(19) United States
(12) Patent Application Publication
(10) Pub. No.: US 2024/0172142 A1
(43) Pub. Date: May 23, 2024

(54) COMMUNICATION CONTROL APPARATUS, COMMUNICATION CONTROL METHOD, AND COMMUNICATION APPARATUS

(71) Applicant: SONY GROUP CORPORATION, TOKYO (JP)

(72) Inventors: HIROTO KURIKI, TOKYO (JP); RYOTA KIMURA, TOKYO (JP); RYO SAWAI, TOKYO (JP)

(21) Appl. No.: 18/549,926

(22) PCT Filed: Feb. 22, 2022
(86) PCT No.: PCT/JP2022/007172

§ 371 Date: Sep. 11, 2023

(30) Foreign Application Priority Data
Mar. 22, 2021 (JP) 2021-047660

(51) Int. Cl. H04W 52/36; H04W 52/24; H04W 52/42

(52) U.S. Cl. CPC H04W 52/367; H04W 52/243; H04W 52/42

(57) ABSTRACT

[Problem] Frequency use efficiency in communication using beamforming is improved. [Solution] A communication control apparatus according to the present disclosure includes a processing unit configured to perform processing for calculating interference power for each beam, a plurality of communication apparatuses capable of transmitting at least one beam giving the interference power to a protection target through transmission of the beam, and decreasing or increasing transmission power for each beam to a value at which total interference power in a case in which the plurality of communication apparatuses simultaneously transmit the beam is equal to or smaller than an interference margin indicating a total allowable interference power of the protection target, on the basis of the interference margin.

### TECHNICAL FIELD

The present disclosure relates to a communication control apparatus, a communication control method, and a communication apparatus.

### BACKGROUND ART

A problem of depletion of radio wave resources (frequencies) that can be allocated to wireless systems began to surface long ago due to an increase in wireless environments in which various wireless systems coexist as well as the increase of wirelessly provided content. Therefore, “dynamic spectrum access (DSA)” in which temporal and spatial vacancies (white spaces) are utilized is rapidly attracting attention as a means for generating necessary radio wave resources.

### CITATION LIST

### Patent Literature

### [PTL 1]

WO 2019/026375

### [PTL 2]

WO 2020/230659

### Non Patent Literature

### [NPL 1]

WINNF-TS-0112-V1.9.0 Requirements for Commercial Operation in the U.S. 3550-3700 MHz Citizens Broadband Radio Service Band

### [NPL 2]

WINNF-TS-0016-V1.2.1 Signaling Protocols and Procedures for Citizens Broadband Radio Service (CBRS): Spectrum Access System (SAS)—Citizens Broadband Radio Service Device (CBSD) Interface Technical Specification

### [NPL 3]

Electronic Code of Federal Regulations, Title 47, Chapter I, Subchapter A, Part 1, Subpart X Spectrum Leasing [available at https://www.ecfr.gov/cgi-bin/text-idx?node=sp47.1.1.x]

### [NPL 4]

WINNF-TS-0061-V1.5.1 Test and Certification for Citizens Broadband Radio Service (CBRS); Conformance and Performance Test Technical Specification; SAS as Unit Under Test (UUT) [available at https://cbrs.wirelessinnovation.org/release-1-of-the-baseline-standard-specifications

### [NPL 5]

WINNF-TS-0016-V1.2.4 Signaling Protocols and Procedures for Citizens Broadband Radio Service (CBRS): Spectrum Access System (SAS)—Citizens Broadband Radio Service Device (CBSD) Interface Technical Specification [available at https://cbrs.wirelessinnovation.org/release-1-of-the-baseline-standard-specifications

### [NPL 6]

940660 D02 CBSD Handshake Procedures v02 [available at https://apps.fcc.gov/kdb/GetAttachment.html?id=RQe7oZJVSWt0fCcNiBV%2Bfw%3D%3D&desc=940660%20D02%20CPE-CBSD%20Handshake%20Procedures%20v02&tracking_number=229297]

### [NPL 7]

“940660 D02 CPE-CBSD Handshake Procedures v02”, Federal Communications Commission Office of Engineering and Technology Laboratory Division, October 2019, available at https://apps.fcc.gov/oetcf/kdb/forms/FTSSearchResultPage.cfm?id=229297&switch=P

### SUMMARY

### Technical Problem

In 5th generation mobile communication systems currently being introduced around the world, more efficient spectrum use is realized by using a wireless base station apparatus having a beamforming function that can obtain a high beam gain using many antennas.

On the other hand, existing institutionalized DSA systems, such as citizens broadband radio service (CBRS) commercialized in the United States, do not appropriately consider this beamforming function. Specifically, the beamforming function is not appropriately considered in the calculation of interference power from the secondary system to the primary system or exchange of messages between a communication control apparatus and a wireless base station apparatus.

For example, NPL 1 and NPL 2 disclose a scheme called an iterative allocation process (IAP) for distributing an interference margin (interference allowable power) of a primary system to each wireless base station apparatus (base station) by iterating decreasing transmission power of the wireless base station apparatus by a constant amount until interference with the primary system becomes equal to or smaller than an allowable value. However, in this scheme, since the transmission power is decreased for each base station, transmission power of other beams is also determined according to a beam giving the strongest interference to the primary system in the case of a base station having a beamforming function of forming a plurality of beams. As a result, a beam giving weak interference to the primary system is matched with the same transmission power as the beam giving the strongest interference. In this case, it cannot be said that radio wave resources are effectively utilized to the maximum.

Further, PTL 1 and PTL 2 disclose an interference margin allocation scheme taking the beamforming function into consideration. However, this scheme assumes that the transmission power of a base station is calculated through back-calculation from allowable interference power (interference margin) allocated to the base station in advance. Therefore, this scheme cannot cope with a scheme of flexibly allocating an interference margin of a primary system to the base station while reducing the transmission power of the base station by a constant amount as in an IAP.

The present disclosure provides a communication control apparatus, a communication control method, and a communication apparatus that make it possible to improve spectrum use efficiency in communication using beamforming.

### Solution to Problem

A communication control apparatus according to the present disclosure includes a processing unit configured to perform processing for calculating interference power for each beam, a plurality of communication apparatuses capable of transmitting at least one beam giving the interference power to a protection target through transmission of the beam, and decreasing or increasing transmission power for each beam to a value at which total interference power in a case in which the plurality of communication apparatuses simultaneously transmit the beam is equal to or smaller than an interference margin indicating total allowable interference power of the protection target, on the basis of the interference margin.

### BRIEF DESCRIPTION OF DRAWINGS

FIG. 1 is a diagram illustrating a system model in an embodiment of the present disclosure.

FIG. 2 illustrates a network configuration to which autonomous decision-making can be applied.

FIG. 3 illustrates a network configuration to which centralized decision-making can be applied.

FIG. 4 illustrates a network configuration in a case in which both centralized decision-making and distributed decision-making are applied.

FIG. 5 is a diagram illustrating a 3 tier structure in CBRS.

FIG. 6 is a diagram illustrating a flow of signaling between terminals.

FIG. 7 is a block diagram of a communication network according to embodiments of the present disclosure.

FIG. 8 is an illustrative diagram illustrating an example of an interference calculation model assumed in the present embodiment.

FIG. 9 is a diagram illustrating an example of a spatial positional relationship between a primary system and a communication apparatus of a secondary system.

FIG. 10 is a diagram illustrating an example in which an interference margin is allocated to each communication apparatus.

FIG. 11 is a flowchart of an IAP for obtaining a maximum antenna power that can be transmitted by a communication apparatus.

FIG. 12 is a diagram illustrating an example of a protection area including two protection points and two communication apparatuses at different distances from the protection area.

FIG. 13A is a diagram schematically illustrating how interference power from two communication apparatuses to a protection point changes in calculation of the IAP according to the present embodiment.

FIG. 13B is a diagram schematically illustrating how interference power from two communication apparatuses to a protection point changes in the calculation of the IAP according to the present embodiment.

FIG. 14 is a diagram illustrating a final value of antenna power that is used when the communication apparatus forms each beam after performing the IAP.

FIG. 15 is a flowchart of the IAP according to the present embodiment.

FIG. 16A is a diagram illustrating an example (example 1) schematically illustrating a state of change in interference power from the two communication apparatuses to the protection point in the calculation of the IAP according to the present embodiment.

FIG. 16B is a diagram illustrating an example (example 1) schematically illustrating a state of change in interference power from the two communication apparatuses to the protection point in the calculation of the IAP according to the present embodiment.

FIG. 17A is a diagram illustrating an example (example 2) schematically illustrating a state of change in interference power from the two communication apparatuses to the protection point in the calculation of the IAP according to the present embodiment.

FIG. 17B is a diagram illustrating an example (example 2) schematically illustrating a state of change in interference power from the two communication apparatuses to the protection point in the calculation of the IAP according to the present embodiment.

FIG. 18A is a diagram illustrating an example (example 3) schematically illustrating a state of change in interference power from the two communication apparatuses to the protection point in the calculation of the IAP according to the present embodiment.

FIG. 18B is a diagram illustrating an example (example 3) schematically illustrating a state of change in interference power from the two communication apparatuses to the protection point in the calculation of the IAP according to the present embodiment.

FIG. 19 illustrates a final determined value of antenna power used by two communication apparatuses to form each beam after performing the IAP according to Examples 1 and 2.

FIG. 20 illustrates a final determined value of antenna power used by two communication apparatuses to form each beam after performing the IAP according to Example 3.

FIG. 21 is a diagram illustrating a relationship between an elevation angle in a beam direction and a size of beam coverage.

FIG. 22 is a diagram illustrating an example in which a beam direction is changed in an azimuth angle direction.

FIG. 23 is a diagram illustrating a range within a certain range angle from a direction in which a primary protection area is present.

FIG. 24 is a diagram illustrating an intermediate direction between two beams.

FIG. 25 is a diagram illustrating a range of a beam width in a beam direction of a certain beam.

FIG. 26 is a flowchart of a modification example of the IAP according to the present embodiment.

### DESCRIPTION OF EMBODIMENTS

### 1. Assumed Representative Scenario

### <1.1 System Model>

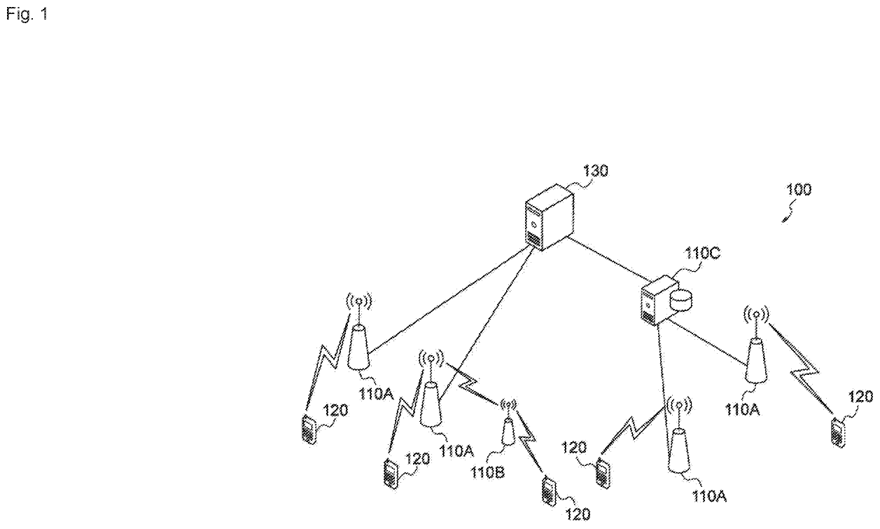

FIG. 1 illustrates a system model in an embodiment of the invention. The present system model is represented by a communication network 100 including wireless communication, as illustrated in FIG. 1, and is typically configured of the following entities.
Communication apparatus 110
Terminal 120
Communication control apparatus 130

Further, the present system model includes at least a primary system and a secondary system that use the communication network 100. The primary system and the secondary system are configured of the communication apparatus 110 or of the communication apparatus 110 and the terminal 120. Various communication systems can be treated as the primary system or the secondary system, but it is assumed in the present embodiment that the primary system and the secondary system use part or all of a frequency band. The frequency bands allocated to the primary system and the secondary system may partially or wholly overlap, or may not overlap at all. That is, the present system model will be described as a model of a wireless communication system for dynamic spectrum access (DSA). The present system model is not limited to a system related to dynamic spectrum access.

The communication apparatus 110 is typically a wireless apparatus that provides a wireless communication service to the terminal 120, like a wireless base station (base station, Node B, eNB, gNB, or the like) or a wireless access point (access point). That is, the communication apparatus 110 provides a wireless communication service to enable wireless communication of the terminal 120. Further, the communication apparatus 110 may be a radio relay apparatus or may be an optical extension apparatus called remote radio head (RRH). In the following description, unless otherwise prescribed, the communication apparatus 110 is an entity constituting the secondary system.

Coverage (a communication area) provided by the communication apparatus 110 is allowed to have various sizes, from a large size like a macro cell to a small size like a pico cell. A plurality of communication apparatuses 110 may form one cell like a distributed antenna system (DAS). Further, when the communication apparatus 110 has a beamforming capability, a cell or service area may be formed for each beam.

The present disclosure assumes that there are two different types of communication apparatuses 110.

In the present disclosure, the communication apparatus 110 that can access the communication control apparatus 130 without using a wireless path that requires permission from the communication control apparatus 130 is referred to as the “communication apparatus 110A.” Specifically, for example, the communication apparatus 110 that can connect to the Internet by wire can be regarded as the “communication apparatus 110A.” Further, for example, even when a wireless relay apparatus does not have a wired Internet connection function, such a wireless relay apparatus may also be regarded as the “communication apparatus 110A” if a wireless backhaul link using a frequency that does not require permission from the communication control apparatus 130 is constructed with the other communication apparatus 110A.

In the present disclosure, the communication apparatus 110 that cannot access the communication control apparatus 130 without the wireless path that requires permission from the communication control apparatus 130 is referred to as the “communication apparatus 110B.” For example, a wireless relay apparatus that needs to construct a backhaul link using a frequency that requires permission from the communication control apparatus 130 can be considered as the “communication apparatus 110B.” Further, for example, an apparatus such as a smartphone including a function of providing a wireless network typified by tethering, which is an apparatus using a frequency that requires permission from the communication control apparatus 130 in both a backhaul link and an access link, is treated as “the communication apparatus 110B.”

The communication apparatus 110 does not necessarily have to be fixedly installed. For example, the communication apparatus 110 may be installed in a moving object such as an automobile. Further, the communication apparatus 110 does not necessarily have to be on the ground. For example, the communication apparatus 110 may be included in an object present in the air or space, such as an aircraft, drone, helicopter, high altitude platform station (HAPS), balloon, or satellite. Further, the communication apparatus 110 may be included in an object on or in the sea, such as a ship or a submarine. Typically, such a mobile communication apparatus 110 corresponds to the communication apparatus 110B and secures an access route to the communication control apparatus 130 by performing wireless communication with the communication apparatus 110A. As a matter of course, when a spectrum used for wireless communication with the communication apparatus 110A is not managed by the communication control apparatus 130, the mobile communication apparatus 110 can be handled as the communication apparatus 110A.

In the present disclosure, unless otherwise restricted, the description “communication apparatus 110” encompasses a meaning of both the communication apparatus 110A and the communication apparatus 110B, and may be read with either.

The communication apparatus 110 may be used, operated, or managed by various operators. For example, a mobile network operator (MNO), a mobile virtual network operator (MVNO), a mobile network enabler (MNE), a mobile virtual network enabler (MVNE), a shared facility operator, a neutral host network (NHN) operator, a broadcaster, an enterprise, an educational institution (school corporation, local government board of education, or the like), real estate (building, condominium, or the like) administrator, an individual, or the like can be assumed to be an operator involved with the communication apparatus 110. The operator involved with the communication apparatus 110 is not particularly limited. Further, the communication apparatus 110A may be a shared facility that is used by a plurality of operators. Further, operators who install, use, operate, and manage a facility may be different from each other.

The communication apparatus 110 operated by an operator is typically connected to the Internet via a core network. Further, operation, administration, and maintenance are performed through a function called operation, administration, and maintenance (OA&M). Further, for example, as illustrated in FIG. 1, there may be an intermediate apparatus (network manager) 110C that integrally controls the communication apparatuses 110 in the network. The intermediate apparatus may be the communication apparatus 110 or may be the communication control apparatus 130.

The terminal 120 (User Equipment, User Terminal, User Station, Mobile Terminal, Mobile Station, or the like) is an apparatus that performs wireless communication using a wireless communication service provided by the communication apparatus 110. Typically, a communication apparatus such as a smart phone corresponds to the terminal 120. Any apparatus having a wireless communication function can correspond to the terminal 120. For example, a device such as a camera for business use having a wireless communication function may correspond to the terminal 120 even when wireless communication is not its main use. Further, a communication device that transmits data to the terminal 120, such as a radio station for broadcasting business (FPU: Field Pickup Unit) that transmits an image for television broadcasting or the like from the outside of a broadcasting station (on-site) to the broadcasting station in order to perform sports relay or the like also corresponds to the terminal 120. Further, the terminal 120 does not necessarily have to be used by a person. For example, a device such as a machine in a factory or a sensor installed in a building through so-called machine type communication (MTC) may be connected to a network and operate as the terminal 120. A device called customer premises equipment (CPE) provided to ensure Internet connection may act as the terminal 120.

Further, the terminal 120 may have a relay communication function, as typified by device-to-device (D2D) or vehicle-to-everything (V2X).

Further, the terminal 120 does not need to be fixedly installed or present on the ground, like the communication apparatus 110. For example, an object present in the air or space, such as an aircraft, drone, helicopter, or satellite, may operate as the terminal 120. Further, for example, an object present on or in the sea, such as a ship or a submarine, may operate as the terminal 120.

In the present disclosure, unless otherwise indicated, the terminal 120 corresponds to an entity in which a radio link using a frequency that requires permission from the communication control apparatus 130 terminates. However, the terminal 120 may perform the same operation as the communication apparatus 110 depending on a function of the terminal 120 or a network topology to be applied. In other words, depending on the network topology, an apparatus that may correspond to the communication apparatus 110, such as a wireless access point, may correspond to the terminal 120, or an apparatus that may correspond to the terminal 120, such as a smartphone, may correspond to the communication apparatus 110.

The communication control apparatus 130 is typically an apparatus that performs a determination, use permission, instruction, and/or management of communication parameters for the communication apparatus 110. For example, database servers called TV White Space Database (TVWSDB), Geolocation database (GLDB), Spectrum Access System (SAS), and Automated Frequency Coordination (AFC) correspond to the communication control apparatus 130. In other words, a database server having authorities and roles such as authentication and supervision of radio wave use related to secondary use of frequencies can be regarded as the communication control apparatus 130.

The communication control apparatus 130 also corresponds to a database server having a role different from the role described above. For example, a control apparatus that performs radio wave interference control between communication apparatuses, which is typified by a spectrum manager (SM) in EN 303 387 of European Telecommunications Standards Institute (ETSI), Coexistence Manager (CM) in Institute of Electrical and Electronics Engineers (IEEE) 802.19.1-2018, Coexistence Manager (CxM) in CBRSA-TS-2001, or the like, also corresponds to the communication control apparatus 130. Further, for example, Registered Location Secure Server (RLSS) prescribed by IEEE 802.11-2016 also corresponds to the communication control apparatus 130. That is, the present disclosure is not limited to these examples, and an entity responsible for a determination, use permission, instruction, management, or the like of the communication parameters of the communication apparatus 110 may be called the communication control apparatus 130. Basically, a control target of the communication control apparatus 130 is the communication apparatus 110, but the communication control apparatus 130 may control the terminal 120 under the control of the communication apparatus 110.

The communication control apparatus 130 also corresponds to a combination of a plurality of database servers having different roles. For example, CBRS Alliance SAS (CSAS) that is a combination of SAS and CxM, as shown in CBRSA-TS-2001, can also be regarded as the communication control apparatus 130.

The communication control apparatus 130 can also be realized by implementing software having the same functions as those of one database server in the database server. For example, a SAS with a CxM-equivalent function or software can also be regarded as the communication control apparatus 130.

There may be a plurality of communication control apparatuses 130 having the same role. When there are a plurality of communication control apparatuses 130 having the same role, at least one of at least the following three types of decision-making topologies can be applied to the communication control apparatuses 130.
Autonomous Decision-Making
Centralized Decision-Making
Distributed Decision-Making

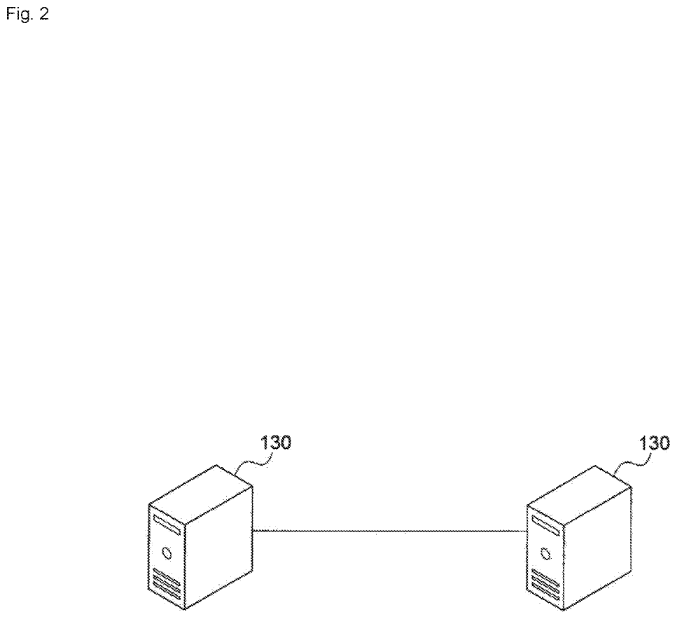

The autonomous decision-making is a decision-making topology in which an entity making a decision (decision-making entity; the communication control apparatus 130 herein) makes a decision independently of other decision-making entities. The communication control apparatus 130 independently performs calculation of necessary frequency allocation or interference control. For example, when the plurality of communication control apparatuses 130 are distributed as illustrated in FIG. 2, autonomous decision-making can be applied.

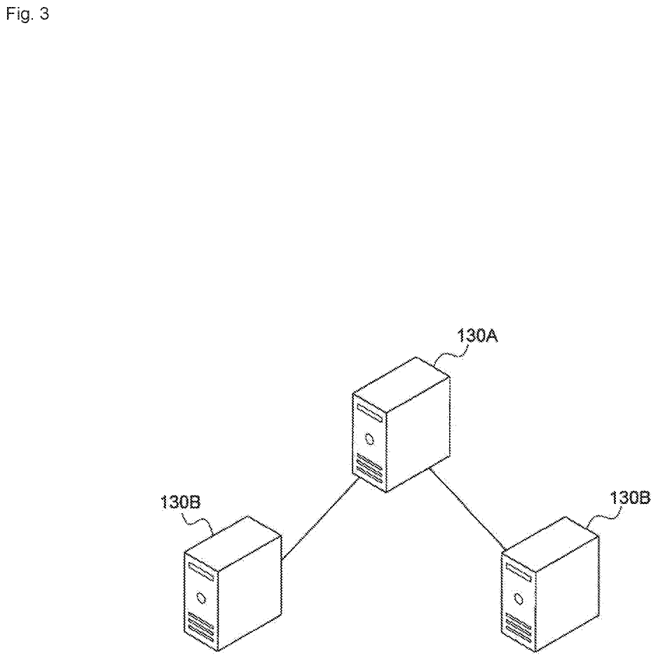

The centralized decision-making is a decision-making topology in which a decision-making entity delegates decision-making to another decision-making entity. When the centralized decision-making is performed, for example, a model as illustrated in FIG. 3 is assumed. FIG. 3 illustrates a model (so-called master-slave type) in which one communication control apparatus 130 centrally controls the plurality of communication control apparatuses 130. In the model of FIG. 3, a communication control apparatus 130A that is a master can totally control a plurality of slave communication control apparatuses 130B and make decisions intensively.

The distributed decision-making is a decision-making topology in which a decision-making entity cooperates with another decision-making entity to make decisions. For example, the plurality of communication control apparatuses 130 make decisions independently as in the autonomous decision-making in FIG. 2, each communication control apparatuses 130 making a decision and then performing mutual adjustment of decision-making results, negotiation, and the like may correspond to the “distributed decision-making”. Further, for example, the communication control apparatus 130A of the master, for example, dynamically delegating a decision-making authority to each slave communication control apparatus 130B or discarding the decision-making authority for the purpose of load distribution (load balancing), or the like in the centralized decision-making of FIG. 3 can also be regarded as the “distributed decision-making”.

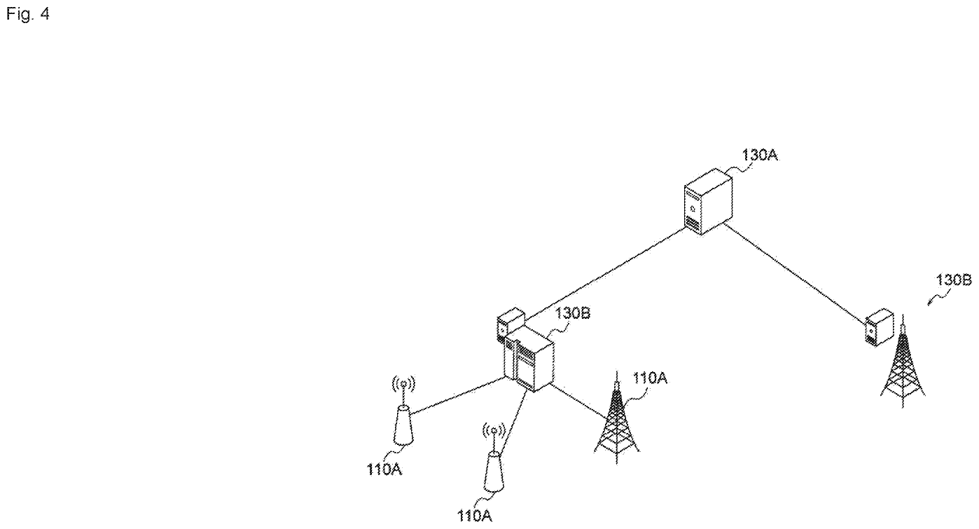

Both the centralized decision-making and the distributed decision-making may be applied. In FIG. 4, the slave communication control apparatus 130B operates as an intermediate apparatus that binds a plurality of communication apparatuses 110. The master communication control apparatus 130A may not control the communication apparatus 110 bundled by the slave communication control apparatus 130B, that is, a secondary system constituted by the slave communication control apparatus 130B. Thus, as a modification example, mounting as illustrated in FIG. 4 is also possible.

The communication control apparatus 130 may also acquire necessary information from entities other than the communication apparatus 110 and the terminal 120 of the communication network 100 for its role. Specifically, for example, information necessary for protection of the primary system can be acquired from a database (regulatory database) that is managed or operated by a national regulatory authority (NRA) in a county or region. An example of the regulatory database may include a universal licensing system (ULS) that is operated by the Federal Communications Commissions (FCC) of United States. Examples of the information necessary for protection of the primary system include position information of the primary system, communication parameters of the primary system, out-of-band emission (OOBE) limit, adjacent channel leakage ratio (ACLR), adjacent channel selectivity, fading margin, and protection ratio (PR). In order to protect the primary system, it is preferable to use information determined by a legal system as the information necessary for protection of the primary system in an area in which a fixed numerical value, an acquisition method, a derivation method, or the like is determined by the legal system or the like.

A database that performs recording regarding the communication apparatus 110 and the terminal 120 that have received conformity approval, such as an equipment authorization system (EAS) managed by an office of engineering and technology (OET) of the FCC, also corresponds to the regulatory database. From such a regulatory database, it is possible to acquire information on operation frequencies of the communication apparatus 110 or the terminal 120, information on maximum equivalent isotropic radiated power (EIRP), and the like. Of course, the communication control apparatus 130 may use this information to protect the primary system.

Further, it can also be assumed that the communication control apparatus 130 acquires radio wave sensing information from a radio wave sensing system installed and operated for the purpose of radio wave detection of the primary system. As a specific example, in the Citizens Broadband Radio Service (CBRS) in United States, the communication control apparatus 130 acquires radio wave detection information of a shipboard radar, which is a primary system, from a radio wave sensing system called an environmental sensing capability (ESC). Further, when the communication apparatus 110 or the terminal 120 has a sensing function, the communication control apparatus 130 may acquire radio wave detection information of the primary system from the communication apparatus 110 or the terminal 120.

It is also assumed that the communication control apparatus 130 acquires activity information of the primary system from a portal system that manages the activity information of the primary system. As a specific example, in the Citizens Broadband Radio Service (CBRS) of United States, the communication control apparatus 130 acquires the activity information of the primary system from a calendar type system called Informing Incumbent Portal. A protection area called a dynamic protection area (DPA) is activated on the basis of the acquired activity information to protect the primary system. Protection of the primary system is realized in a similar scheme by an equivalent system, called informing incumbent capability (IIC).

An interface between the entities constituting the present system model may be wired or may be wireless. For example, as an interface between the communication control apparatus 130 and the communication apparatus 110, not only a wired line but also a wireless interface that does not depend on spectrum access may be used. As wireless interfaces that do not depend on spectrum access, there are, for example, a wireless communication line provided through a licensed band by a mobile network operator, and Wi-Fi communication using an existing license-exempt band.

### <1.2 Terminology Regarding Frequency and Sharing>

As described above, description will be given assuming a dynamic spectrum access environment in the present embodiment. As a representative example of the dynamic spectrum access, a mechanism defined by CBRS in United States (that is, a mechanism defined by Part 96 Citizens Broadband Radio Service of FCC rules in United States) will be described.

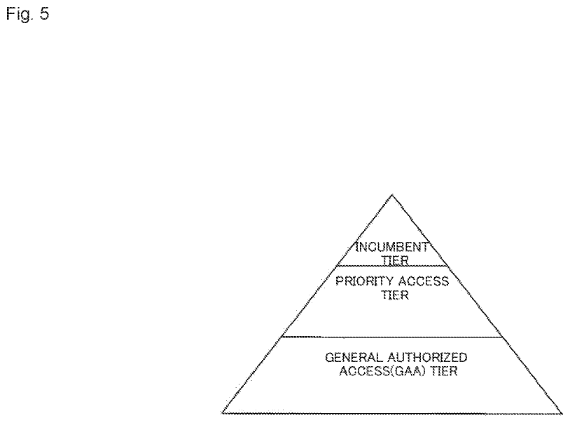

In CBRS, each user of a frequency band is classified into one of three groups, as illustrated in FIG. 5. This group is called a tier. The three groups are called an incumbent tier, a priority access tier, and a general authorized access (GAA) tier, respectively.

The incumbent tier is a group of existing users who have traditionally used the frequency band. The existing users are also generally referred to as primary users. In CBRS, the Department of Defense (DOD) of United States, a fixed satellite operator, and a grandfathered wireless broadband Licensee (GWBL) are defined as existing users. The incumbent tier is not required to avoid interference with the priority access tier and the GAA tier having a lower priority, nor to suppress the use of the frequency band. Further, the incumbent tier is also protected from interference with the priority access tier and GAA tier. That is, the users of the incumbent tier can use the frequency band without considering the presence of other groups.

The priority access tier is a group of users who use the frequency band on the basis of the above-described priority access license (PAL). The users of the priority access tier are also generally referred to as secondary users. When the frequency band is used, the priority access tier is required to avoid interference and suppress the use of the frequency band with respect to the incumbent tier having a higher priority than the priority access tier. Meanwhile, the priority access tier is required to avoid interference and suppress the use of the frequency band with respect to the GAA tier having a lower priority than the priority access tier. Further, the priority access tier is not protected from interference with the incumbent tier having a higher priority, but is protected from interference with the GAA tier having a lower priority.

The GAA tier is a group of frequency band users that do not belong to the incumbent tier and priority access tier. The users of the GAA tier are also generally referred to as secondary users, similar to the priority access tier. However, the user is also called a low-priority secondary user because a shared use priority is lower than that of the priority access tier. When the frequency band is used, the GAA tier is required to avoid the interference and suppress the use of the frequency band with respect to the incumbent tier and priority access tier having a higher priority. Further, the GAA tier is not protected from interference due to the incumbent tier and the priority access tier having a higher priority.

Although the mechanism of CBRS has been described above as a representative example of the dynamic spectrum access, the present embodiment is not limited to the definition of CBRS. For example, as illustrated in FIG. 5, CBRS generally adopts a 3 tier structure, but a 2 tier structure may be adopted in the present embodiment. Representative examples of the 2 tier structure may include Authorized Shared Access (ASA), Licensed Shared Access (LSA), evolved LSA (eLSA), TV band White Space (TVWS), and US 6 GHz band access. ASA, LSA and eLSA do not have a GAA tier, and a structure equivalent to a combination of the incumbent tier and the priority access tier is adopted. Further, there is no priority access tier in the TVWS and the US 6 GHz band access, and the same structure as a combination of the incumbent tier and the GAA tier is adopted. Further, there may be four or more tiers. Specifically, four or more tiers may be generated by, for example, providing a plurality of intermediate layers corresponding to the priority access tiers and assigning different priorities to the respective intermediate layers.

Further, for example, the GAA tier may be similarly divided, a priority may be assigned, and the number of tiers may be increased. That is, each group may be divided.

Further, the primary system of the present embodiment is not limited to the definition of the CBRS. For example, as examples of the primary system, TV broadcasting, fixed microwave links (FS: Fixed System), meteorological radar, radio altimeter, wireless train control system (communications-based train control), and a wireless system such as radio astronomy are assumed. Further, the present disclosure is not limited thereto, any wireless system can be the primary system of the present embodiment.

Further, as described above, the present embodiment is not limited to a spectrum access environment. Generally, in the spectrum access or frequency secondary use, an existing system using a target frequency band is called a primary system, and a secondary user is called a secondary system, but these should be replaced with other terms and read when the present embodiment is applied to an environment other than the spectrum access environment. For example, a macro cell base station in a heterogeneous network (HetNet) may be a primary system, and a small cell base station or a relay station may be a secondary system. Further, the base station may be a primary system, and a relay user equipment (UE) or vehicle UE realizing D2D and V2X present within a coverage thereof may be a secondary system. The base station is not limited to a fixed type, and may be portable or mobile. In such a case, for example, the communication control apparatus 130 of the present embodiment may be included in a core network, base station, relay station, relay UE, or the like.

Further, when the present embodiment is applied to environments other than the spectrum access environment, the term “frequency” in the present disclosure is replaced with another term shared by an application destination. For example, it is assumed that the terms are replaced with terms such as “resource”, “resource block”, “resource element”, “resource pool”, “channel”, “component carrier”, “carrier”, “subcarrier”, and “bandwidth part (BWP)”, or other terms having equivalent or similar meanings.

### 2. Description of Various Procedures Assumed in Present Embodiment

Basic procedures that can be used in implementing the present embodiment will be described herein. Description will be made assuming that the present embodiment is mainly implemented in the communication apparatus 110A up to <2.5> that will be described below.

### <2.1 Registration Procedure>

A registration procedure is a procedure for registering information on a wireless system desiring to use the frequency band. More specifically, the registration procedure is a procedure for registering device parameters regarding the communication apparatus 110 of the wireless system in the communication control apparatus 130. Typically, the registration procedure is initiated by the communication apparatus 110 representing the wireless system intending to use the frequency band notifying the communication control apparatus 130 of a registration request including the device parameters. When the plurality of communication apparatuses 110 belong to the wireless system intending to use the frequency band, device parameters of each of the plurality of communication apparatuses are included in the registration request. Further, an apparatus that transmits the registration request on behalf of the wireless system may be determined appropriately.

### <2.1.1 Details of Required Parameters>

The device parameters refer to, for example, the following information.
Information on a user of the communication apparatus 110 (hereinafter referred to as user information)
Unique information of the communication apparatus 110 (hereinafter referred to as unique information)
Information on the position of the communication apparatus 110 (hereinafter referred to as position information)
Information on an antenna of the communication apparatus 110 (hereinafter referred to as antenna information)
Information on the wireless interface of the communication apparatus 110 (hereinafter referred to as wireless interface information)
Legal information on the communication apparatus 110 (hereinafter referred to as legal information)
Information on an installer of the communication apparatus 110 (hereinafter referred to as installer information)
Information on a group to which the communication apparatus 110 belongs (hereinafter, group information)

The device parameters are not limited to the above. Information other than these may be treated as the device parameter. The device parameters do not have to be transmitted once, and may be transmitted in a divided manner at multiple times. That is, a plurality of registration requests may be transmitted for one registration procedure. Thus, one procedure or one processing within the procedure may be divided into a plurality of times and performed. The same applies to procedures to be described below.

The user information is information related to the user of the communication apparatus 110. For example, user ID, account name, user name, user contact, call sign, or the like can be assumed. The user ID and the account name may be uniquely generated by the user of the communication apparatus 110 or may be issued in advance by the communication control apparatus 130. It is preferable to use the call sign that is issued by the NRA.

The user information can be used, for example, for interference resolution. As a specific example, even when the communication control apparatus 130 performs a use stop determination for a spectrum that is being used by the communication apparatus 110, in the spectrum use notification procedure described in <2.5> to be described below, and issues an instruction based on the use stop determination, a spectrum use notification request for the spectrum may continue to be notified. In this case, the communication control apparatus 130 may suspect a problem with the communication apparatus 110 and may perform contact for a behavior confirmation request of the communication apparatus 110 with respect to the user contact included in the user information. The present disclosure is not limited to this example and, when a determination is made that the communication apparatus 110 is performing an operation contrary to the communication control performed by the communication control apparatus 130, the communication control apparatus 130 can contact using the user information.

The unique information is information with which the communication apparatus 110 can be specified, product information of the communication apparatus 110, information on hardware or software of the communication apparatus 110, and the like.

The information with which the communication apparatus 110 can be specified can include, for example, a manufacturing number (serial number) of the communication apparatus 110 or an ID of the communication apparatus 110. The ID of the communication apparatus 110 may be uniquely assigned by the user of the communication apparatus 110, for example.

The product information of the communication apparatus 110 can include, for example, an authentication ID, product model number, and information on a manufacturer. The approval ID is an ID assigned from an approval authority in each country or region, such as an FCC ID in United States, CE number in Europe, and the certification of conformance to technical standards (technical conformance) in Japan. An ID issued on the basis of an independent authentication program by an industry association or the like may also be regarded as the authentication ID.

Unique information typified by these can be used for, for example, the use of an allowlist or a denylist. For example, when any information related to the communication apparatus 110 in operation is included in the deny list, the communication control apparatus 130 can instruct the communication apparatus 110 to stop the spectrum use in the spectrum use notification procedure described in <2.5> to be described below Further, the communication control apparatus 130 can behave, for example, not to release use suspension measures until the communication apparatus 110 is released from the denylist. Further, for example, the communication control apparatus 130 can reject registration of the communication apparatus 110 included in the denylist. Further, for example, the communication control apparatus 130 can also perform an operation that the communication apparatus 110 corresponding to information included in the denylist is not considered in interference calculation of the present disclosure, or only the communication apparatus 110 corresponding to information included in the allowlist is considered in the interference calculation.

In the present disclosure, the FCC ID may be treated as information on transmission power. For example, in an equipment authorization system (EAS) database that is a type of regulatory database, information on a certified apparatus can be acquired, and its API (Application Programming Interface) is also open to the public. For example, certified maximum EIRP information or the like can be included in the information together with the FCC ID. Since such power information is associated with the FCC ID, the FCC ID can be treated as transmission power information. Similarly, the FCC ID may be treated as the same information as other information included in the EAS. Further, the present disclosure is not limited to the FCC ID and, when there is information associated with the authentication ID, the authentication ID may be treated as being equivalent to that information.

Examples of information on hardware of the communication apparatus 110 may include transmission power class information. As the transmission power class information, for example, US Title 47 C.F.R (Code of Federal Regulations) Part 96 defines two types of classes including category A and category B, and information on hardware of the communication apparatus 110 conforming to the definition can include information on which of the two classes the hardware belongs to. Further, in 3GPP (3rd Generation Partnership Project) TS36.104 or TS38.104, several classes of eNodeB and gNodeB are defined, and the definition thereof can also be used.

The transmission power class information can be used, for example, for the interference calculation. It is possible to perform the interference calculation using maximum transmission power prescribed for each class as transmission power of the communication apparatus 110.

The information on the software of the communication apparatus 110 can include, for example, version information or a build number regarding an execution program describing processing required for interaction with the communication control apparatus 130. Further, version information or build number of software for operating as the communication apparatus 110 may also be included.

The position information is typically information that can identify the position of the communication apparatus 110. For example, the position information is coordinate information acquired by a positioning function typified by a global positioning system (GPS), Beidou, quasi-zenith satellite system (QZSS), Galileo, or assisted global positioning system (A-GPS). Typically, information related to latitude, longitude, ground height/elevation, altitude, and positioning error may be included. Alternatively, for example, the position information may be position information registered in an information management apparatus managed by a national regulatory authority (NRA) or its entrusted agency. Alternatively, for example, the position information may be coordinates of X-, Y-, and Z axes with a specific geographical position as an origin. Further, in addition to such coordinate information, an identifier indicating whether the communication apparatus 110 is present outdoors or indoors can be assigned.

Further, location uncertainty may also be included in the position information. For example, both or either of a horizontal plane and a vertical plane may be provided as the location uncertainty. The location uncertainty can be used, for example, as a correction value when a distance to any point is calculated. Further, for example, the location uncertainty can be used as area information at which the communication apparatus 110 is likely to be located. In this case, the location uncertainty is used for processing such as specifying usable frequency information within an area indicated by the location uncertainty.

Further, the position information may be information indicating an area in which the communication apparatus 110 is located. For example, information indicating an area determined by the government, such as a postal code and an address, may be used. Further, for example, the area may be indicated by a set of three or more geographic coordinates. The information indicating the area may be provided together with coordinate information.

Further, when the communication apparatus 110 is located indoors, information indicating a floor of a building in which the communication apparatus 110 is located may also be included in the position information. For example, an identifier indicating the number of floors, ground, or underground may be included in the position information. Further, information indicating an additional indoor closed space, such as a room number or a room name in a building may be included in the position information.

It is preferable for the positioning function to be typically included in the communication apparatus 110. However, the performance of the positioning function may not satisfy required precision. Further, even when the performance of the positioning function satisfies required accuracy, position information that satisfies the required accuracy may not always be able to be acquired depending on an installation position of the communication apparatus 110. Therefore, the positioning function may be included in an apparatus other than the communication apparatus 110, and the communication apparatus 110 may acquire information on a position from such an apparatus. The apparatus with the positioning function may be an existing available apparatus, or may be provided by the installer of the communication apparatus 110. In such a case, it is preferable for position information measured by the installer of the communication apparatus 110 to be written to the communication apparatus 110.

The antenna information is typically information indicating the performance, configuration, and the like of the antenna included in the communication apparatus 110. Typically, information such as antenna installation height, tilt angle (Downtilt), horizontal orientation (Azimuth), boresight (boresight), antenna peak gain, and antenna model may be included.

Further, the antenna information may also include information on beams that can be formed. For example, information such as a beam width, a beam pattern, and analog or digital beamforming capabilities may be included.

The antenna information can also include information on the performance or configuration of multiple input multiple output (MIMO) communication. For example, information such as the number of antenna elements, the maximum number of spatial streams (or the number of MIMO layers) may be included. Further, codebook information to be used, weight matrix information, or the like may also be included. The weight matrix information includes unitary matrix, zero-forcing (ZF) matrix, minimum mean square error (MMSE) matrix, or the like, and these are obtained by singular value decomposition (SVD), eigen value decomposition (EVD), block diagonalization (BD), or the like. Further, when the communication apparatus 110 has a function such as maximum likelihood detection (MLD) requiring nonlinear calculation, information indicating the included function may be included in the antenna information.

Further, the antenna information may include ZoD (Zenith of Direction, Departure). ZoD is a type of radio wave arrival angle. The ZOD may not be notified of from the communication apparatus 110, but may be estimated from radio waves radiated from the antenna of the communication apparatus 110 by the other communication apparatus 110 and notified of. In this case, the communication apparatus 110 may be an apparatus operating as a base station or an access point, an apparatus performing D2D communication, a moving relay base station, or the like. The ZoD can be estimated by radio wave arrival direction estimation technology such as multiple signal classification (MUSIC) or estimation of signal propagation via rotation invariance techniques (ESPRIT). Further, ZOD can be used by the communication control apparatus 130 as measurement information.

The wireless interface information is typically information indicating a wireless interface technology included in the communication apparatus 110. For example, identifier information indicating a technology used in GSM, CDMA2000, UMTS, E-UTRA, E-UTRA NB-IOT, 5G NR, 5G NR NB-IOT or a further next generation cellular system may be included as the wireless interface information. Further, identifier information indicating long term evolution (LTE)/5G-compliant derivative technology such as MulteFire, long term evolution-unlicensed (LTE-U), and NR-Unlicensed (NR-U) may also be included. Further, identifier information indicating a standard technology such as a metropolitan area network (MAN) such as WiMAX and WiMAX2+, and an IEEE 802.11 wireless LAN may also be included. Identifier information indicating extended global platform (XGP) or Shared XGP (sXGP) may also be included. Identifier information of a communication technology for LPWA (Local Power, Wide Area) may also be included. Further, identifier information indicating a proprietary wireless technology may be included. Further, a version number or release number of a technical specification defining these technologies may be included as the wireless interface information.

Frequency band information supported by the communication apparatus 110 may also be included in the wireless interface information. For example, the frequency band information can be represented by an upper limit frequency, a lower limit frequency, a center frequency, a bandwidth, a 3GPP operating band number, or a combination of at least two of these. Further, one or more pieces of frequency band information may be included in the wireless interface information.

As the frequency band information supported by the communication apparatus 110, information indicating capability of a band extension technology such as carrier aggregation (CA) or channel bonding may be further included. For example, combinable band information may be included. Further, regarding the carrier aggregation, information on a band desired to be used as a primary component carrier (PCC) or a secondary component carrier (SCC) may also be included. The number of component carriers (CC number) that can be aggregated at the same time can be also included.

As the frequency band information supported by the communication apparatus 110, information indicating a combination of frequency bands supported by dual connectivity and multi connectivity may be further included. Further, information on other communication apparatuses 110 that cooperatively provide dual connectivity and multi connectivity may also be provided. In subsequent procedures, the communication control apparatus 130 may take into consideration other communication apparatuses 110 that are in a cooperative relationship or the like to perform a determination of communication control disclosed in the present embodiment.

Information indicating a radio wave use priority such as PAL and GAA may also be included as the frequency band information supported by the communication apparatus 110.

The wireless interface information may also include modulation scheme information supported by the communication apparatus 110. For example, as a representative example, information indicating a primary modulation scheme such as frequency shift keying (FSK), n-value phase shift keying (PSK; where n is a multiplier of 2 such as 2, 4, or 8), or n-value quadrature amplitude modulation (QAM; where n is a multiplier of 4, such as 4, 16, 64, 256, and 1024) may be included. Further, information indicating a secondary modulation scheme such as orthogonal frequency division multiplexing (OFDM), scalable OFDM, DFT spread OFDM (DFT-s-OFDM), generalized frequency division multiplexing (GFDM), or filter bank multi carrier (FBMC) is included.

Further, the wireless interface information may also include information on error correction code. For example, the wireless interface information may include capability such as turbo code, low density parity check (LDPC) code, polar code, or erasure correction code, or coding rate information to be applied.

The modulation scheme information or the information on the error correction code can also be represented by modulation and coding scheme (MCS) indexes as another aspect.

Further, the wireless interface information may also include information indicating functions specific to each radio technology specification supported by the communication apparatus 110. For example, a representative example may include transmission mode (TM) information defined in LTE. In addition, those having two or more modes for a specific function can be included in the wireless interface information like TM information. Further, in the technical specification, in a case in which the communication apparatus 110 supports a function that is not essential to the specification even when two or more modes do not exist, information indicating the supported function can also be included.

Further, the wireless interface information may also include radio access technology (RAT) information supported by the communication apparatus 110. For example, information indicating time division multiple access (TDMA), frequency division multiple access (FDMA), orthogonal frequency division multiple access (OFDMA), power division multiple access (PDMA), code division multiple access (CDMA), sparse code multiple access (SCMA), interleave division multiple access (IDMA), spatial division multiple access (SDMA), carrier sense multiple access/collision avoidance (CSMA/CA), carrier sense multiple access/collision detection (CSMA/CD), or the like may be included. TDMA, FDMA, and OFDMA are classified as orthogonal multiple access (OMA). PDMA, CDMA, SCMA, IDMA, and SDMA are classified as non-orthogonal multiple access (NOMA). A representative example of PDMA is a scheme realized by combining superposition coding (SPC) and successive interference canceller (SIC). CSMA/CA and CSMA/CD are classified as opportunistic access.

When the wireless interface information includes information indicating the opportunistic access, information indicating details of the access scheme may also be included. As a specific example, information indicating whether the scheme is a frame based equipment (FBE) or load based equipment (LBE) defined in EN 301 598 of ETSI may be included.

When the wireless interface information indicates LBE, LBE-specific information such as priority class may be further included.

The wireless interface information may also include information related to a duplex mode supported by the communication apparatus 110. As a representative example, information on a scheme such as frequency division duplex (FDD), time division duplex (TDD), and full duplex (FD) may be included.

When TDD is included as the wireless interface information, TDD frame structure information used or supported by the communication apparatus 110 can be assigned. Further, the information related to the duplex mode may be included for each frequency band indicated by the frequency band information.

When the FD is included as the wireless interface information, information on an interference power detection level may be included.

Further, the wireless interface information can also include information on a transmission diversity scheme supported by the communication apparatus 110. For example, space time coding (STC) may be included.

The wireless interface information may also include guard band information. For example, information on a guard band size determined for the wireless interface in advance may be included. Alternatively, for example, information on the guard band size desired by the communication apparatus 110 may be included.

The wireless interface information may be provided for each frequency band regardless of the above aspect.

The legal information typically is information on regulations with which the communication apparatus 110 should comply, which is defined by a national regulatory authority in each county or region, or an equivalent organization, or authentication information acquired by the communication apparatus 110. Examples of the information on regulations typically includes upper limit information of out-of-band radiation, and information on blocking characteristics of a receiver. Examples of the authentication information can typically include type approval information and regulatory information serving as a reference for approval acquisition. The type approval information includes, for example, the FCC ID in US, and the certification of conformance to technical standards in Japan. The regulatory information corresponds to, for example, FCC regulation number in US or ETSI Harmonized Standard number in Europe.

Information defined in a specification of a wireless interface technology may be substituted for Information on numerical values in the legal information. The specification of the wireless interface technology corresponds to, for example, 3GPP TS 36.104 or TS 38.104. The adjacent channel leakage ratio (ACLR) is prescribed in these. The upper limit information on out-of-band radiation may be derived and used using ACLR prescribed in the specification instead of the upper limit information on out-of-band radiation. Further, ACLR itself may be used as necessary. Further, adjacent channel selectivity (ACS) may also be used instead of blocking characteristics. Further, these may be used together, or an adjacent channel interference ratio (ACIR) may be used. In general, ACIR has the following relationship with ACLR and ACS.

$$\begin{matrix}[ Math . 1 ] & \\ ACIR = {( \frac{1}{ACS} + \frac{1}{A C L R} )}^{- 1} & ( 1 )\end{matrix}$$

Although a true value expression is used in Equation (1), Equation (1) may be represented by a logarithmic expression.

The installer information can include information with which a person who has installed the communication apparatus 110 (an installer) can be specified, unique information linked to the installer, and the like. Typically, information on an individual who is responsible for the position information of the communication apparatus 110, which is called a certified professional installer (CPI) defined in NPL 3, can be included in the installer information. CPI discloses a certified professional installer registration ID (CPIR-ID) and a CPI name. Further, as unique information linked to the CPI, for example, a contact address (mailing address or contact address), E-mail address, telephone number, public key identifier (PKI), and the like are disclosed. The present disclosure is not limited thereto, and other information on the installer may be included in the installer information, as necessary.

The group information may include information on a communication apparatus group to which the communication apparatus 110 belongs. Specifically, for example, information related to the same or equivalent type of group as that disclosed in WINNF-SSC-0010 may be included. Further, for example, when the mobile network operator manages the communication apparatuses 110 in units of groups according to its own operation policy, information on the group can be included in the group information.

The information listed so far may be inferred from other information provided from the communication apparatus 110 by the communication control apparatus 130 without being provided to the communication control apparatus 130 by the communication apparatus 110. Specifically, for example, the guard band information can be inferred from the wireless interface information. When the wireless interface used by the communication apparatus 110 is E-UTRA or 5G NR, the guard band information can be inferred on the basis of a transmission bandwidth specification of E-UTRA described in 3GPP TS36.104, a transmission bandwidth specification of 5G NR described in 3GPP TS38.104, and a table given in TS38.104 shown below.

TABLE 1
Table 5.6-1 Transmission bandwidth configuration
NRB in E-UTRA channel bandwidths (Cited from
Table 5.6-1 of TS36.104 of 3GPP)

| | Channel bandwidth BW_{Channel} [MHz] | | | | | |
|---|---|---|---|---|---|---|
| | 1.4 | 3 | 5 | 10 | 15 | 20 |
| Transmission | 6 | 15 | 25 | 50 | 75 | 100 |
| bandwidth | | | | | | |
| configuration N_{RB} | | | | | | |

TABLE 2
Table 5.3.3-1: Minimum guardband (kHz) (FR1) (Cited from Table 5.3.3-1 of TS38.104 of 3GPP)

| SCS | 5 | 10 | 15 | 20 | 25 | 30 | 40 | 50 | 60 | 70 | 80 | 90 | 100 |
|---|---|---|---|---|---|---|---|---|---|---|---|---|---|
| (kHz) | MHz | MHz | MHz | MHz | MHz | MHz | MHz | MHz | MHz | MHz | MHz | MHz | MHz |
| 15 | 242.5 | 312.5 | 382.5 | 452.5 | 522.5 | 592.5 | 552.5 | 692.5 | N.A | N.A | N.A | N.A | N.A |
| 30 | 505 | 665 | 645 | 805 | 785 | 945 | 905 | 1045 | 825 | 965 | 925 | 885 | 845 |
| 60 | N.A | 1010 | 990 | 1330 | 1310 | 1290 | 1610 | 1570 | 1530 | 1490 | 1450 | 1410 | 1370 |

TABLE 3
Table: 5.3.3-2: Minimum guardband (kHz) (FR2)
(Cited from Table 5.3.3-2 of TS38.104 of 3GPP)

| SCS (kHz) | 50 MHz | 100 MHz | 200 MHz | 400 MHz |
|---|---|---|---|---|
| 60 | 1210 | 2450 | 4930 | N.A. |
| 120 | 1900 | 2420 | 4900 | 9860 |

TABLE 4
Table: 5.3.3-3: Minimum guardband (kHz) of SCS 240 KHz SS/PBCH
block (FR2) (Cited from Table 5.3.3-3 of TS38.104 of 3GPP)

| SCS (kHz) | 100 MHz | 200 MHz | 400 MHz |
|---|---|---|---|
| 240 | 3800 | 7720 | 15560 |

In other words, it is sufficient for the communication control apparatus 130 to be able to acquire the information listed so far, and the communication apparatus 110 does not necessarily need to provide the information to the communication control apparatus 130. Further, an intermediate apparatus 130B (for example, network manager) that binds the plurality of communication apparatuses 110 does not need to provide the information to the communication control apparatus 130A. The communication apparatus 110 or the intermediate apparatus 130B providing information to the communication control apparatus 130 or 130A is merely one means of providing the information in the present embodiment. The information listed so far means that the information is information necessary for the communication control apparatus 130 to normally complete the present procedure, and means for providing the information does not matter. For example, in WINNF-TS-0061, such a method is called Multi-Step Registration and allowed.

Further, naturally, the information listed so far is selectively applicable depending on local legal systems and technical specifications.

### <2.1.1.1 Supplement to Required Parameters>

In the registration procedure, it is assumed that device parameters regarding not only the communication apparatus 110 but also the terminal 120 are required to be registered in the communication control apparatus 130 in some cases. In such a case, the term “communication apparatus” in the description described in <2.1.1> may be replaced with the “terminal” or a similar term, and the term may be applied. Further, “terminal”-specific parameters not described in <2.1.1> may be treated as required parameters in the registration procedure. Examples thereof may include a user equipment (UE) category defined by 3GPP. <2.1.2 Details of Registration Processing>

As described above, the communication apparatus 110) representing the wireless system attempting to use the frequency band generates a registration request including the device parameters and notifies the communication control apparatus 130 of the registration request.

Here, when the installer information is included in the device parameter, the communication apparatus 110 may use the installer information to perform, for example, processing of falsification prevention on the registration request. Further, encryption processing may be performed on part or all of information included in the registration request. Specifically, for example, a unique public key may be shared in advance between the communication apparatus 110 and the communication control apparatus 130, and the communication apparatus 110 may use a private key corresponding to the public key to encrypt information. An example of an encryption target may include information sensitive to crime prevention, such as the position information.

The ID and the position information of the communication apparatus 110 are open to the public, and the communication control apparatus 130 may hold an ID and position information of a main communication apparatus 110 present within its own coverage in advance. In such a case, since the communication control apparatus 130 can acquire the position information from the ID of the communication apparatus 110 that has transmitted the registration request, the position information need not be included in the registration request. Further, it is also conceivable that the communication control apparatus 130 returns necessary device parameters to the communication apparatus 110 that has transmitted the registration request, and the communication apparatus 110 receives this and transmits a registration request including the device parameters necessary for registration. Thus, the information included in the registration request may vary from case to case.

After registration request reception, the communication control apparatus 130 performs registration processing for the communication apparatus 110 and returns a registration response according to a processing result. When there are no shortage and no abnormality of information necessary for registration, the communication control apparatus 130 records the information in an internal or external storage apparatus and notifies of normal completion. Otherwise, the communication control apparatus 130 notifies of registration failure. When the registration is normally completed, the communication control apparatus 130 may individually assign an ID to each communication apparatus 110 and notify the communication apparatus 110 of the ID information at the time of a response. When the registration fails, the communication apparatus 110 may notify of the modified registration request again. Further, the communication apparatus 110 may change the registration request and attempt the registration procedure until normal completion.

The registration procedure may be executed even after the registration has normally been completed. Specifically, the registration procedure may be re-executed when the position information changes beyond a predetermined reference, for example, due to movement, accuracy improvement, or the like. The predetermined reference is typically set by a legal system of each country or region. For example, in 47 C.F.R Part 15 of United States, Mode II personal/portable white space devices, that is, devices that use vacant frequencies should be re-registered when positions thereof change by 100 meters or more.

### <2.2 Available Spectrum Query Procedure>

The available spectrum query procedure is a procedure in which the wireless system attempting to use the frequency band inquires of the communication control apparatus 130 about information on the available spectrum. It is not always necessary to perform the available spectrum query procedure. Further, the communication apparatus 110 that makes the query on behalf of the wireless system attempting to use the frequency band may be the same as or different from the communication apparatus 110 that has generated the registration request. Typically, the procedure is started by the communication apparatus 110 making a query notifying the communication control apparatus 130 of a query request including the information with which the communication apparatus 110 can be specified.

Here, the available spectrum information is typically information indicating a frequency that the communication apparatus 110 can safely use for secondary use without fatal interference with the primary system.

The available spectrum information is determined, for example, on the basis of a secondary use prohibition area called an exclusion zone. Specifically, for example, when the communication apparatus 110 is installed in the secondary use prohibition area provided for the purpose of protecting the primary system that uses a frequency channel F1, the communication apparatus 110 is not notified of the frequency channel F1 as an available channel.

The available spectrum information can also be determined, for example, by a degree of interference with the primary system. Specifically, for example, even in an area other than the secondary use prohibition area, when a determination is made that the communication apparatus gives the fatal interference with the primary system, the frequency channel may not be notified as an available channel. An example of a specific calculation method is described in <2.2.2> to be described below.

Further, as described above, there may be frequency channels that are not notified as being available according to conditions other than primary system protection requirements. Specifically, for example, in order to avoid interference that may occur between the communication apparatuses 110 in advance, a frequency channel being used by the other communication apparatus 110 present near the communication apparatus 110 may not be notified as an available channel. Thus, the available spectrum information set in consideration of interference with the other communication apparatuses 110 may be set as, for example, “recommended frequency information” and provided together with the available spectrum information. That is, it is preferable for the “recommended frequency information” to be a subset of the available spectrum information.

When an influence can be avoided by decreasing the transmission power even in a case in which the primary system is influenced, the same frequency as the primary system or nearby communication apparatus 110 may be notified as an available channel. In such a case, maximum allowable transmission power information is typically included in the available spectrum information. The maximum allowable transmission power is typically expressed in EIRP. The present disclosure does not have to be always limited thereto, and may be provided, for example, in a combination of antenna power (conducted power) and an antenna gain. Further, for the antenna gain, an allowable peak gain may be set for each spatial direction.

### <2.2.1 Details of Required Parameters>

Information with which the wireless system attempting to use the frequency band can be specified can be assumed to be, for example, unique information registered in the registration procedure, and the ID information described above.

Further, query requirement information may also be included in the query request. The query requirement information may include, for example, information indicating a frequency band of which the availability is desired to be known. Further, for example, the transmission power information may be included. The communication apparatus 110 performing the query may include the transmission power information, for example, when communication apparatus 110 desires to know only frequency information in which the desired transmission power is likely to be used. The query requirement information does not necessarily have to be included in the query request.

Information indicating a format of the available spectrum information may also be included in the information indicating the frequency band. The IEEE 802.11 standard defines a channel number for each band. For example, a flag requesting whether or not a channel defined by such a wireless interface technical specification is used may be included. As another format, a flag requesting whether a unit frequency range rather than the defined channel is used may be included. When the unit frequency is 1 MHz, available spectrum information is requested for each frequency range of 1 MHz. When this flag is used, desired unit frequency information may be enclosed in the flag.

Further, the query request may also include a measurement report. The measurement report includes results of measurements performed by the communication apparatus 110 and/or the terminal 120. Some or all of the measurement results may be represented by raw data or may be represented by processed data. For example, standardized metrics typified by reference signal received power (RSRP), reference signal strength indicator (RSSI), and reference signal received quality (RSRQ) can be used for measurement.

### <2.2.2 Details of Available Spectrum Evaluation Processing>

After the query request is received, evaluation of the available spectrum is performed on the basis of the query requirement information. For example, as described above, it is possible to perform the evaluation of the available spectrum in consideration of the primary system, the secondary use prohibition area thereof, and the presence of nearby communication apparatuses 110.

The communication control apparatus may derive the secondary use prohibition area. For example, when maximum transmission power P_{MaxTx(dBm)} and minimum transmission power P_{MinTx(dBm)} are defined, it is possible to calculate a range of a separation distance between the primary system and the secondary system from the following equation, and determine the secondary use prohibition area.

PL⁻¹(P_{MaxTx(dBm)}−I_{Th(dBm)})_{(dB)}≤d<PL⁻¹(P_{MinTx(dBm)}−I_{Th(dBm)})_{(dB)} [Math. 2]

I_{Th(dBm)} denotes allowable interference power (a limit value of allowable interference power), d denotes a distance between a predetermined reference point and the communication apparatus 110, and PL( )_{(dB)} is a propagation loss function. Thereby, it is possible to determine frequency availability depending on a positional relationship between the primary system and the communication apparatus 110. Further, when transmission power information or power range information desired to be used by the communication apparatus 110 is supplied as a request, PL⁻¹(P_{Tx(dBm)}−I_{Th(dBm)}) can be calculated and compared with the range equation to determine the frequency availability.

Maximum allowable transmission power information may be derived. Typically, the maximum allowable transmission power information is calculated using allowable interference power information in the primary system or a protection zone thereof, position information of a reference point for calculating an interference power level suffered by the primary system, registration information of the communication apparatus 110, and a propagation loss estimation model.

Specifically, as an example, the maximum allowable transmission power information is calculated by the following equation.

[Math. 3]

P_{MaxTx(dBm)}=I_{Th(dBm)}+PL(d)_{(dB)} (2)

In Equation (2), an antenna gain in a transceiver is not included, but the antenna gain in the transceiver may be included according to a method of expressing the maximum allowable transmission power (EIRP, conducted power, or the like) or a reference point of reception power (antenna input point, antenna output point, or the like). A safety margin for compensating for a variation due to fading, or the like may be also included. Further, a feeder loss may also be considered as necessary. Further, it is possible to perform the same calculation for neighboring channels by taking into account an adjacent channel leakage ratio (ACRL) or a maximum value of out-of-band radiation.

Further, Equation (2) is also written on the basis of the assumption that a single communication apparatus 110 is an interference source (single station interference). For example, when aggregated interference from the plurality of communication apparatuses 110 should be considered at the same time, a correction value may be added. Specifically, for example, the correction value can be determined on the basis of three types (Fixed/Predetermined, Flexible, Flexible Minimized) of interference margin allocation scheme disclosed in NPL 4 (ECC Report 186).

It is not always possible to directly use the allowable interference power information itself, as in Equation (2). For example, when a required signal power to interference power ratio (SIR), signal to interference plus noise ratio (SINR), or the like of the primary system are available, these may be converted into allowable interference power and used. Such conversion processing is not limited to this processing, and may be applied to processing of other procedures.

Although Equation (2) is expressed using a logarithm, this may be naturally converted to antilogarithm and used at the time of implementation. Further, all parameters of a logarithmic notation described in the present disclosure may be appropriately converted to an antilogarithm and used.

Further, when the above-described transmission power information is included in the query requirement information, it is possible to perform the evaluation of the available spectrum using a method other than the above-described method. Specifically, for example, in a case in which it is assumed that the desired transmission power indicated by the transmission power information has been used, when an amount of interference to be estimated is smaller than the allowable interference power in the primary system or a protection zone thereof, a determination is made that the frequency channel is available and the communication apparatus 110 is notified of this.

Further, for example, when an area or space in which the communication apparatus 110 can use the frequency band is determined in advance, the available spectrum information may be simply derived on the basis only on coordinates (X-axis, Y-axis, Z-axis coordinates or latitude, longitude, and ground clearance of the communication apparatus 110) included in the position information of the communication apparatus 110, as in an area of a radio environment map (REM). Further, for example, even when a lookup table in which coordinates of the position of the communication apparatus 110 are associated with the available spectrum information is prepared, the available spectrum information may be derived on the basis only on the position information of the communication apparatus 110. Thus, there are various methods for determining the available spectrum, and the methods are not limited to the examples of the present disclosure.

Further, when the communication control apparatus 130 acquires the information on the capability of the band extension technology such as carrier aggregation (CA) or channel bonding as the frequency band information supported by the communication apparatus 110, the communication control apparatus 130 may include an available combination of these, a recommended combinations, or the like in the available spectrum information.

Further, when the communication control apparatus 130 acquires information on a combination of frequency bands supported by dual connectivity and multi connectivity as the frequency band information supported by the communication apparatus 110, the communication control apparatus 130 may include, in the available spectrum information, information such as an available spectrum and a recommended spectrum for the dual connectivity and multi connectivity.

Further, in a case in which available spectrum information for the band extension technology as described above is provided, when an imbalance in the maximum allowable transmission power is generated among a plurality of frequency channels, the maximum allowable transmission power of each frequency channel may be adjusted and then the available spectrum information may be provided. For example, from the viewpoint of primary system protection, the maximum allowable transmission power of each frequency channel may be aligned with the maximum allowable transmission power of a frequency channel with a low maximum allowable power spectral density (PSD).

The evaluation of the available spectrum does not necessarily have to be performed after the query request is received. For example, the communication control apparatus 130 may independently perform the evaluation without the query request after the normal completion of the registration procedure described above. In such a case, the REM or lookup table shown as an example above, or an information table similar thereto may be created.

Further, radio wave use priority such as PAL and GAA may also be evaluated. For example, when information on a priority of radio wave use is included in the registered device parameters or the query requirements, a determination may be made as to whether spectrum use is possible on the basis of the priority and a notification may be performed. Further, for example, as disclosed in NPL 3, when information on the communication apparatus 110 (referred to as a cluster list in NPL 3) that performs high-priority use (for example, PAL) is registered in the communication control apparatus 130 from the user in advance, evaluation may be performed on the basis of that information.

After the evaluation of the available spectrum is completed, the communication control apparatus 130 notifies the communication apparatus 110 of an evaluation result.

The communication apparatus 110 may use the evaluation result received from the communication control apparatus 130 to select a desired communication parameter. When a spectrum grant procedure, which will be described below, is not adopted, the communication apparatus 110 may start radio wave transmission using the selected desired communication parameter as the communication parameter.

### <2.3 Spectrum Grant Procedure>

The spectrum grant procedure is a procedure in which the wireless system attempting to use the frequency band receives secondary spectrum grant from the communication control apparatus 130. The communication apparatus 110 that performs the spectrum grant procedure on behalf of the wireless system may be the same as or different from the communication apparatus 110 that has performed the procedures so far. Typically, the procedure is started by the communication apparatus 110 notifying the communication control apparatus 130 of a spectrum grant request including the information with which the communication apparatus 110 can be specified. As described above, the available spectrum query procedure is not essential. Therefore, the spectrum grant procedure may be performed after the available spectrum query procedure, or may be performed after the registration procedure.

In the present embodiment, it is assumed that at least two types of spectrum grant request schemes below can be used.
Designation scheme
Flexible scheme

The designation scheme is a request scheme in which the communication apparatus 110 designates the desired communication parameter and asks the communication control apparatus 130 to permit an operation based on the desired communication parameter. The desired communication parameters include, but are not limited to, a frequency channel to be used, maximum transmission power, and the like. For example, wireless interface technology-specific parameters (modulation scheme, duplex mode, or the like) may be designated. Further, information indicating the radio wave use priority such as PAL and GAA may be included.

The flexible scheme is a request scheme in which the communication apparatus 110 designates only requirements regarding the communication parameters and requests the communication control apparatus 130 to designate communication parameters of which secondary use can be permitted, while satisfying the requirements. The requirements regarding the communication parameters include, but are not limited to, for example, bandwidth, desired maximum transmission power, or desired minimum transmission power. For example, wireless interface technology-specific parameters (modulation scheme, duplex mode, or the like) may be designated. Specifically, for example, one or more of TDD frame structures may be selected in advance and notified of.

The spectrum grant request may also include a measurement report regardless of whether the scheme is any one of the designation scheme and the flexible scheme, like the query request. The measurement report includes results of measurement performed by the communication apparatus 110 and/or the terminal 120. The measurement may be represented by raw data or may be represented by processed data. For example, standardized metrics typified by reference signal received power (RSRP), reference signal strength indicator (RSSI), and reference signal received quality (RSRQ) can be used for measurement.

The scheme information used by the communication apparatus 110 may be registered in the communication control apparatus 130 in the registration procedure described in <2.1>.

### <2.3.1 Details of Spectrum Grant Processing>

After the communication control apparatus 130 receives the spectrum grant request, the communication control apparatus 130 performs spectrum grant processing on the basis of a spectrum grant request scheme. For example, with the scheme described in <2.2>, it is possible to perform spectrum grant processing in consideration of the primary system, the secondary use prohibition area, the presence of nearby communication apparatuses 110, and the like.

When the flexible scheme is used, the maximum allowable transmission power information may be derived using the scheme described in <2.2.2>. Typically, the maximum allowable transmission power information is calculated using the allowable interference power information in the primary system or its protection zone, the position information of the reference point for calculating the interference power level suffered by the primary system, the registration information of the communication apparatus 110, and the propagation loss estimation model. Specifically, as an example, the maximum allowable transmission power information is calculated by Equation (2) above.

Further, Equation (2) is written on the basis of the assumption that the single communication apparatus 110 is the interference source, as described above. For example, when the aggregated interference from the plurality of communication apparatuses 110 should be considered at the same time, the correction value may be added. Specifically, for example, a correction value can be determined on the basis of three types of scheme (Fixed/Predetermined, Flexible, Flexible Minimized) disclosed in NPL 4 (ECC Report 186).

The communication control apparatus 130 can use various propagation loss estimation models in the spectrum grant procedure, available spectrum evaluation processing for an available spectrum information query request, and the like. When a model is designated for each use, it is preferable to use the designated model. For example, in NPL 3 (WINNF-TS-0112), a propagation loss model such as Extended Hata (eHATA) or Irregular Terrain Model (ITM) is adopted for each use. Of course, the propagation loss model Is are not limited thereto.

There is also the propagation loss estimation model that requires information on a radio wave propagation path. Information indicating inside and outside a line of sight (LOS: Line of Sight and/or NLOS: Non Line of Sight), topographical information (undulation, sea level, or the like), or environmental information (urban, suburban, rural, open sky, or the like), for example, can be included in the information on the radio wave propagation path. In using the propagation loss estimation model, the communication control apparatus 130 may infer information thereof from the registration information of the communication apparatus 110 or information of the primary system that has already been acquired. Alternatively, when there is a parameter designated in advance, it is preferable to use the parameter.

When the propagation loss estimation model is not designated for a predetermined use, the propagation loss estimation model may be used as necessary. For example, when interference power to the other communication apparatus 110 is estimated, a model in which a loss is calculated to be small, such as a free space loss model, is used, but when coverage of the communication apparatus 110 is estimated, a model in which a loss is calculated to be large is used.

Further, when the designated propagation loss estimation model is used, it is possible to perform spectrum grant processing on the basis of evaluation of the interference risk, as an example. Specifically, for example, in a case in which it is assumed that the desired transmission power indicated by the transmission power information has been used, when an amount of interference to be estimated is smaller than the allowable interference power in the primary system or a protection zone thereof, a determination is made that use of the frequency channel is permissible and the communication apparatus 110 is notified of this.

In both the designation scheme and the flexible scheme, the radio wave use priority such as PAL and GAA may be evaluated like the query request. For example, when information on the radio wave use priority is included in the registered device parameters or the query requirements, a determination may be made as to whether spectrum use is possible on the basis of the priority and a determination result may be notified of. Further, for example, when the information on the communication apparatus 110 that performs high-priority use (for example, PAL) is registered in the communication control apparatus 130 from the user in advance, the evaluation may be performed on the basis of that information. For example, in NPL 3 (WINNF-TS-0112), the information on the communication apparatus 110 is called a cluster list.

Further, when the position information of the communication apparatus is used in any of the calculations, the frequency availability may be determined by correcting the position information or coverage using the location uncertainty.

The spectrum grant processing does not necessarily have to be executed due to reception of the spectrum grant request. For example, the communication control apparatus 130 may independently perform the processing without the spectrum grant request after normal completion of the registration procedure described above. Further, for example, the spectrum grant processing may be performed at regular intervals. In such cases, the above-described REMs, lookup table, or similar information table may be created. Accordingly, since permissible frequency can be determined only with the position information, the communication control apparatus 130 can quickly return a response after receiving the spectrum grant request.

### <2.4 Spectrum Use Notification/Heartbeat>

The spectrum use notification is a procedure in which a wireless system using the frequency band notifies the communication control apparatus 130 of spectrum use based on communication parameters permitted for use in the spectrum grant procedure. The communication apparatus 110 that performs the spectrum use notification on behalf of the wireless system may be the same as or different from the communication apparatus 110 that has performed the procedures so far. Typically, the communication apparatus 110 notifies the communication control apparatus 130 of a notification message including the information with which the communication apparatus 110 can be specified.

It is preferable for the spectrum use notification to be periodically performed until the communication control apparatus 130 refuses spectrum use. In this case, the spectrum use notification is also called a heartbeat.

After reception of the spectrum use notification, the communication control apparatus 130 may determine whether spectrum use (in other words, radio wave transmission at a permitted frequency) is started or continued. Examples of a determination method may include confirmation of the spectrum use information of the primary system. Specifically, it is possible to determine whether to permit or deny the start or continuation of the spectrum use (radio transmission at the permitted frequency) on the basis of change in the use spectrum of the primary system, change in a spectrum use situation of a primary system in which radio wave use is not regular (for example, a shipboard radar of CBRS in US), or the like. When the start or continuation is permitted, the communication apparatus 110 may start or continue the spectrum use (radio transmission at the permitted frequency).

After the spectrum use notification is received, the communication control apparatus 130 may instruct the communication apparatus 110 to reconfigure the communication parameters. Typically, the reconfiguration of the communication parameters can be instructed in the response of the communication control apparatus 130 to the spectrum use notification. For example, information on recommended communication parameters (hereinafter referred to as recommended communication parameter information) can be provided. It is preferable for the communication apparatus 110 that has received the recommended communication parameter information to perform the spectrum grant procedure described in <2.4> again using the recommended communication parameter information.

### <2.5 Supplement to Various Procedures>

The various procedures do not necessarily need to be implemented separately, as will be described below. For example, two different procedures may be realized by substituting a third procedure having roles of the two different procedures. Specifically, for example, the registration request and the available spectrum information query request may be integrally notified. Further, for example, the spectrum grant procedure and the spectrum use notification may be performed integrally. Of course, the present disclosure is not limited to the combinations thereof, and three or more procedures may be integrally performed. Further, as described above, one procedure may be divided and performed a plurality of times.

Further, an expression “acquire” or similar expressions in the present disclosure does not necessarily mean acquisition according to the procedures described in the present disclosure. For example, although it is described that the position information of the communication apparatus 110 is used for the available spectrum evaluation processing, this means that that it is not always necessary to use information acquired in the registration procedure, and when position information is included in the available spectrum query procedure request, the position information may be used. In other words, the procedure for acquisition described in the present disclosure is an example, and acquisition by another procedure is also permitted within the scope of the present disclosure and within the scope of technical feasibility.

Further, the information described as being included in the response from the communication control apparatus 130 to the communication apparatus 110 may be actively notified from the communication control apparatus 130 using a push scheme, if possible. As a specific example, the available spectrum information, the recommended communication parameter information, radio wave transmission continuation deny notification, and the like may be notified using a push scheme.

### <2.6 Various Procedures Regarding Terminal>

Up to this point, the processing in the communication apparatus 110A is mainly assumed and the description has been made. However, according to the embodiment, not only the communication apparatus 110A, but also the terminal 120 or the communication apparatus 110B may operate under the control of the communication control apparatus 130. That is, a scenario in which the communication parameters are determined by the communication control apparatus 130 is assumed. In such a case, it is basically possible to use each procedure described in <2.1> to <2.4>. However, the terminal 120 or the communication apparatus 110B needs to use a frequency managed by the communication control apparatus 130 for the backhaul link, and cannot arbitrarily transmit radio waves, unlike the communication apparatus 110A. Therefore, it is preferable to detect radio waves or an authorization signal transmitted by the communication apparatus 110A (the communication apparatus 110 capable of providing wireless communication service or a master communication apparatus 110 in a master-secondary type), and then, start backhaul communication aiming at access to the communication control apparatus 130.

On the other hand, being under the control of the communication control apparatus 130 may include a case in which allowable communication parameters are also set for the purpose of primary system protection in the terminal or the communication apparatus 110B. However, the communication control apparatus 130 cannot know the position information of these apparatuses in advance. Further, these apparatuses are highly likely to have mobility. That is, the position information is dynamically updated. Depending on the legal system, re-registration in the communication control apparatus 130 may be obligatory when the position information changes a certain amount or more.

In consideration of such various use forms and operation forms of the terminal 120 and the communication apparatus 110, two types of communication parameters below are defined in TVWS operation form (NPL 5) defined by the Office of Communication (Ofcom).
Generic Operational Parameters
Specific Operational Parameters

The generic operational parameters are communication parameters defined as “parameters that can be used by any slave WSD located within the coverage area of a predetermined master WSD (equivalent to the communication apparatus 110)” in NPL 5. The characteristic is that this is calculated by the WSDB without using position information of the slave WSD.

The generic operational parameters can be provided by unicast or broadcast from the communication apparatus 110 that has already received permission of radio wave transmission from the communication control apparatus 130. For example, a broadcast signal typified by the Contact Verification Signal (CVS) prescribed in the FCC Rule Part 15 Subpart H of United States can be used. Alternatively, the generic operational parameters may be provided by a broadcast signal specific to a wireless interface. This makes it possible for the terminal 120 or the communication apparatus 110B to treat this as a communication parameter used for radio wave transmission aiming at accessing the communication control apparatus 130.

The specific operational parameters are communication parameters defined as “parameters available to a specific slave white space device (WSD)” in NPL 5. In other words, the specific operational parameters are communication parameters that are calculated using the device parameter of the slave WSD corresponding to the terminal 120. A characteristic may include that this is calculated by white space database (WSDB) using the position information of the slave WSD.

The CPE-CBSD Handshake Procedure defined in NPL 6 can be regarded as another form of a procedure regarding a terminal. CPE-CBSD does not have a wired backhaul line and accesses the Internet via BTS-CBSD. Therefore, it is not possible to acquire, from the SAS, permission to transmit radio waves in a CBRS band without special regulations or procedures. The CPE-CBSD handshake procedure recognizes performing radio wave transmission with the same maximum EIRP and minimum required duty cycle as a terminal (EUD) until permission to transmit radio waves is acquired from the SAS with respect to CPE-CBSD. Accordingly, the communication apparatus 110B sets transmission EIRP to the maximum EIRP of the terminal, and then performs wireless communication with the communication apparatus 110A at the minimum required duty cycle, thereby constructing a line for acquiring permission of radio wave transmission from the communication control apparatus 130. After a permission to transmit radio waves is acquired, it is possible to use up to the maximum EIRP prescribed for communication apparatuses within a range of permission.

### <2.7 Procedure Generated Between Communication Control Apparatus>

### <2.7.1 Information Exchange>

The communication control apparatus 130 can perform exchange of management information with other communication control apparatuses 130. At least, it is preferable for the following information to be exchanged.
Information related to the communication apparatus 110
Area information
Protection target system information

The information related to the communication apparatus 110 includes at least the registration information and communication parameter information of the communication apparatus 110 operating under permission of the communication control apparatus 130. Registration information for the communication apparatus 110 that does not have authorized communication parameters may also be included.

The registration information of the communication apparatus 110 is typically device parameters of the communication apparatus 110 registered in the communication control apparatus 130 in the registration procedure described above. Not all registered pieces of information is necessarily exchanged. For example, information that may correspond to personal information need not be exchanged. Further, when the registration information of the communication apparatus 110 is exchanged, the registration information may be encrypted and exchanged, or the information may be exchanged after the content of the registration information is made ambiguous. For example, information converted into a binary value or information signed using an electronic signature mechanism may be exchanged.

The communication parameter information of the communication apparatus 110 is typically information related to communication parameters that are currently used by the communication apparatus 110. It is preferable for at least information indicating a use frequency and transmission power to be included. Other communication parameters may be included.

The area information is typically information indicating a predetermined geographical area. This information may include area information of various attributes in various aspects.

For example, protection area information of the communication apparatus 110 serving as a high-priority secondary system may be included in the area information, like the PAL protection area (PPA) disclosed in NPL 3 (WINNF-TS-0112). The area information in this case can be represented, for example, by a set of three or more coordinates indicating geographic positions. Further, for example, when the plurality of communication control apparatuses 130 can refer to a common external database, the area information can be represented by a unique ID, and the actual geographic area can be referenced from the external database using the ID.

Further, for example, information indicating a coverage of the communication apparatus 110 may be included. The area information in this case can also be represented, for example, by a set of three or more coordinates indicating geographical positions. Alternatively, for example, assuming that the coverage is a circle centered on the geographical position of the communication apparatus 110, this can also be represented by information indicating a magnitude of a radius. Further, for example, when the plurality of communication control apparatuses 130 can refer to a common external database that records the area information, the information indicating the coverage can be represented by a unique ID, and actual coverage can be referenced by using the ID from the external database.

Further, as another aspect, information related to an area partition determined by an administration or the like in advance can also be included. Specifically, for example, it is possible to indicate a certain area by indicating an address. Further, for example, a license area can be similarly expressed.

Further, as yet another aspect, the area information does not necessarily have to represent a two-dimensional area, and may represent a three-dimensional space. For example, this may be expressed using a spatial coordinate system. Further, for example, information indicating a predetermined closed space, such as the number of floors of a building, a floor, a room number, or the like, may be used.

The protection target system information is, for example, information of a wireless system treated as a protection target, such as the above-described existing layer (incumbent tier). Examples of a situation in which this information should be exchanged include a situation requiring cross-border coordination. In neighboring countries or regions, it is sufficiently conceivable that there are different protection targets in the same band. In such a case, the protection target system information may be exchanged between the different communication control apparatuses 130 in corresponding countries or regions, as necessary.

As another aspect, the protection target system information may include information on a secondary licensee, and information on a wireless system operated by the secondary licensee. The secondary licensee is specifically a licensee of a license, and for example, it is assumed that the secondary licensee borrows a PAL from a holder and operates the wireless system of the secondary licensee. When the communication control apparatus 130 independently performs lease management, the communication control apparatus 130 may exchange information on the secondary licensee and information on the wireless system operated by the secondary licensee with another communication control apparatus for the purpose of protection.

These pieces of information can be exchanged between the communication control apparatuses 130 regardless of the decision-making topology applied to the communication control apparatus 130.

Further, these pieces of information can be exchanged in a variety of ways. An example is shown hereinafter.
ID designation scheme
Period designation scheme
Area designation scheme
Dump scheme

The ID designation scheme is a scheme of acquiring information corresponding to the ID by using an ID assigned in advance to specify information managed by the communication control apparatus 130. For example, it is assumed that the communication apparatus 110 with ID: AAA is managed by a first communication control apparatus 130. In this case, a second communication control apparatus 130 designates an ID: AAA for the first communication control apparatus 130, and makes an information acquisition request. After the request is received, the first communication control apparatus 130 performs search for information of ID: AAA, and notifies of information on the communication apparatus 110 with ID: AAA, such as registration information communication parameter information, as a response.

The period designation scheme is a scheme in which information satisfying a predetermined condition can be exchanged in a specific designated period.

Examples of the predetermined condition may include whether or not information is updated. For example, when acquisition of the information on the communication apparatus 110 in the specific period is designated by a request, the registration information of the communication apparatus 110 newly registered within the specific period can be notified of in a response. Further, the registration information or communication parameter information of the communication apparatus 110 whose communication parameters have been changed within the specific period can also be notified of in a response.

Examples of the predetermined condition may include whether or not recording has been performed by the communication control apparatus 130. For example, when the acquisition of the information on the communication apparatus 110 in the specific period is designated by a request, the registration information or communication parameter information recorded by the communication control apparatus 130 in the period can be notified of in a response. When the information is updated in that period, latest information in the period may be notified of. Alternatively, an update history may be notified of for each piece of information.

In an area designation scheme, a specific area is designated, and information of the communication apparatus 110 belonging to the area is exchanged. For example, when acquisition of the information on the communication apparatus 110 in the specific area is designated by a request, the registration information or the communication parameter information of the communication apparatus 110 installed in the specific area can be notified of in a response.

The dump scheme is a scheme for providing all pieces of information recorded by the communication control apparatus 130. It is preferable for at least the information related to the communication apparatus 110 or the area information to be provided by using the dump scheme.

All the descriptions of the exchange of information between the communication control apparatuses 130 so far are based on a pull scheme. That is, this is a form in which information corresponding to the parameter designated by the request is returned as a response, and can be realized by an HTTP GET method as an example. However, it is not necessary to be limited to the pull scheme, and information may be actively provided to the other communication control apparatus 130 using the push scheme. The push scheme can be realized by an HTTP POST method, for example.

### <2.7.2 Order and Request Procedure>

The communication control apparatuses 130 may perform a command or a request to each other. Specifically, one example may include the reconfiguration of the communication parameters of the communication apparatus 110. For example, when a determination is made that the first communication apparatus 110 managed by the first communication control apparatus 130 is receiving a great deal of interference from the second communication apparatus 110 managed by the second communication control apparatus 130, the first communication control apparatus 130 may request the second communication control apparatus 130 to change the communication parameters of the second communication apparatus 110.

Another example may include reconfiguration of the area information. For example, when there is a deficiency in calculation of coverage information or protection area information regarding the second communication apparatus 110 managed by the second communication control apparatus 130, the first communication control apparatus 130 may request the second communication control apparatus 130 to reconstruct the area information. In addition thereto, an area information reconstruction request may be made for various reasons.

### <2.8 Information Transfer Means>

Notification (signaling) between entities described so far can be realized via various mediums. E-UTRA or 5G NR will be described by way of example. Of course, implementations are not limited to these.

### <2.8.2 Signaling Between Communication Control Apparatus 130 and Communication Apparatus 110>

Notification from the communication apparatus 110 to the communication control apparatus 130 may be performed, for example, in an application layer. For example, the notification may be implemented using Hyper Text Transfer Protocol (HTTP). Signaling can be performed by describing the required parameters in an HTTP message body according to a predetermined format. Further, when HTTP is used, notification from the communication control apparatus 130 to the communication apparatus 110 is also performed according to an HTTP response mechanism.

### <2.8.3 Signaling Between Communication Apparatus 110 and Terminal 120>

The notification from the communication apparatus 110 to the terminal 120 may be performed using, for example, at least one of radio resource control (RRC) signaling, system information (SI), and downlink control information (DCI). Further, there are, as downlink physical channels, PDCCH: Physical Downlink Control Channel, PDSCH: Physical Downlink Shared Channel, PBCH: Physical Broadcast Channel, NR-PDCCH, NR-PDSCH, NR-PBCH, and the like, but at least one of these may be used for implementation.

Notification from the terminal 120 to the communication apparatus 110 may be performed using, for example, radio resource control (RRC) signaling or uplink control information (UCI). Further, the notification may be performed using an uplink physical channel (PUCCH: Physical Uplink Control Channel, PUSCH: Physical Uplink Shared Channel, or PRACH: Physical Random Access Channel).

The signaling is not limited to physical layer signaling described above, but may be performed in a higher layer. For example, when the notification may be performed in the application layer, the signaling may be performed by describing the required parameters in the HTTP message body according to a predetermined format.

### <2.8.4 Signaling Between Terminals 120>

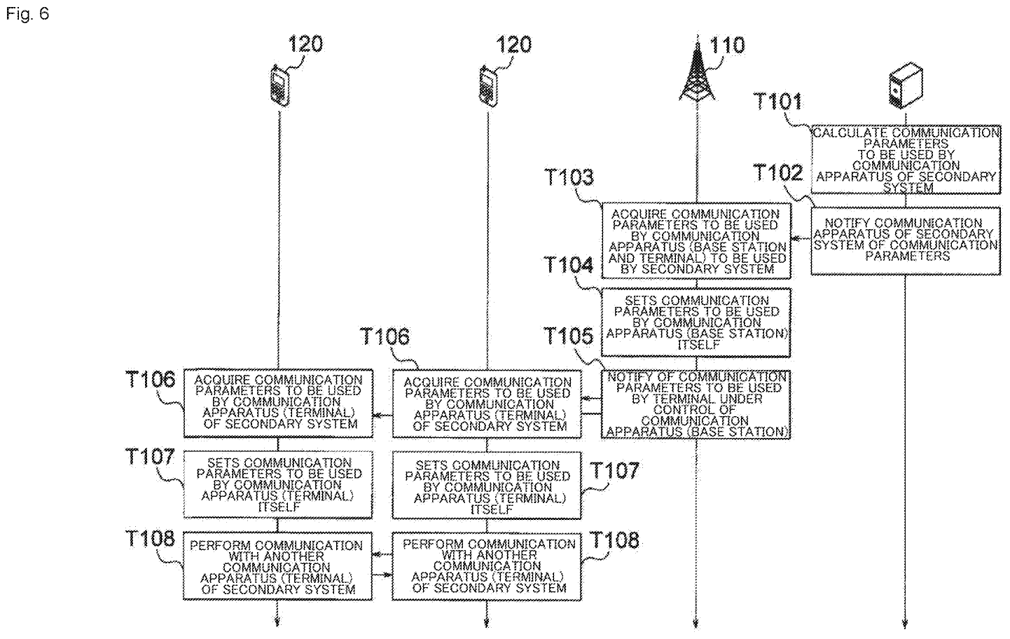

An example of a flow of signaling in a case in which device-to-device (D2D) or vehicle-to-everything (V2X), which is communication between the terminals 120 is assumed as communication of the secondary system is illustrated in FIG. 6. D2D or V2X, which is communication between the terminals 120, may be performed using a physical sidelink channel (PSCCH: Physical Sidelink Control Channel, PSSCH: Physical Sidelink Shared Channel, and PSBCH: Physical Sidelink Broadcast Channel). The communication control apparatus 130 calculates communication parameters to be used by the secondary system (T101) and notifies the communication apparatus 110 of the secondary system of the communication parameters (T102). A value of the communication parameter may be determined and notified, or conditions indicating a range of the communication parameter or the like may be determined and notified. The communication apparatus 110 acquires the communication parameters to be used by the secondary system (T103), and sets the communication parameters to be used by the communication apparatus 110 itself (T104). The terminal 120 is notified of communication parameters to be used by the terminal 120 under the control of the communication apparatus 110 (T105). Each terminal 120 under the control of the communication apparatus 110 acquires the communication parameters to be used by the terminal 120 (T106) and performs a setting (T107). Then, communication with another terminal 120 of the secondary system is performed (T108).

Communication parameters in a case in which a target frequency channel for spectrum access is used in a side link (direct communication between the terminals 120) may be notified in a form associated with a resource pool for a side link in the target frequency channel, acquired, or set. The resource pool is a radio resource for a sidelink set by a specific frequency resource or time resource. Examples of the frequency resources include a resource block and a component carrier. Examples of the time resources include a radio frame, a subframe, a slot, and a mini-slot. When a resource pool is set in a frequency channel that is a spectrum access target, the communication apparatus 110 sets the resource pool in the terminal 120 on the basis of at least one of RRC signaling, the system information, and the downlink control information. The communication apparatus 110 also sets the communication parameters to be applied in the resource pool and the sidelink, in the terminal 120, on the basis of at least one of the RRC signaling from the communication apparatus 110 to the terminal 120, the system information, and the downlink control information. The notification of a resource pool setting and the notification of communication parameters to be used in a sidelink may be performed at the same time or separately.

### 3. Embodiment of Present Invention

In the present embodiment, it is assumed that the plurality of communication apparatuses 110 that perform secondary use of the frequency band allocated to the primary system communicate with another apparatus by beamforming. The other apparatus is, for example, the terminal 120 or the other communication apparatus 110. In the present embodiment, when each communication apparatus 110 can selectively form and transmit a plurality of beams, a protection target system (such as the primary system) is effectively protected from interference with the communication apparatus 110, and transmission power for each beam is effectively controlled. This improves the utilization efficiency of the frequency band.

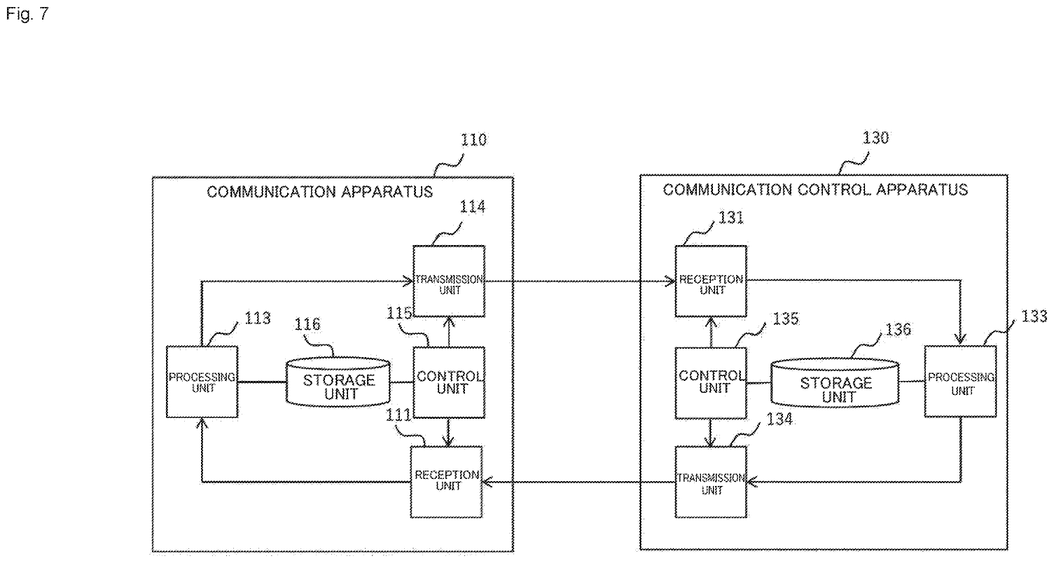

FIG. 7 is a block diagram of the communication network 100 according to an embodiment of the present disclosure.

The communication network 100 in FIG. 7 includes the communication apparatus 110 and the communication control apparatus 130. Only blocks regarding units that perform processing mainly related to the present embodiment are illustrated, and illustration of blocks regarding other processing is omitted. The communication apparatus 110 corresponds to the CBSD described above as an example, but is not limited to the CBSD and may be another apparatus such as an access point of a wireless LAN. The communication control apparatus 130 corresponds to the SAS described above as an example, but is not limited to the SAS, and may be, for example, a control apparatus of a 5G core network.

The communication control apparatus 130 includes a reception unit 131, a processing unit 133, a transmission unit 134, a control unit 135, and a storage unit 136. The control unit 135 controls the entire communication control apparatus 130 by controlling respective elements in the communication control apparatus 130.

The communication apparatus 110 includes a reception unit 111, a processing unit 113, a transmission unit 114, a control unit 115, and a storage unit 116. The control unit 115 controls the entire the communication apparatus 110 by controlling respective elements in the communication apparatus 110.

Various types of information necessary for communication with the communication apparatus 110 and other communication control apparatuses 130 are stored in the storage unit 136 of the communication control apparatus 130. The storage unit 116 of the communication apparatus 110 stores various types of information necessary for communication with the communication control apparatus 130 and communication with the terminal 120.

Each processing block of the communication control apparatus 130 is configured of a hardware circuit, software (such as a program), or both. The storage unit 136 of the communication control apparatus 130 is configured of an arbitrary storage apparatus such as a memory apparatus, a magnetic storage apparatus, or an optical disc. Each processing block of the communication apparatus 110 is configured of a hardware circuit, software (such as a program), or both. The storage unit 116 of the communication apparatus 110 is configured of any storage apparatus such as a memory apparatus, a magnetic storage apparatus, or an optical disc.

The storage unit 136 of the communication control apparatus 130 may be externally connected to the communication control apparatus 130 by wire or wirelessly, rather than being inside the communication control apparatus 130. The transmission unit 134 and the reception unit 131 in the communication control apparatus 130 may include one or a plurality of network interfaces according to the number or types of networks to which a connection can be made. The storage unit 116 of the communication apparatus 110 may be externally connected to the communication apparatus 110 by wire or wirelessly, rather than inside the communication apparatus 110. The transmission unit 114 and the reception unit 111 in the communication apparatus 110 may include one or a plurality of network interfaces depending on the number or type of connectable networks.

When the transmission unit 134 and the reception unit 131 in the communication control apparatus 130 wirelessly communicate with another apparatus, the communication control apparatus 130 may include one or a plurality of antennas. When the transmission unit 114 and the reception unit 111 in the communication apparatus 110 perform wireless communication with another apparatus, the communication apparatus 110 may include one or a plurality of antennas.

The communication apparatus 110 has a function for performing beamforming. For example, the communication apparatus 110 can select a beam corresponding to a communication partner from among a plurality of patterns of beams that can be formed by the communication apparatus 110, and transmit the selected beam. There are one or more protection target systems (for example, the primary systems) that are protection targets near each communication apparatus 110. The transmission of the beam gives interference power to a protection target system that is a protection target. The magnitude of the interference power depends on transmission power of the beam, a distance to the protection target system, a gain of an antenna on the transmitting side, a gain of an antenna on the receiving side, and the like.

The processing unit 113 of the communication apparatus 110 performs processing regarding communication with another apparatus (for example, the terminal 120 or the other communication apparatus 110). Further, the processing unit 113 performs with the communication control apparatus 130, processing necessary for communication with the other apparatus. For example, the processing unit 113 requests the communication control apparatus 130 to perform issuance of a grant, which is permission to use the frequency, as processing that is performed with the communication control apparatus 130 to perform communication with the other apparatus, acquires the grant, and performs radio wave transmission (including the beam transmission) on the basis of the acquired grant.

The processing unit 113 transmits various types of information on the communication apparatus 110 to the communication control apparatus 130. An example of the information on the communication apparatus 110 is capability information of the communication apparatus 110. The capability information includes, for example, information on the beams that can be formed by the communication apparatus 110, information necessary for the communication control apparatus 130 to calculate the beam that can be formed by the communication apparatus 110, and the like. In addition, the capability information includes various types of information to be described below. The information on the communication apparatus 110 may also include information on a position or specification of the communication apparatus 110.

The processing unit 113 transmits information for inquiring the communication control apparatus 130 about transmission power (for example, the maximum allowable transmission power) allowed for each of a plurality of beams that can be transmitted by the communication apparatus 110. The processing unit 113 receives information indicating the maximum allowable transmission power for each beam that can be transmitted by the communication apparatus 110 from the communication control apparatus 130, and transmits information indicating that the beam is transmitted, to the control unit 115 according to the received information. The control unit 115 controls the transmission power of each beam so that the transmission power is equal to or lower than the maximum allowable transmission power, on the basis of the information received from the processing unit 113. The processing unit 113 may select one of a plurality of beams that can be transmitted, depending on a position of the communication partner apparatus, and transmit a signal to the communication partner apparatus using the selected beam. The communication apparatus 110 may also be capable of simultaneously communicating with one or a plurality of apparatuses using two or more beams simultaneously.

The processing unit 133 of the communication control apparatus 130 performs processing regarding communication with one or the plurality of communication apparatuses 110. The processing unit 133 may give permission to use the frequency in response to a spectrum use notification request from each communication apparatus 110. In this case, the processing unit 133 may issue the grant indicating the permission to use the frequency, and transmit information including information on the permitted frequency band and an identifier of the grant to the communication apparatus 110.

The processing unit 133 determines transmission power (for example, the maximum allowable transmission power) allowed for each of the plurality of beams that can be transmitted by the communication apparatus 110 depending on query information from each communication apparatus 110.

The determination of the transmission power is made to protect the protection target system from power interference from the communication apparatus 110. The interference margin indicating a total of allowable interference powers is set in the protection target system. When the total (sum) of the interference powers from the plurality of communication apparatuses 110 is equal to or smaller than the interference margin, the protection target system is protected from power interference. That is, the power interference equal to or smaller than the interference margin is allowed.

In order to protect the protection target system from the power interference, the processing unit 133 calculates, for each beam of each communication apparatus 110, the interference power that each communication apparatus 110 gives to the protection target system through beam transmission. The processing unit 133 adjusts the transmission power of each beam to a value in which total interference power in a case in which the plurality of communication apparatuses 110 simultaneously transmit any beam is equal to or smaller than the interference margin, on the basis of the interference margin of the protection target system (transmission power adjustment processing). Specifically, in the transmission power adjustment processing, the transmission power for each beam is decreased (or increased) according to the interference power for each beam of each communication apparatus 110 so that the transmission power for each beam is adjusted. Details of an algorithm of an operation for decreasing the transmission power will be described below. Accordingly, the processing unit 133 determines transmission power (for example, the maximum allowable transmission power) allowed for each beam for each communication apparatus 110.

Thus, the transmission power according to the interference power allowed to be given to the protection target system is determined for each beam and for each communication apparatus, making it possible to perform efficient communication regardless of a used beam, and to efficiently use the frequency band. Further, in this case, even when the plurality of communication apparatuses 110 perform communication at the same time using the respective beams, the total interference power is within the interference margin of the protection target system. Therefore, it is possible to effectively protect the protection target system from the power interference.

The processing unit 133 generates information indicating a value of the transmission power (for example, the maximum allowable transmission power) for each beam determined for each communication apparatus 110, and transmits the generated information to each communication apparatus 110 via the transmission unit 134. This makes it possible to notify each communication apparatus 110 of the transmission power (for example, the maximum allowable transmission power) for each beam that can be transmitted by the communication apparatus 110. The transmission power of which the communication apparatus 110 is notified may be a power value to be supplied to the antenna (antenna power) or may be a power value actually radiated from the antenna. Further, the transmission power of which the communication apparatus 110 is notified may be an output power value of any circuit (for example, an amplifier) involved in signal transmission within the communication apparatus 110.

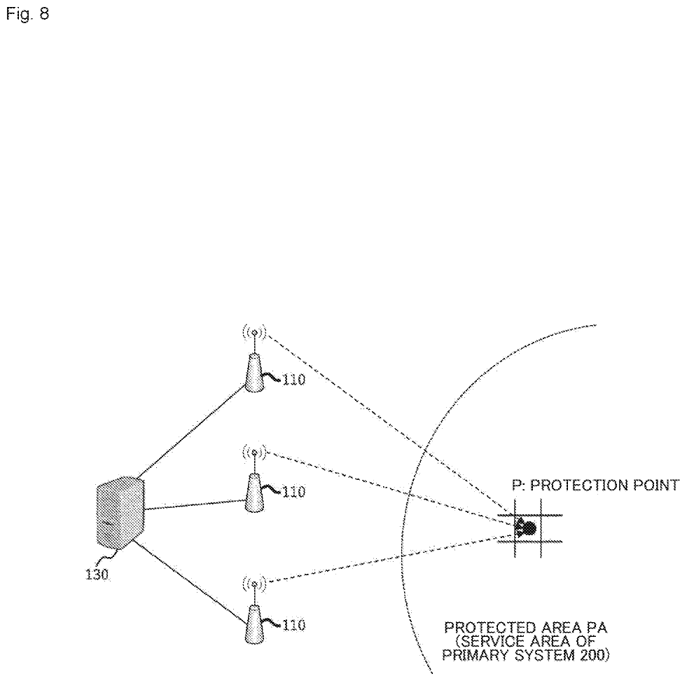

Hereinafter, the present embodiment will be described in greater detail with reference to FIGS. 8 to 26. Description will be given in the following order.
<3.1 Various Procedures Required to Realize Embodiment of Present Invention>
<3.2 Interference Calculation Model>
<3.3 Interference Margin Distribution by Existing Iterative Allocation Process (IAP)>
<3.4 IAP According to Present Embodiment>
<3.5 Calculation Amount Reduction Scheme When Beamforming Is Used>
<3.6 Details of Method of Specifying Beam Gain>
<3.7 Details of Method of Notify Communication Apparatus of Maximum Antenna Power>
<3.8 Modification Example of the IAP According to Present Embodiment>
<4 Modification Example of Present Embodiment>

<3.1 Various Procedures Required to Realize Embodiment of Present Invention>

In an embodiment of the present invention, the communication apparatus 110 having the function for performing beamforming uses a frequency band as a secondary user. In this case, the communication apparatus 110 inquires of the communication control apparatus 130 (SAS: Spectrum Access System) about maximum transmission power allowed for each of the plurality of beams that can be transmitted by the communication apparatus 110, and transmits each beam according to the maximum allowable transmission power notified of by the communication control apparatus 130.

A type of beamforming is not limited, and may be digital beamforming or analog beamforming. Further, the beamforming may also be hybrid beamforming that is a combination of both the digital beamforming and the analog beamforming.

When the communication control apparatus 130 calculates the maximum allowable transmission power of each beam, capability information of the beamforming included in the antenna information acquired through the registration procedure may be used.

The capability information is, for example, pattern information on one or more the beams that can be formed by the communication apparatus 110. The following parameters can be assumed as beam pattern information that can be used to determine the maximum allowable transmission power for each beam. The processing unit 133 can determine one or a plurality of beams that can be transmitted by the communication apparatus 110, on the basis of information (the capability information) on the communication apparatus 110.
[1] One or more precoding matrices, weight matrices or steering vectors
[2] Combination between one or more beam directions and antenna element information
[3] Combination between one or more beam directions, beam widths, and beam maximum gains
[4] Combination between one or more beam directions and a sampled beam pattern
[5] Combination between one or more beam motion areas and antenna element information
[6] Combination between one or more beam motion areas, a beam width, and a beam maximum gain
[7] Combination between the one or more beam motion areas and the sampled beam pattern

The precoding matrix, the weight matrix, or the steering vector of [1] may represent the analog beamforming, the digital beamforming, or hybrid beamforming that is a combination of both.

In the case of hybrid beamforming, the precoding matrix, the weight matrix, and the steering vector representing the analog beamforming, and the precoding matrix, the weight matrix, and the steering vector representing the digital beamforming may be notified of separately. In this case, the communication control apparatus 130 may obtain the precoding matrix, the weight matrix, and the steering vector according to a combination of these.

The beam directions in [2] to [4] are typically a horizontal direction (azimuth angle) and a vertical direction (elevation angle) in which the gain of the beam is maximized.

Similarly, the beam motion areas in [5] to [7] is typically a range in which the horizontal direction (azimuth angle) and vertical direction (elevation angle) in which the beam gain is maximized is moved.

The azimuth angle and elevation angle at which the gain of the beam is maximized may be determined as absolute values based on a reference common to all antennas, such as true north or zenith. Alternatively, the azimuth angle and elevation angle at which the gain of the beam is maximized may be determined as relative values based on an azimuth angle, elevation angle, tilt angle, or the like of the antenna included in each communication apparatus.

Further, the beam motion area may be a combination of one or more ranges in which the azimuth angle and the elevation angle at which the gain of the beam is maximized are movable, and one or more ranges in which the azimuth angle and the elevation angle are not movable.

The antenna element information in [2] and [5] typically includes, for example, information indicating the number of elements and an element spacing in each of vertical and horizontal directions of an antenna array included in the communication apparatus 110.

A beam width in [3], [6] is typically a half width from a beam direction indicating a maximum beam gain. For the beam width, different values may be used in the azimuth angle and the elevation angle.

Further, the half width needs to be necessarily used as the beam width. For example, a range of azimuth angle and the elevation angle from the beam direction required for the beam gain to be attenuated on by a constant value from the maximum gain may be used as the beam width.

The sampled beam patterns in [4] and [7] are obtained by sampling the beam patterns that can be transmitted by the communication apparatus 110 at sampling points set at the azimuth angle and the elevation angle. The beam pattern is represented by a plurality of combinations of the azimuth angle, the elevation angle, and the beam gain.

The sampling point of the beam pattern do not necessarily have to be at regular intervals. For example, only a point at which an attenuation amount from the maximum beam gain is a constant value may be given.

Further, not only a result of sampling an accurate beam pattern, but also, for example, a result of sampling an abstract beam pattern like an envelope of the beam pattern may be used.

The maximum beam gain and the beam pattern may be absolute values including an antenna gain of each element of an array antenna, or may be relative values not including the antenna gain of each element.

Further, a plurality of beam widths, beam gains, and beam patterns may be defined for one beam direction or range.

The beam width, the beam gain, and the beam pattern may be common in all beam directions and motion areas, or may be different depending on the beam directions or beam motion areas.

The communication apparatus 110 registers one or a plurality of types of [1] to [7] in the communication control apparatus 130 as capability information of the beam. The communication control apparatus 130 specifies all beam patterns that can be transmitted by the communication apparatus 110 on the basis of this capability information. The communication control apparatus 130 determines the maximum allowable power of the beam for each beam pattern for the communication apparatus 110. A method of specifying all beam patterns that can be transmitted will be described in detail in <3.6>.

The capability information of the beamforming does not necessarily have to be registered at the time of the registration procedure. The capability information of the beamforming may be registered or changed at the time of the available spectrum query procedure, the spectrum grant procedure, or spectrum use notification.

Further, for example, the capability information of the beam may include information for identifying a beam to be preferentially used or a beam in which there is no problem even when the beam cannot be used.

Further, the capability information of the beam may include a desired transmission power different for each beam. This value may be an absolute amount or may be a relative amount such as a difference from the desired transmission power of the communication apparatus.

When one communication apparatus 110 can simultaneously form a plurality of beams, for example, the communication apparatus 110 notifies the communication control apparatus 130 of an effective required transmission power obtained by multiplying the desired transmission power by the number of beams that can be simultaneously transmitted. Further, the communication apparatus 110 separately notifies the communication control apparatus of the single desired transmission power and the number of beams that can be simultaneously transmitted, and the communication control apparatus 130 may regard a power obtained by multiplying the single desired transmission power by the number of simultaneously transmittable beams as the effective required transmission power. The communication control apparatus 130 may perform calculation of the interference power using this substantial local transmission power.

Further, the communication apparatus 110 may notify the communication control apparatus 130 of the number of beams that can be simultaneously transmitted, and the communication control apparatus 130 may duplicate the communication apparatuses 110 with the same parameters by the number of beams that can be simultaneously transmitted, regard theses communication apparatus as separates communication apparatuses, and perform interference calculation.

Further, the communication control apparatus 130 may regard a value obtained by multiplying the calculated interference power of the communication apparatus 110 by the number of beams that can be simultaneously transmitted, which is notified from the communication apparatus 110, as a magnitude of effective interference power.

Further, the communication control apparatus 130 does not necessarily need to calculate the interference power for all the beams notified from the communication apparatus 110. For example, the communication control apparatus 130 may determine whether a terminal that can communicate using the beam is actually present, and exclude the beam from an interference power calculation target when the terminal is not present. When the beam is excluded from the interference power calculation target, the communication control apparatus 130 may notify the communication apparatus 110 of negative infinity in a logarithmic notation as allowable transmission power of the beam, or may notify of information indicating that transmission is not possible.

### <3.2 Interference Calculation Model>

An interference calculation model assumed in the present embodiment will be described. FIG. 8 is an illustrative diagram illustrating an example of an interference calculation model assumed in the present embodiment.

In an interference model in FIG. 8, it is assumed that the primary system 200 is a wireless system with a service area. This service area corresponds to the protection area PA of the primary system 200, for example. In the protection area PA, there are one or a plurality of interference calculation reference points (hereinafter referred to as interference calculation points or protection points P) are set. In the present embodiment, it is assumed that a plurality of protection points are set. The protection point is set by, for example, an operator of the primary system 200, a public institution that manages radio waves, or the like (hereinafter referred to as an administrator). For example, the administrator may partition the protection area into grids and set a center of a predetermined grid as the protection point. A method of determining the protection point is arbitrary. The protection point may be set not only in a horizontal direction but also in a vertical direction. That is, the protection points may be arranged three-dimensionally.

As the protection point, a point in which the communication apparatus 110 is installed may be used instead of a point provided within the service area of the primary system 200.

An interference margin (cumulative value of allowable interference power) at each protection point is set by an administrator or the like. FIG. 8 illustrates a state in which the plurality of communication apparatuses 110 constituting the secondary system interfere with the protection point. The communication control apparatus 130 needs to control the transmission power of the plurality of communication apparatuses 110 so that the cumulative interference power at each protection point does not exceed the interference margin set for each protection point.

First, a method of calculating the interference power given to each protection point from the communication apparatus 110 when the communication apparatus 110 of the secondary system does not have the function of performing beamforming will be described.

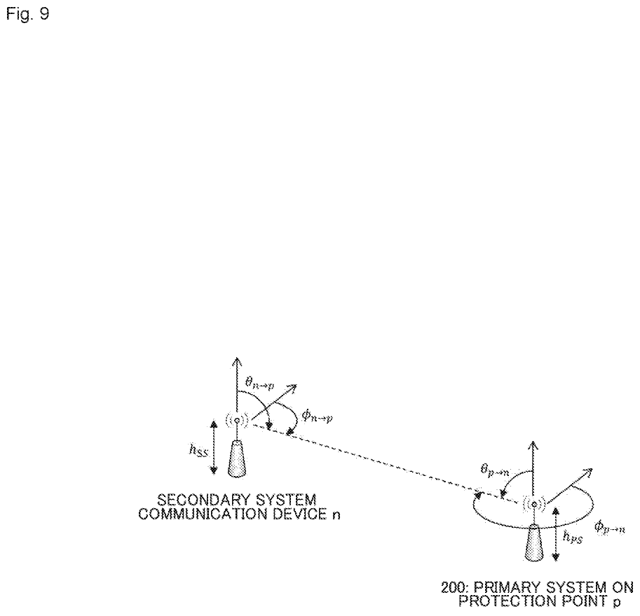

In the interference calculation, as illustrated in FIG. 9, a spatial positional relationship between a primary system with an antenna height of hₚₛ installed at a protection point p and a communication apparatus 110 of a secondary system with an antenna height of hₛₛ (a communication apparatus of any secondary system is referred to as a communication apparatus n) is considered. For example, position information and antenna height information of the primary system and the secondary system may be used to specify a direction in which the communication apparatus of the secondary system is located as seen from the primary system on the protection point p. Similarly, the direction in which the primary system on the protection point p seen from the communication apparatus n of the secondary system is located may be specified. These directions can be represented by an azimuth angle φ and an elevation angle θ. In FIG. 9, a direction of the communication apparatus n of the secondary system seen from the primary system on the protection point p is set to φ_{p→n} and θ_{p→n}, and a direction of the primary system on the protection point p seen from the communication apparatus n of the secondary system is set to φ_{n→p} and φ_{n→p}. 1<=n<=Nₚ for the total number Nₚ of communication apparatuses that are targets of the calculation of interference with the protection point p.

Using the azimuth angle and the elevation angle, the interference power from the communication apparatus n of the secondary system to the primary system installed at the protection point p is expressed by Equation (3) below.

[Math. 4]

I_{n→p}=Pₙ+Gₙ(ϕ_{n→p},θ_{n→p})−L_{n→p}+G_{PS}(ϕ_{p→n},θ_{p→n}) (3)

Each variable is defined as follows.
I_{n→p}: Interference power from the communication apparatus n of the secondary system to the primary system installed at the protection point p per used bandwidth in the primary system
Pₙ: Antenna power per used bandwidth in the primary system, of the communication apparatus n of the secondary system
Gₙ(φ_{n→p}, θ_{n→p}): Transmission antenna gain of the communication apparatus n of the secondary system in the direction (φ_{n→p}, θ_{n→p}) in which the primary system on the protection point p is located as viewed from the communication apparatus n of the secondary system.
L_{n→p}: Radio wave propagation loss between the communication apparatus n of the secondary system and the primary system on the protection point p (Note: regardless of model)
Gₚₛ (φ_{p→n}, θ_{p→n}): Reception antenna gain of the primary system in a direction (φ_{p→n}, θ_{p→n}) in which the communication apparatus n of the secondary system is located, as viewed from the primary system on the protection point p

The communication control apparatus 130 can calculate cumulative interference power to the primary system on the protection point p by performing the same calculation on the communication apparatuses 110 of all the secondary systems and obtaining a sum of results of the calculations.

In the present embodiment, the communication control apparatus 130 controls, for example, an antenna power Pₙ of the communication apparatus n of the secondary system so that the cumulative interference power satisfies a condition of Equation (4) below at all protection points p.

$$\begin{matrix}[ Math . 5 ] & \\ {I}_{a c c e p t} \geq {\sum }_{n = 1}^{{N}_{p}} {I}_{n \to p} & ( 4 )\end{matrix}$$

Here, I_{accept} is a threshold value (the interference margin) of the interference power that can be allowed by the primary system. The threshold value may be common to all the protection points p, or may be different among the respective protection points p.

Next, a method of calculating the interference power from the communication apparatus 110 (the communication apparatus n) to each protection point p when the communication apparatus 110 of the secondary system has the function for performing beamforming will be described.

First, as in a case with no function for performing beamforming, the direction φ_{p→n}, θ_{p→n} in which the communication apparatus n of the secondary system is located as viewed from the primary system on the protection point p is specified, as illustrated in FIG. 9. Further, the direction φ_{n→p}, θ_{n→p} in which the primary system on the protection point p is located as viewed from the communication apparatus n of the secondary system is specified.

Further, a total number of beams that can be formed by the communication apparatus n of the secondary system is set as Bₙ, and each beam is expressed by b (1<=b<=Bₙ). It is assumed that the communication apparatus n of the secondary system can change the transmission power for each beam.

Using the azimuth angle and the elevation angle, the interference power to the primary system installed at the protection point p when the communication apparatus n of the secondary system has formed a beam b is expressed by Equation (5) below.

[Math. 6]

I_{n,b→p}=P_{n,b}+G_{n,b}(ϕ_{n→p},θ_{n→p})−L_{n→p}+G_{PS}(ϕ_{p→n},θ_{p→n}) (5)

Each variable is defined as follows.
I_{n,b→p}: Interference power per used bandwidth of the primary system to the primary system installed at the protection point p when the communication apparatus n of the secondary system forms the beam b
P_{n,b}: An antenna power per used bandwidth of the primary system of the communication apparatus n of the secondary system when the beam b is formed
G_{n,b} (φ_{n→p}, θ_{n→p}): Beam gain of the beam b formed by the communication apparatus n of the secondary system in the direction (φ_{n→p}, θ_{n→p}) in which the primary system on the protection point p is located as seen from the communication apparatus n of the secondary system.
L_{n→p} and Gₚₛ have the same definitions as in Equation (3).

The communication control apparatus 130 performs the same calculations on all the communication apparatuses n of the secondary system and all the beams b that can be formed, and calculates a sum between the communication apparatuses n of maximum interference powers calculated for the respective beams of the communication apparatuses n. This makes it possible to calculate the worst value (maximum value) of the cumulative interference power to the primary system on the protection point p. Here, it is assumed that one communication apparatus n transmits one beam at the same time. When the communication apparatus n can simultaneously transmit a plurality of beams, the communication control apparatus 130 calculate, for each communication apparatus, total interference power in a case in which the communication apparatus n has transmitted the maximum number of beams that can be transmitted simultaneously, and calculate a cumulative maximum value of the total values calculated for all the communication apparatuses, to calculate the worst value (maximum value) of the cumulative interference power.

It is difficult for the communication control apparatus 130 to always ascertain the beam b actually formed by the communication apparatus n of the secondary system in real time. Therefore, it is necessary to set a condition of the transmission power (for example, a maximum allowable transmission power value) so that the primary system can be reliably protected regardless of which of the plurality of beams that the communication apparatus n forms (even when the communication apparatus n forms the beam with the maximum interference power). For example, in the present embodiment, the communication control apparatus 130 controls an antenna power P_{n,b} when the communication apparatus n of the secondary system forms the beam b, so that the cumulative interference power satisfies a condition of Equation (6) below at all the protection points p.

$$\begin{matrix}[ Math . 7 ] & \\ {I}_{a c c e p t} \geq {\sum }_{n = 1}^{{N}_{p}} {max}_{1 \leq b \leq {B}_{n}} {I}_{n , b \to ρ} & ( 6 )\end{matrix}$$

The antenna power P_{n,b} when the communication apparatus n of the secondary system forms the beam b may be individually controlled for each beam or may be a common value for all beams.

### <3.3 Interference Margin Distribution by Iterative Allocation Process (IAP)>

In CBRS in United States, an interference margin allocation scheme called iterative allocation process (IAP) disclosed in NPL 1 is adopted as a scheme for realizing the transmission power control of the communication apparatus 110 (the communication apparatus n) as described above.

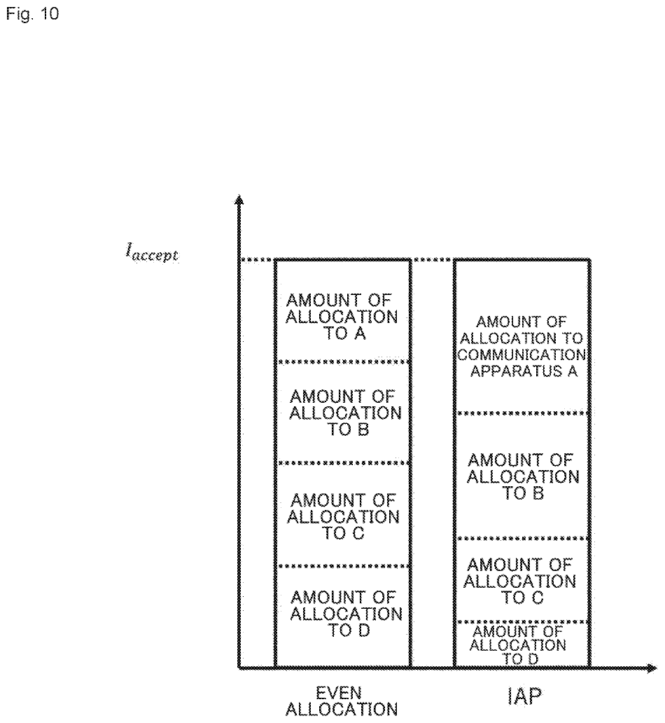

The characteristic of the IAP is that an initial value Pₙ of the antenna power of the communication apparatus n of the secondary system is decreased gradually by a constant amount until the initial value is equal to or smaller than the interference margin (allowable transmission power) allocated to the communication apparatus n. In the IAP, as shown on the right side of FIG. 10, the interference margin is allocated to each communication apparatus (communication apparatuses A to D) according to an actual amount of interference (interference power) from the communication apparatus to the primary system. That is, the interference margin of the protection target system is distributed to each communication apparatus. As an example, when the amount of interference is larger, a larger interference margin is allocated. In the CBRS, the calculation of the IAP is performed for each spectrum grant, not for each communication apparatus. The left side of FIG. 10 shows an even allocation method for evenly allocating the interference margins of protection points to a plurality of communication apparatuses A to D as a scheme different from the IAP.

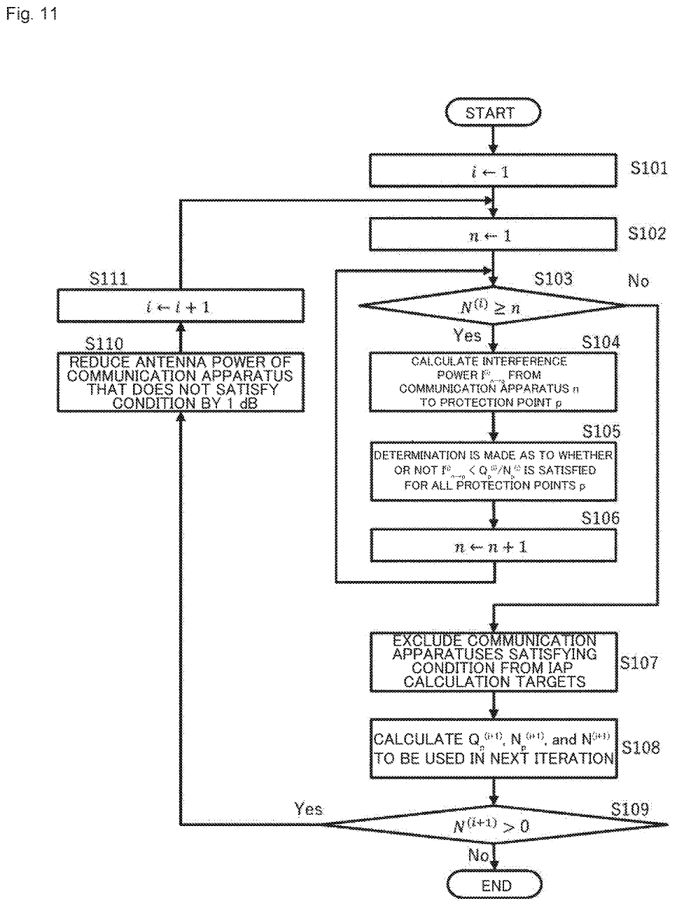

FIG. 11 is a flowchart of the IAP for obtaining a maximum antenna power Pₙ′ that can be transmitted by the communication apparatus n of the secondary system after the condition of Equation (4) is satisfied. In description below, the number of the IAP iterations is represented by i (i>=1), and initially i=1 (S101).

The communication apparatus of the secondary system that is a calculation target of the IAP targets for any protection point p is represented by n (1<=n<=N⁽ⁱ⁾). N⁽ⁱ⁾ is a total number of communication apparatuses in the secondary system that are the calculation of the IAP targets for any one or more protection points p at a point in time of the number i of iterations. Since all communication apparatuses are initially the calculation targets, N⁽ⁱ⁾ is the number (Nₚ) of all communication apparatuses that are targets of the interference calculation. As initial processing, n=1 (S102), and since n is equal to or smaller than N⁽ⁱ⁾ (Yes in S103), the interference power to the primary system installed at each protection point p is calculated (S104). Interference power I⁽ⁱ⁾_{n→p} for the protection point p when the number of the IAP iterations is i can be expressed by Equation (7) below.

[Math. 8]

I_{n→p}⁽ⁱ⁾=Pₙ⁽ⁱ⁾+Gₙ(ϕ_{n→p},θ_{n→p})−L_{n→p}+G_{PS}(ϕ_{p→n},θ_{p→n}) (7)

P⁽ⁱ⁾ₙ is the antenna power of the communication apparatus n of the secondary system, which is set at a point in time at which the number of the IAP iterations is i. An initial value P⁽¹⁾ₙ of P⁽ⁱ⁾ₙ may be a desired antenna power Pₙ that the communication apparatus n requests the communication control apparatus 130 to provide.

Next, a determination is made as to whether or not the interference power from the communication apparatus n is equal to or smaller than the allowable value for all the protection points p (S105). Here, Q⁽ⁱ⁾ₚ is a total amount of unassigned interference margin with respect to the protection point p at the point in time at which the number of iterations is i (that is, a residual interference margin obtained by subtracting the interference margin allocated to the communication apparatus from the interference margin of the protection target system). N⁽ⁱ⁾ₚ is the number of communication apparatuses in the secondary system for which calculation of the interference power to the protection point p is required. A value obtained by dividing Q⁽ⁱ⁾ₚ by N⁽ⁱ⁾ₚ is defined as an allowable value of an interference power with the protection point p per communication apparatus. A determination is made as to whether a condition of Equation (8) below is satisfied for all the protection points p.

[Math. 9]

I_{n→p}⁽ⁱ⁾<Qₚ⁽ⁱ⁾/Nₚ⁽ⁱ⁾ (8)

Initial values of the total amount of unassigned interference margin (residual interference margin) and the number of communication apparatuses in the secondary system for which calculation of the interference power to the protection point p is required may be Q⁽¹⁾ₚ=I_{accept} and N⁽¹⁾ₚ=Nₚ.

Steps S104 and S105 above are applied to all of N⁽ⁱ⁾ communication apparatuses of the secondary system (Yes in S106 and S103). All communication apparatuses n satisfying the condition of Equation (8) are excluded from the calculation of the IAP targets after the next iteration (S107). The maximum antenna power P⁽ⁱ⁾ₙ set at a point in time of the exclusion becomes the maximum antenna power Pₙ′ allowed for the communication apparatus n.

The interference power I⁽ⁱ⁾_{n→p} are summed for all the excluded communication apparatuses and subtracted from the total amount of interference margin Q⁽ⁱ⁾ₚ (residual interference margin), thereby calculating a total amount Q⁽ⁱ⁺¹⁾ₚ of the interference margin in the next (i+1)-th iteration (S108). Further, among the N⁽ⁱ⁾ₚ communication apparatuses of the secondary system for which calculation of the interference calculation to the protection point p is required, the number of communication apparatuses that did not satisfy the condition of Equation (8) is calculated as the number N⁽ⁱ⁺¹⁾ₚ of communication apparatuses in the secondary system for which calculation of the interference power is required in the next (i+1)-th iteration (S108). Further, in the next (i+1)-th iteration, the number N⁽ⁱ⁺¹⁾ of communication apparatuses that are the calculation of the IAP targets at least one protection point p is calculated (S108).

When communication apparatuses that do not satisfy the condition of Equation (8) remain at any one or more protection points, that is,

N⁽ⁱ⁺¹⁾>0

(Yes in S109), the antenna power of the communication apparatus that does not satisfy the condition is decreased by 1 dB (S110), and the decreased antenna power is used in the next (i+1)-th iteration (S110). That is, the antenna power used in the (i+1)-th iteration can be expressed as P⁽ⁱ⁺¹⁾ₙ=P⁽ⁱ⁾ₙ−1.

The IAP is iterated until all communication apparatuses satisfy the condition, that is, until N⁽ⁱ⁺¹⁾=0. This makes it possible to obtain a maximum allowable antenna power Pₙ′ for all the communication apparatuses.

In the above description of the IAP, the communication apparatus that does not have the function for performing beamforming has been used as an example. In the case of a communication apparatus having the function for performing beamforming, an antenna gain used in Equation (7) for calculating the interference power is replaced with, for example, a maximum value of the beam gain G_{n,b}(φ_{n→p}, θ_{n→p}) so that the maximum interference power can be obtained. Alternatively, the antenna pattern is replaced with a synthesis antenna pattern obtained by synthesizing all beam patterns, and the interference power is calculated, so that it is possible to obtain the maximum antenna power Pₙ′ that can be transmitted by each communication apparatus in the same procedure. The synthesis of the beam patterns may be intended to obtain a maximum envelope of all beams, or may be intended to obtain an average value of beam gains of all the beams.

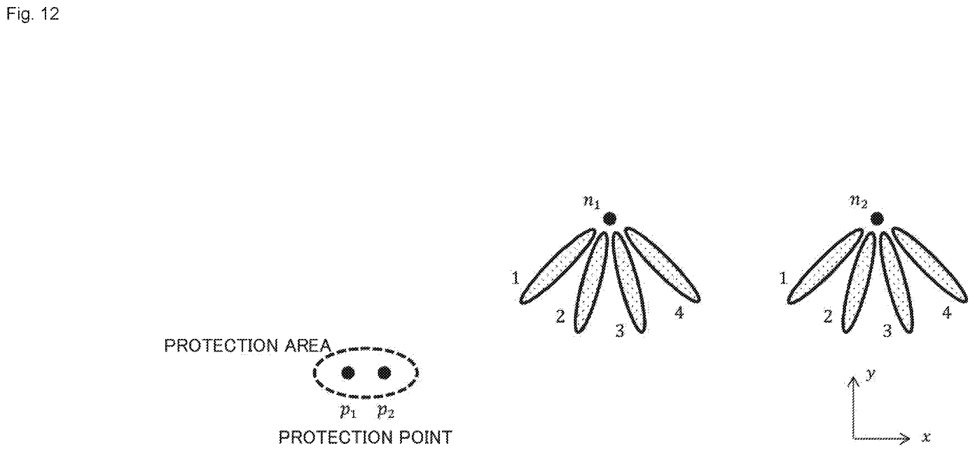

Hereinafter, how the interference power of each beam changes when the antenna power Pₙ′ is obtained by the IAP for the communication apparatus having the function for performing beamforming will be described. A protection area including two protection points of p=p₁ and p₂ as illustrated in FIG. 12, and two communication apparatuses of the secondary system of n=n₁ and n₂ at different distances from the protection area are considered. It is assumed that the communication apparatus n₂ is disposed farther from the protection area than the communication apparatus n₁, and average interference power is low. Further, it is assumed that the two communication apparatuses can both form four beams (b=1, . . . , 4).

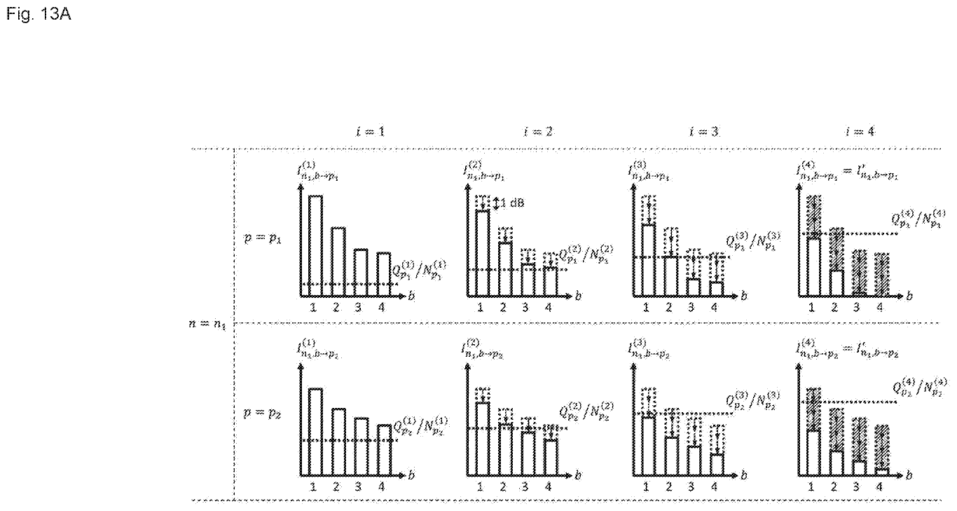

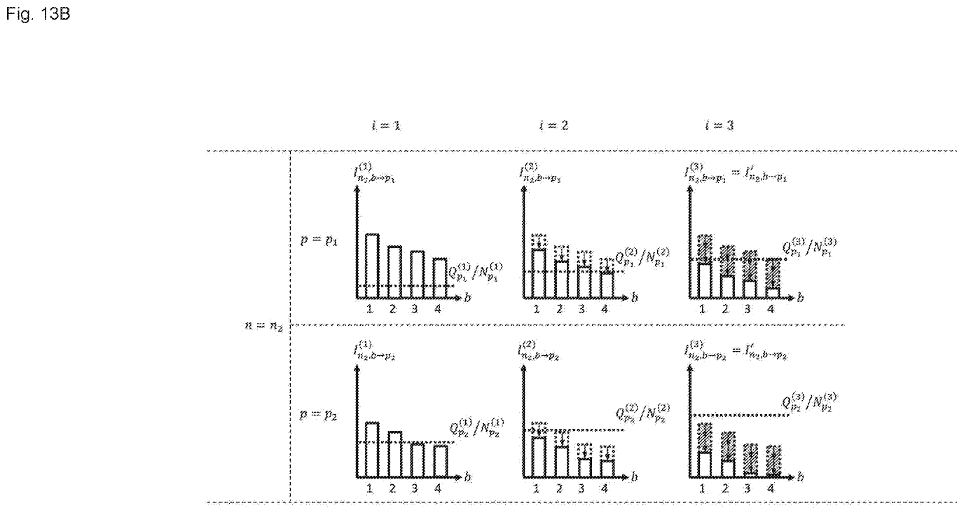

FIGS. 13A and 13B schematically illustrate how the interference power from two communication apparatuses n₁ and n₂ to the protection points p₁ and p₂ changes as the number i of iterations of the IAP increases. In a disposition illustrated in FIG. 12, it is assumed that the interference power from each beam of n₁ and n₂ to the protection points p₁ and p₂ both decreases in order of b=1, . . . , 4 at a point in time of i=1. That is, a beam with the maximum beam gain in a protection point direction is b=1 for both protection points. Therefore, the two communication apparatuses n₁ and n₂ are the calculation of the IAP targets until the interference powers I⁽ⁱ⁾_{n,1→p1} and I⁽ⁱ⁾_{n,1→p2} from this beam to the two protection points are lower than Q⁽ⁱ⁾ₚ/N⁽ⁱ⁾ₚ that is an allowable value according to the condition of Equation (8).

Further, since other communication apparatuses satisfying the condition of Equation (8) with an increase of i are excluded from the calculation targets, the allowable value Q⁽ⁱ⁾ₚ/N⁽ⁱ⁾ₚ to each protection point allocated to each communication apparatus is assumed to increase gradually. Further, it is assumed that the allowable value is different for the two protection points.

First, for the communication apparatus n₁, when i=3, I⁽³⁾_{n1,1→p2} is lower than Q⁽³⁾ₚ₂/N⁽³⁾p₂, but I⁽³⁾_{n1,1→p1} still exceeds Q⁽³⁾ₚ₁/N⁽³⁾ₚ₁ at this point in time, as illustrated in FIG. 13A, and thus, the communication apparatus n1 is not excluded from the calculation targets. When i=4, I⁽⁴⁾_{n1,1→p1} is smaller than Q⁽⁴⁾ₚ₁/N⁽⁴⁾ₚ₁, and thus, the communication apparatus n₁ is excluded from subsequent the calculation of the IAP targets. When the communication apparatus is excluded at i=4, interference I′_{n1,b→p} actually given to each protection point by the communication apparatus n₁ is I′_{n1,b→p}=I⁽⁴⁾_{n1,b→p} (b=1, . . . ,4, p=p₁, p₂).

Similarly, for the communication apparatus n₂, I⁽²⁾_{n2,1→p2} is smaller than Q⁽²⁾ₚ₂/N⁽²⁾ₚ₂ at i=2 as illustrated in FIG. 13B, but I⁽²⁾_{n2,1→p1} still exceeds Q⁽²⁾ₚ₁/N⁽²⁾ₚ₁ at this point in time, and thus, the communication apparatus n2 is not excluded from the calculation of the IAP targets. Since I⁽³⁾_{n2,1→p1} is smaller than Q⁽³⁾ₚ₁/N⁽³⁾ₚ₁ at i=3, the communication apparatus n₂ is excluded from the subsequent the calculation of the IAP targets. When the communication apparatus n₂ is excluded at i=3, interference I′_{n2,b→p} actually given by the communication apparatus to each protection point is I′_{n2,b→p}=I⁽³⁾_{n2,b→p} (b=1, . . . , 4, p=p₁, p₂).

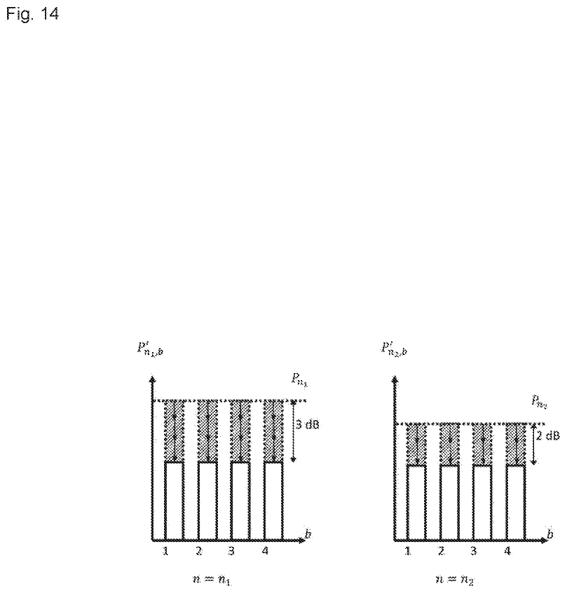

FIG. 14 illustrates a final value of the antenna power that is used when the communication apparatuses n₁ and n₂ form each beam after IAP is performed as illustrated in FIGS. 13A and 13B. Pₙ₁ and Pₙ₂ are initial values of the maximum antenna power of the communication apparatuses n₁ and n₂, and P′_{n1,b} and P′_{n2,b} indicate the maximum antenna powers allowed when the communication apparatuses n₁ and n₂ form each beam. As a result of the IAP, P′_{n1,b} decreases by 3 dB from the initial value and P′_{n2,b} decreases by 2 dB from the initial value for all the beams b.

As illustrated in FIGS. 13A and 13B, there is no problem in transmission at a higher transmission power as long as actual interference powers I′_{n,b→p1}, and I′_{n,b→p2} to the two the protection points are lower than the maximum interference power I′_{n,bmax→p}, except for beams with maximum interference power (bₘₐₓ=1 for both communication apparatuses n₁ and n₂). However, in the IAP of the related art, since the antenna power of each beam is decreased by the same amount for each beam in each iteration processing, the transmission power is excessively suppressed. Therefore, in order to make the most effective use of a beamforming function used in 5G, or the like, an interference margin allocation scheme that can individually control the antenna power of the beam while ensuring that the primary system is protected from interference is needed.

### <3.4 IAP According to Present Embodiment>

PTL 1 to PTL 3 disclose interference margin allocation schemes that enable individual control of the antenna powers of the beams in consideration of the beamforming function. However, these schemes are based on a scheme for calculating the transmission power of each communication apparatus through back-calculation from the allowable interference power distributed to each communication apparatus. Therefore, these schemes cannot cope with a scheme for allocating the interference margin to each communication apparatus more flexibly while decreasing the transmission power by a constant amount like the IAP.

The present embodiment provides a scheme (the IAP according to the present embodiment) capable of achieving both more flexible interference margin allocation than an existing IAP and the individual control of the antenna powers of the beams.

In the IAP according to the present embodiment, the transmission power is gradually decreased by a constant amount for each beam until the transmission power becomes equal to or smaller than the interference margin (allowable transmission power) allocated to the communication apparatus n with respect to an initial value P_{n,b} of the antenna power when the communication apparatus n of the secondary system forms the beam b. Here, a total number of beams formed by the communication apparatus n is Bₙ. In the present embodiment, basically, an interference margin is allocated to each communication apparatus according to an amount of interference (interference power) given to the primary system from the actual communication apparatus, like the existing IAP. In the following description, although it is assumed that the IAP according to the present embodiment is executed for each communication apparatus, the IAP may be performed for each frequency use permission (grant), like the existing IAP.

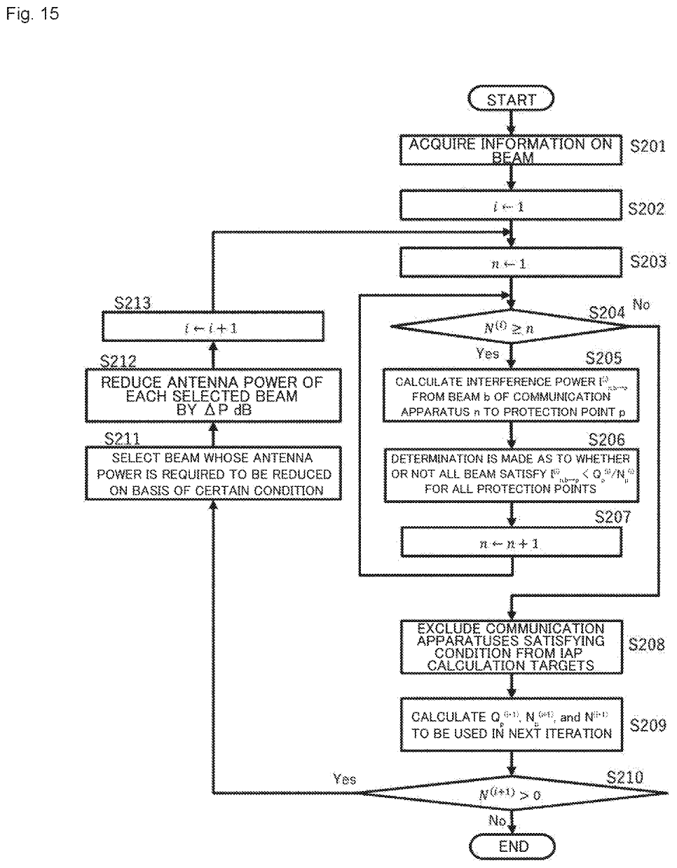

FIG. 15 illustrates an example of a flowchart of the IAP according to the present embodiment for obtaining a maximum antenna power P′_{n,b} for each beam b that can be formed by the communication apparatus n of the secondary system after the condition of Equation (6) is satisfied. An operation of the present flowchart is performed by the processing unit 133 of the communication control apparatus 130.

First, capability information of the beam is acquired from the communication apparatus (S201). The number of the IAP iterations is represented by i (i>=1), and initially i=1 (S202). The communication apparatus of the secondary system that is the calculation of the IAP target for any protection point is represented by n (1<=n<=N⁽ⁱ⁾). N⁽ⁱ⁾ is a total number of communication apparatuses in the secondary system that are the calculation of the IAP targets for any one or more protection points at a point in time of the number i of iterations. As initial processing, n=1 is set (S203). Since n is equal to or smaller than N⁽ⁱ⁾ (Yes in S204), the processing proceeds to step S205. In step S205, when the communication apparatus n forms each beam, the interference power to the primary system installed at each protection point is calculated (S205). Specifically, an interference power I⁽ⁱ⁾_{n,b→p} to the protection point p at the number i of iterations of the IAP when the communication apparatus n forms the beam b is calculated by Equation (9) below.

[Math. 10]

I_{n,b→p}⁽ⁱ⁾=P_{n,b}⁽ⁱ⁾+G_{n,b}(ϕ_{n→p},θ_{n→p})−L_{n→p}+G_{PS}(ϕ_{p→n},θ_{p→n}) (9)

P⁽ⁱ⁾_{n,b} is the antenna power when the communication apparatus n of the secondary system has formed the beam b, which is set at the point in time at which the number of the IAP iterations is i. Here, an initial value P⁽¹⁾_{n,b} of P⁽ⁱ⁾_{n,b} may be the antenna power P_{n,b} of each beam that the communication apparatus n requests the communication control apparatus 130 to provide. P_{n,b} may be common to all beams formed by the communication apparatus n, or respective different values may be set.

Next, a determination is made as to whether or not the interference power I⁽ⁱ⁾_{n,b→p} is equal to or smaller than the allowable value for all beams formed by the communication apparatus n (S206). Specifically, at the point in time at which the number of iterations is i, the interference power Q⁽ⁱ⁾ₚ/N⁽ⁱ⁾ₚ to the protection point p allowed per communication apparatus may be calculated, and a determination may be made as to whether or not all the beams b satisfy a condition of Equation (10) below for all the protection points p. Q⁽ⁱ⁾ₚ corresponds to a residual interference margin of a protection target. Q⁽ⁱ⁾ₚ/N⁽ⁱ⁾ₚ is calculated on the basis of a remaining margin of the protection target and the number of communication apparatuses whose interference power is not smaller than the allowable interference power (interference margin). That is, Q⁽ⁱ⁾ₚ/N⁽ⁱ⁾ₚ is calculated by dividing the remaining margin by the number of communication apparatuses. A communication apparatus whose interference power is not smaller than the allowable interference power (interference margin) for the protection point p corresponds to the first communication apparatus according to the present embodiment. A communication apparatus whose interference power is smaller than the allowable interference power (interference margin) for the protection point p corresponds a second communication apparatus.

[Math. 11]

I_{n,b→p}⁽ⁱ⁾<Qₚ⁽ⁱ⁾/Nₚ⁽ⁱ⁾ (10)

The condition of Equation (10) is equivalent to a condition of Equation (11) that a worst value (maximum value) of the interference power I⁽ⁱ⁾_{n,b→p} of each beam is smaller than Q=⁽ⁱ⁾ₚ/N⁽ⁱ⁾ₚ.

$$\begin{matrix}[ Math . 12 ] & \\ {max}_{1 \leq b \leq {B}_{n}} {I}_{n , b \to p}^{( i )} < {Q}_{p}^{( i )} / {N}_{p}^{( i )} & ( 11 )\end{matrix}$$

Initial values of Q⁽ⁱ⁾ₚ and N⁽ⁱ⁾ₚ may be Q⁽ⁱ⁾ₚ=I_{accept} and N⁽¹⁾ₚ=Nₚ.

Further, a determination may be made as to whether or not an average value satisfies the condition of Equation (10), instead of the worst value of the interference power I⁽ⁱ⁾_{n,b→p} of all beams. The average value of the interference power may be a weighted average value obtained by weighting the interference power of each beam according to a temporal use rate of the beam. For the beam use rate, a set value, a value obtained by actually measuring a use situation, or the like may be obtained from the communication apparatus. Further, in addition to the temporal use rate, the interference power of each beam may be weighted according to a size of the geographical coverage of each beam. The coverage of each beam may be acquired from the communication apparatus, or may be obtained by the communication control apparatus 130 in consideration of radio wave propagation, topography, and the like.

Steps S205 and S206 above are applied to all of N⁽ⁱ⁾ communication apparatuses of the secondary system (S207). The communication apparatus n satisfying all the conditions of Equation (10) for all beams to be formed and for all protection points is excluded from the calculation of the IAP targets after the next iteration (S208). The maximum antenna power P⁽ⁱ⁾_{n,b} (transmission power) set for each beam at a point in time of the exclusion is the maximum antenna power P′_{n,b} (transmission power) allowed when the communication apparatus n forms the beam b. That is,

Worst values (maximum values) of the interference powers of the respective beams

$${max}_{1 \leq b \leq {B}_{n}} {I}_{n , b \to p}^{( i )}$$

are summed for all the communication apparatuses (second communication apparatuses) excluded from the calculation of the IAP targets. A value obtained by subtracting a sum of the worst values (maximum values) from a total interference margin Q⁽ⁱ⁾ₚ is used as a total interference margin Q⁽ⁱ⁺¹⁾ₚ in the next i+1-th iteration (S209). Further, among the N⁽ⁱ⁾ₚ communication apparatuses of the secondary system for which calculation of the interference power to the protection point p is required, the number of communication apparatuses (first communication apparatuses) that did not satisfy the condition of Equation (10) becomes the number N⁽ⁱ⁺¹⁾ₚ of communication apparatuses in the secondary system for which calculation of the interference power is required in the next (i+1)-th iteration (S209). At any one or more protection points, the number of communication apparatuses that fail to satisfy the condition of Equation (10) becomes N⁽ⁱ⁺¹⁾ in the next (i+1)-th iteration (S209).

When communication apparatuses that do not satisfy the condition of Equation (10) remain at any one or more protection points, that is, N⁽ⁱ⁺¹⁾>0 (in S210 Yes), the processing proceeds to step S211. In step S211, one or more beams satisfying a certain criterion (or condition) to be described below are selected from among the beams formed by the respective communication apparatuses that do not satisfy the condition (S211). For the selected beams, for example, a predetermined amount of power is decreased from the antenna power P⁽ⁱ⁾_{n,b} (S212). The decreased power is used as the antenna power of the beam b in the interference calculation of the next i+1-th iteration. That is, the antenna power of the communication apparatus n when the beam b used in the (i+1)-th iteration is formed can be expressed as P⁽ⁱ⁺¹⁾_{n,b}=P⁽ⁱ⁾_{n,b}−ΔP using a predetermined decrease amount ΔP.

The above steps are iterated until there are no communication apparatuses that cannot satisfy the condition of Equation (10), that is, until N⁽ⁱ⁺¹⁾=0 (No in S213 and S210). This makes it possible to obtain the maximum antenna power P′_{n,b} for each beam to be formed, for all the communication apparatuses.

### [Beam Selection Criteria]

Criteria (or conditions) for selecting a beam whose antenna power needs to be decreased in step S211 will be described.

Any one of criteria such as a magnitude of interference power given to the protection point by each beam, a magnitude of SINR at the protection point, a magnitude of the beam gain in the protection point direction, and an aiming direction of the beam, or a combination of two or more of these may be used.

When the magnitude of the interference power is used as a reference, specifically, for example, a beam may be selected on the basis of any of the following references, or a combination of two or more of these references.
[1] Select a beam with the maximum interference power and a beam with a difference in interference power from the maximum interference power that is smaller than (or equal to or lower than) ΔP [dB], for each protection point, in the same communication apparatus
[2] Select a beam whose interference power is higher than (or equal to or higher than) the allowable interference power Q⁽ⁱ⁾ₚ/N⁽ⁱ⁾ₚ for each protection point
[3] Select only a beam with maximum interference power for each protection point
[4] Select a plurality of beams with highest interference power for each protection point

At a point in time at which the number of iterations is i, the beam of the communication apparatus n that satisfies the criterion of [1] (that is, a beam in which an interference power difference from the maximum interference power is smaller than ΔP [dB]), for example, can be expressed as the beam b that satisfies Equation (12) below.

$$\begin{matrix}[ Math . 13 ] & \\ {I}_{n , b \to p}^{( i )} > {max}_{1 \leq b \leq {B}_{n}} {I}_{n , b \to p}^{( i )} - Δ P & ( 12 )\end{matrix}$$

Further, a difference from the maximum interference power used as a criterion of [1] does not necessarily have to be the same as a reduction amount ΔP of the antenna power used in step S212, and may be more generally second power. The second power may be ΔP or may be a value different from ΔP.

Similarly, the beam of the communication apparatus n that satisfies the criterion of [2] can be expressed as the beam b that satisfies Equation (13) below, for example.

[Math. 14]

I_{n,b→p}⁽ⁱ⁾>Qₚ⁽ⁱ⁾/Nₚ⁽ⁱ⁾ (13)

Further, it is not always necessary to decrease the predetermined value of ΔP for the antenna power of the selected beam. For example, when the criterion of [1] is used, antenna power of a beam bₘₐₓ giving the maximum interference to each protection point is decreased by ΔP (first power), and, for the other selected beam, a reduction amount ΔP′ of the antenna power may be determined so that the interference power is equal to interference power of the beam bₘₐₓ.

$${I}_{n , {b}_{max} \to p}^{( i )} = {max}_{1 \leq b \leq {B}_{n}} {I}_{n , b \to p}^{( i )}$$

ΔP′ corresponds to an example of a third power decreased from the antenna power of the other selected beam. In this case, since the amount of reduction of each beam differs for each beam and for each protection point, the amount of reduction can be expressed as in Equation (14) below.

[Math. 15]

ΔP_{n,b,p}′=I_{n,b→p}⁽ⁱ⁾−(I_{n,b}_{ₘₐₓ}_{→p}⁽ⁱ⁾−ΔP) (14)

When there are a plurality of protection points, a reduction amount ΔP′_{n,b,p} is obtained at each protection point, and a maximum value for the protection point p is set as a final reduction amount ΔP′_{n,b} of the beam b. That is, the reduction amount can be expressed as Equation (15) below.

$$\begin{matrix}[ Math . 16 ] & \\ Δ {P}_{n , b}^{′} = {max}_{p} Δ {P}_{n , b , p}^{′} & ( 15 )\end{matrix}$$

Using this ΔP′_{n,b}, the antenna power P⁽ⁱ⁺¹⁾ₙ,b of each beam used in the next iteration i+1 can be expressed by Equation (16) below. (Note: P⁽ⁱ⁺¹⁾_{n,b} on the right side of Equation (16) in the proposal is corrected into to P⁽ⁱ⁾_{n,b})

[Math. 17]

P_{n,b}⁽ⁱ⁺¹⁾=P_{n,b}⁽ⁱ⁾−ΔP_{n,b}′ (16)

Further, in any criterion of [1] to [4], when the beams selected at the respective protection points are different, the beams may all be antenna power reduction targets as long as the beams are selected at any one or more protection points.

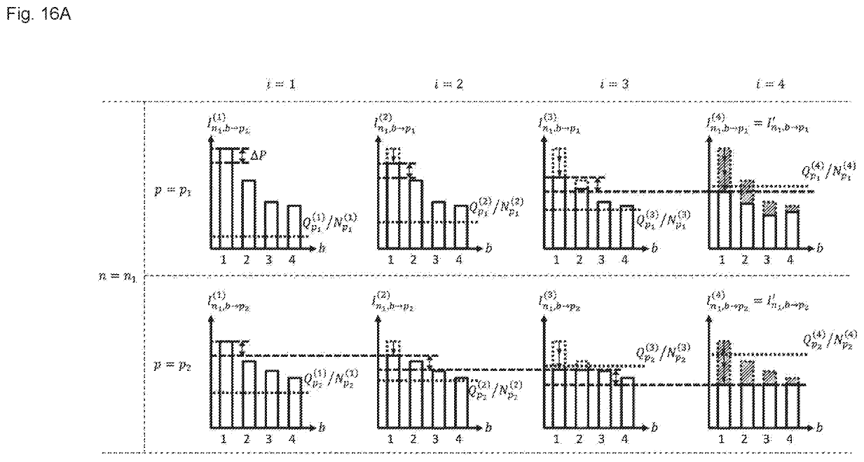

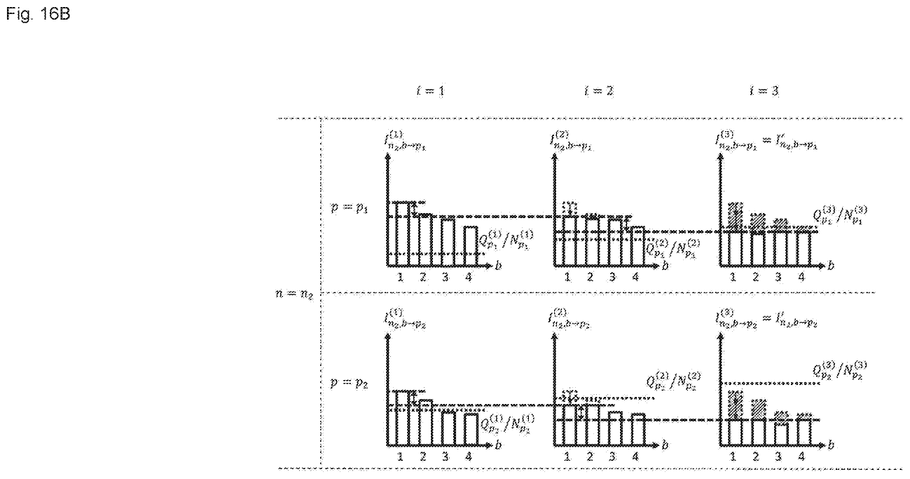

FIGS. 16A and 16B illustrate an example (example 1) schematically showing how the interference power from the two communication apparatuses n₁ and n₂ disposed as illustrated in FIG. 12 to the protection points p₁ and p₂ changes as the number i of iterations of the IAP increases in calculation of the IAP according to the present embodiment. In Example 1, a case in which the antenna power of the beam is decreased as shown in Equation (14) using the criterion of [1] is shown.

First, the communication apparatus n₁ will be described with reference to FIG. 16A. At i=1, beam 1 has the maximum interference power at both the protection points p₁ and p₂. Since there is no beam with interference power within ΔP from this value, only the beam 1 becomes a reduction target, and the antenna power of the beam 1 is decreased by ΔP.

The beam 1 has the maximum interference power at both the protection points p₁ and p₂ when i=2. At p₁, only the beam 1 becomes the reduction target. On the other hand, at p₂, since the beam 1 becomes the reduction target and the beam 2 has interference power within ΔP from the interference power of the beam 1, the beam 2 also becomes the reduction target. That is, the beam 2 does not become the reduction target at the protection point p₁, but at the protection point p₂, it is necessary to decrease the beam by

Iₙ_{₁}_{,2→p}_{₂}⁽²⁾−(Iₙ_{₁}_{,1→p}_{₂}⁽²⁾−ΔP),

and thus, the beam 2 is decreased by

Iₙ_{₁}_{,2→p}_{₂}⁽²⁾−(Iₙ_{₁}_{,1→p}_{₂}⁽²⁾−ΔP)

according to Equation (15) above with a reduction determination for the protection point p₂ prioritized. The power decreased from the beam 2 corresponds to the third power as an example.

When i=3, it is necessary to decrease the antenna power of both the beams 1 and 2 by ΔP for both p₁ and p₂. That is, since the amount of reduction for the beam 1 is ΔP, but the reduction amount of p₂ (=ΔP) for the beam 2 is larger than that of the beam 1, the reduction amount of p₂ is adopted and an actual amount of reduction is ΔP. Further, for the beam 3, the beam 3 is not the reduction target at the protection point p₁, whereas the beam 3 becomes the reduction target at the protection point p₂, and thus, the antenna power of the beam 3 needs to be decreased as a result.

Ultimately, at i=4, a condition of the allowable interference power is satisfied for all the protection points and all the beams, and the communication apparatus n₁ is excluded from the calculation targets. Further, final interference power from each beam to each protection point p is

Iₙ_{₁}_{,b→p}′=Iₙ_{₁}_{,b→p}⁽⁴⁾.

Next, the communication apparatus n2 will be described with reference to FIG. 16B. At i=1, the beams 1 and 2 are reduction targets at both p₁ and p₂. In the beam 1, the antenna power is decreased by ΔP. For the beam 2, since the amount of reduction in p₂ is greater than the amount of reduction in p₁, the amount of reduction in p₂ is prioritized, and the antenna power is decreased by the amount of reduction in p₂.

At i=2, all beams are the reduction targets at both the protection points p₁ and p₂. In the beam 1, the antenna power is decreased by ΔP. For the beams 2 and 4, since the amount of reduction at the protection point p₂ is greater than the amount of reduction at the protection point, the antenna power is decreased by the amount of reduction at the protection point p₂. For the beam 3, since the amount of reduction at the protection point p₁ is greater than the amount of reduction at the protection point p₂, the antenna power is decreased by the amount of reduction at the protection point p₁.

Ultimately, at i=3, the condition of the allowable interference power is satisfied for all the protection points and all the beams, and the communication apparatus n2 is excluded from calculation targets.

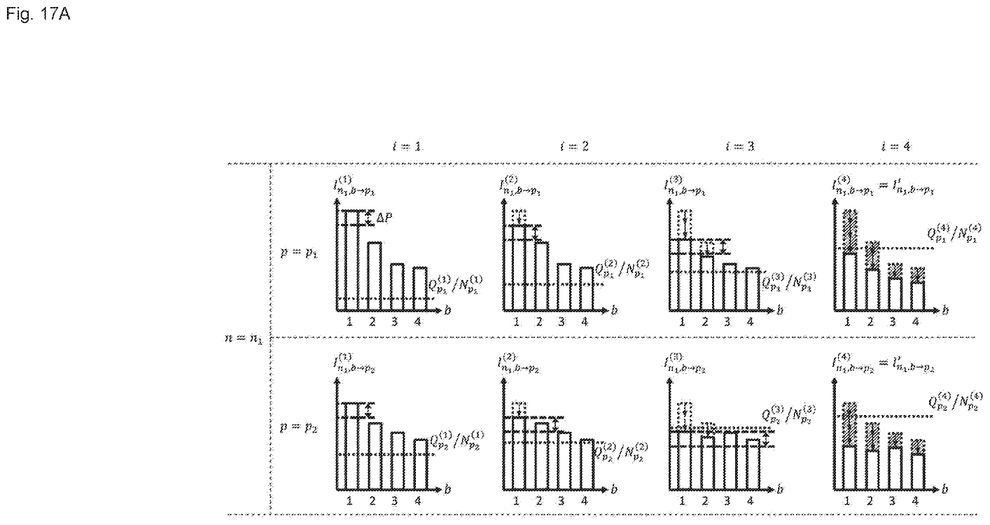

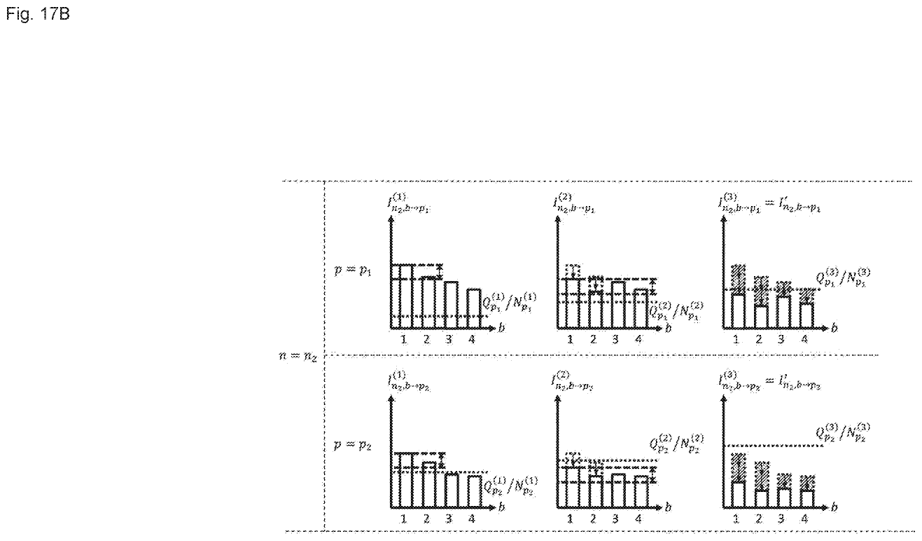

FIGS. 17A and 17B illustrate another example (Example 2) schematically showing change according to an increase in the number i of iterations of the IAP in the calculation of the IAP according to the present embodiment. In Example 2, an example of change in the interference power in a case in which the antenna power of the beam is always decreased by ΔP is shown using the criterion of [1].

First, as illustrated in FIG. 17A, in the communication apparatus n₁, only the beam 1 becomes the reduction target at i=1 for both the protection points p₁ and p₂, and the antenna power of the beam 1 is decreased by ΔP.

When i=2, the beam 1 becomes a reduction target at both the protection points p₁ and p₂, and the antenna power of the beam 1 is decreased by ΔP. Further, for the protection point p₂, since the beam 2 is also the reduction target, the antenna power of the beam 2 is decreased by ΔP even when the beam 2 is not the reduction target at the protection point p₁.

When i=3, only the beam 1 becomes the reduction target at the protection point p₁, but all the beams are the reduction targets at the protection point p₂. Therefore, as a result, the antenna power is decreased by ΔP for all the beams.

Next, for the communication apparatus n₂, the beams 1 and 2 are the reduction targets at both the protection points p₁ and p₂ at i=1, and the antenna power of the beams 1 and 2 is decreased by ΔP, as illustrated in FIG. 17B. It can be seen that all beams are reduction targets at i=2.

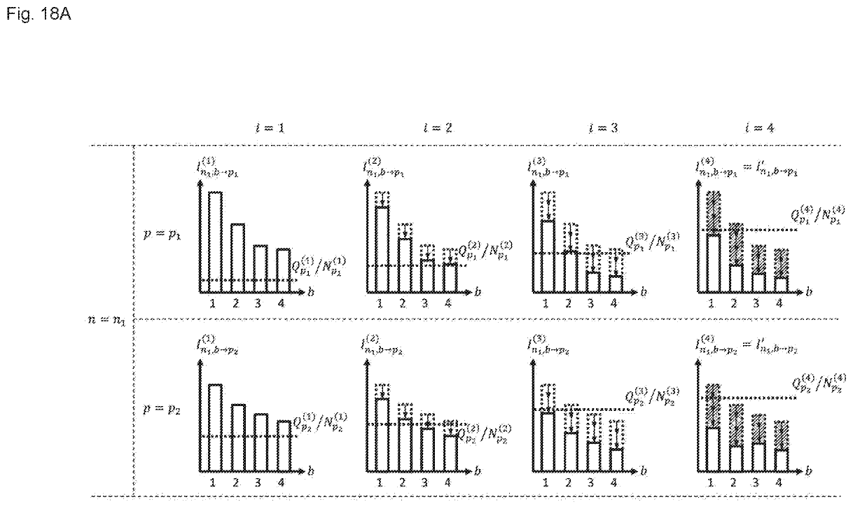

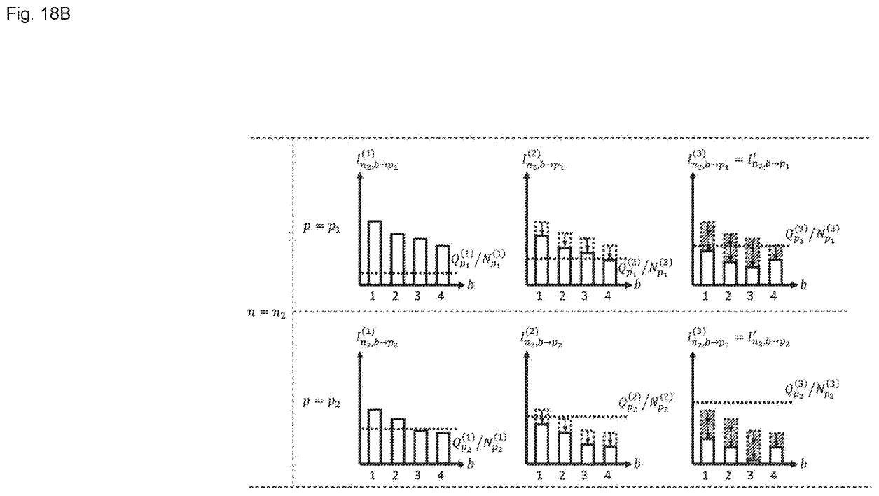

FIGS. 18A and 18B illustrate still another example (Example 3) schematically showing change according to an increase in the number i of iterations of the IAP in the calculation of the IAP according to the present embodiment. In Example 3, an example in which the criterion of [2] is used is illustrated.

As illustrated in FIG. 18A, for the communication apparatus n₁, the antenna power of the beam with even one protection point whose interference exceeds Q⁽ⁱ⁾ₚ/N⁽ⁱ⁾ₚ is decreased by ΔP, at each number i of iterations. Using criterion [2], the power decreased from the selected beam corresponds to a fourth power, as an example. For the communication apparatus n₂, similarly, the antenna power is decreased by ΔP for a beam having one protection point in which the interference exceeds Q⁽ⁱ⁾ₚ/N⁽ⁱ⁾ₚ, as illustrated in FIG. 18B.

In Examples 2 and 3 described with reference to FIGS. 17A, 17B, 18A, and 17B, the calculation is simpler than in Example 1, and therefore, there is an advantage that beam transmission power control can be easily performed. On the other hand, in Example 1, after the antenna power is decreased by ΔP from the beam with the maximum interference power at each iteration number i, there is no other beam exceeding the interference power after reduction, and thus, affinity with existing IAPs is high.

Incidentally, when the criterion of [1] is used, the maximum interference power always decreases by ΔP at each iteration while the communication apparatus is the calculation targets, in any combination of the communication apparatus and the protection point, as in the IAP of the related art. This maintains fairness between the communication apparatuses.

On the other hand, when the criterion of [2] is used, the amount of decrease in the maximum interference power for each iteration may differ depending on the communication apparatus, and the interference margin may not be evenly distributed.

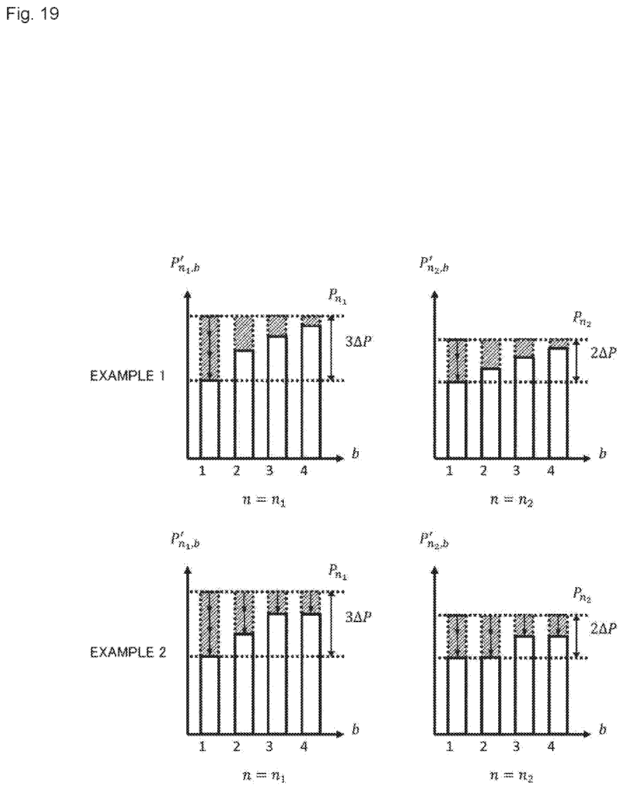

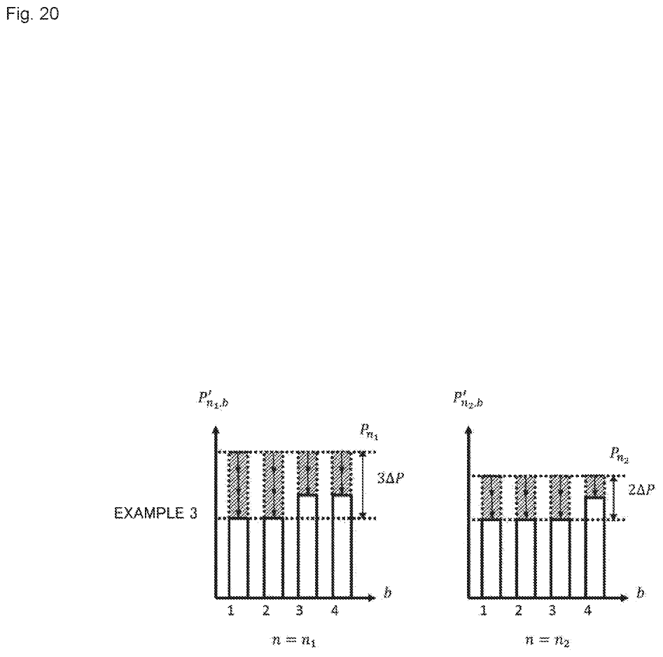

FIG. 19 illustrates a final value of the antenna power that is used when the communication apparatuses n₁ and n₂ form each beam after IAP is performed, as in Examples 1 and 2 described above. Similarly, FIG. 20 illustrates a final value of the antenna power that is used when the communication apparatuses n₁ and n₂ form each beam after IAP is performed, as in Example 3 described above.

In FIGS. 19 and 20, Pₙ₁ and Pₙ₂ represent initial values (maximum values) of the antenna powers of the communication apparatuses n₁ and n₂. P′_{n1,b} and P′_{n2,b} represents the maximum antenna powers that are allowed when the communication apparatuses n₁ and n₂ form respective beams.

It can be seen that, when ΔP=1 [dB], the antenna power of the beam with small interference power to the protection point increases in any of Examples 1 to 3, as compared with the antenna power illustrated in FIG. 14. On the other hand, it can be seen that the antenna power of the beam 1 with the highest interference power to the protection point is suppressed to the same level as in FIG. 14, and there is no problem from the viewpoint of protection of the primary system.

When the communication apparatus includes one or more beams desired to be preferentially used, in the capability information of the beam, the interference power of the beam desired to be preferentially used by the communication apparatus is equal to or smaller than the allowable value during the IAP iteration. At that time, the communication apparatus may be excluded from the calculation target. In this case, even when another beam has an interference power exceeding the allowable value, the communication apparatus is excluded at a point in time at which the interference power of the beam desired to be used by the communication apparatus becomes equal to or smaller the allowable value. In this case, it is assumed that the communication apparatus can use only a beam desired to be preferentially used and another beam whose interference is smaller than the allowable value. The communication control apparatus 130 may determine that a beam with interference power equal to or greater than the allowable value cannot be used. The communication control apparatus 130 may notify the communication apparatus of an unavailable beam. As a method of notification, a method of notifying of the maximum antenna power represented by negative infinity, an infinitely small negative value, a true value of 0, or the like, or a method of notifying of an unavailable flag or the like may be used. The notification may be made in a response of the available spectrum query procedure, the spectrum grant procedure, or the spectrum use notification as a timing when the notification is performed.

Further, when the communication apparatus includes information for specifying one or more beams that may not be available, in the capability information of the beam, the communication control apparatus 130 may remove the beam specified by this information from the calculation targets in advance and perform the IAP. The communication control apparatus 130 may notify the communication apparatus that the beam excluded from the calculation targets is unavailable.

Similarly, when interference power of beams other than the beam notified as a beam that may not be available to the communication apparatus becomes equal to or smaller than the allowable value during the IAP iteration, the communication control apparatus 130 may exclude this communication apparatus from the calculation targets at that point in time. The communication control apparatus 130 may transmit, to the communication apparatus, a notification that the beam notified as a beam that may not be available to the communication apparatus cannot be used.

<3.5 Calculation Amount Reduction Scheme when Beamforming is Used>

Since a maximum value of the gain of the beam formed by the communication apparatus 110 is generally larger than when beamforming is not performed, an absolute amount of interference power also increases as compared with a case in which the beamforming is not performed, as a result. In this case, as a matter of course, the absolute amount of antenna power to be decreased by the IAP also increases greatly as compared with the case in which beamforming is not performed, and in each repetition processing of the IAP, when the antenna power is always decreased by the same amount, the number of repetitions is also very large.

Although the same value such as 1 dB is used for the amount ΔP of reduction in the antenna power during the IAP iteration in the description so far, this ΔP may be variable to decrease the number of iterations and decrease an amount of calculation. For example, ΔP may be changed on the basis of the following criteria.
I. ΔP is increased or decreased depending on the magnitude of the interference power for each beam
II. ΔP is increased or decreased depending on a magnitude of the beam gain in the protection point direction
III. ΔP is increased or decreased depending on the number of the IAP iterations

For each criterion, ΔP may be increased or decreased in proportion to a magnitude of the criterion or number of times. Further, one or more threshold values may be set for each magnitude or number of times, and the magnitude of ΔP corresponding to the threshold value may be set in advance.

Further, regarding I and II, the magnitude of the interference power may be a relative amount rather than an absolute amount. For example, ΔP may be determined using a difference between the interference power and an allowable interference amount of the interference.

One or more threshold values are set for the interference power, and for beams whose interference power is equal to or greater than the threshold value, for example, P⁽¹⁾_{n,b}, which is the initial value of P⁽ⁱ⁾_{n,b}, may be limited to a value smaller than an original initial value using a predetermined scheme. This makes it possible to decrease the absolute amount of power that needs to be decreased and decrease the number of the IAP iterations. For example, a difference between the interference power and the threshold value is subtracted from the original initial value (P⁽¹⁾_{n,b}), and a value after subtraction is set as a new initial value P⁽¹⁾_{n,b}.

Further, a threshold value may be set for the maximum beam gain or the like instead of the interference power, and P⁽¹⁾_{n,b} may be adjusted in the same manner as described above for beams in which the maximum beam gain or the like is equal to or greater than the threshold value.

Further, when the antenna power is decreased by ΔP in first iteration processing of the IAP instead of changing the initial value P⁽¹⁾_{n,b}, antenna power of the beam in which the interference power or maximum beam gain is equal to or greater than the threshold value may be limited to an initial value or smaller. It is possible to achieve a similar objective by decreasing the antenna power of the beam by ΔP after the antenna power is limited to an initial value or smaller.

Further, the above-described scheme can be applied not only to the IAP according to the present embodiment but also to an existing IAP.

### <3.6 Details of Method of Specifying Beam Gain>

A method of specifying the beam gain to be used in calculating the interference power from the communication apparatus 110 to the primary system disposed at the protection point may vary depending on a type of capability information of the beam.

When capability information is given in the form of one or more precoding matrices, the weight matrices, or the steering vectors as in [1] of <3.1>, the beam gain may be calculated using these matrices and vectors, a vector indicating a direction of the protection point viewed from the communication apparatus, and the like. In this case, the number of transmission beams may be equal to the number of precoding matrices, the weight matrices, or the steering vectors.

When the communication apparatus performs the hybrid beamforming, and the precoding matrices, the weight matrices, or the steering vectors are reported separately for the analog beamforming and the digital beamforming, the beam gain is calculated for each combination of these. Further, the number of transmission beams may be determined depending on the number of combinations.

Next, when one or more beam directions represented by, for example, at least one of the azimuth angle and the elevation angle are given as in [2] to [4] of <3.1>, these beam directions may be used as beam directions of a beam that is formed by the communication apparatus as they are. Therefore, the number of transmission beams is determined depending on the number of given beam directions. A plurality of beam patterns may be defined for the same beam direction. Further, a beam gain in the direction of the protection point may be obtained using a beam pattern specified by a method according to capability information as will be described below.

As in [5] to [7] of <3.1>, when one or more beam motion areas represented by, for example, at least one of the azimuth angle and the elevation angle are given, the beam motion area may be sampled by at least one of the azimuth angle and the elevation angle. A beam having these sampling points as the beam direction may be formed by the communication apparatus. It is possible to determine at least one beam that can be transmitted by the communication apparatus 110 by sampling the beam motion area on the basis of the information (the capability information) on the communication apparatus 110 in this manner.

The sampling interval in the beam motion area may be determined depending on the beam width, for example. Further, as will be described below, a method of obtaining the beam width differs depending on the type of capability information. Further, the beam width does not necessarily have to be a specific beam width (for example, 3 dB beam width), and an angle at which the gain is attenuated by any value may be used as the beam width.

Further, the sampling interval in the beam motion area does not necessarily have to be uniform, and a value of the sampling interval may be changed depending on at least one of the azimuth angle and elevation angle. For example, the sampling interval may be changed depending on a beam use frequency according to the beam direction. When there is a range of beam directions in which the beam use frequency is higher than others, a smaller sampling interval is used within this range. For other ranges, a larger sampling interval is used. The beam use frequency may be notified of from the communication apparatus together with the capability information of the beam.

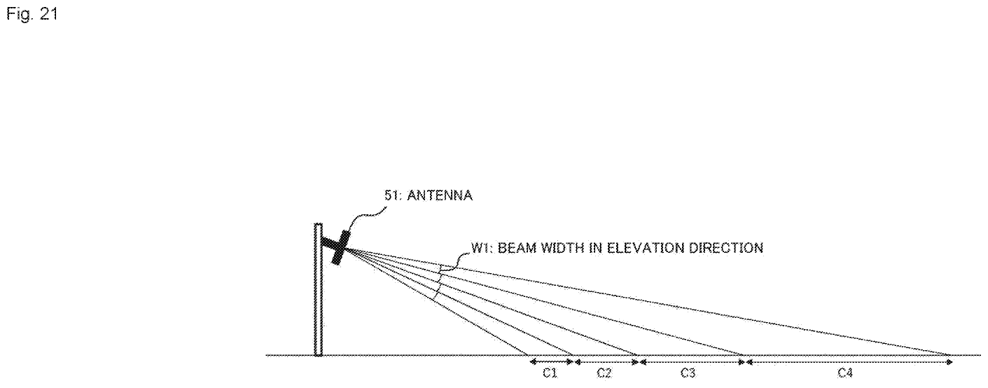

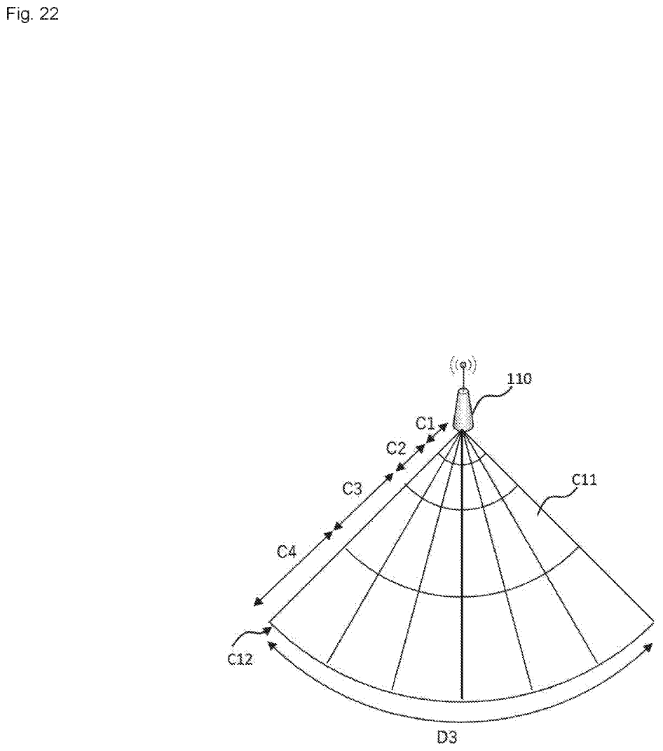

Further, the sampling interval may be changed according to the size of the geographical coverage of the beam for each beam direction. In general, in a communication apparatus that performs beamforming, when the beams have the same width W1, the coverage of each beam formed by the antenna 51 is larger as the elevation angle in the beam direction is larger, as illustrated in FIG. 21. In the illustrated example, coverages C1, C2, C3, and C4 are formed in ascending order of elevation angle, the coverage C4 is the largest, and the coverage C1 is the smallest. Thus, when there is a difference in beam coverage, the sampling interval in the beam direction in which the coverage is widened may be set to be narrow, and the sampling interval in the beam direction in which the coverage is narrowed may be set to be wide. When the beam direction can be changed in an azimuth angle direction D3 as illustrated in FIG. 22, in addition to the elevation angle, the sampling interval may be similarly changed in consideration of a difference in coverage due to the elevation angle. In FIG. 22, a plurality of coverages C11 in the beam direction and the entire coverage C12 of the communication apparatus 110 are illustrated. The size of the geographical coverage of the beam may be notified of from the communication apparatus 110 or may be calculated by the communication control apparatus 130 using information notified of from the communication apparatus 110.

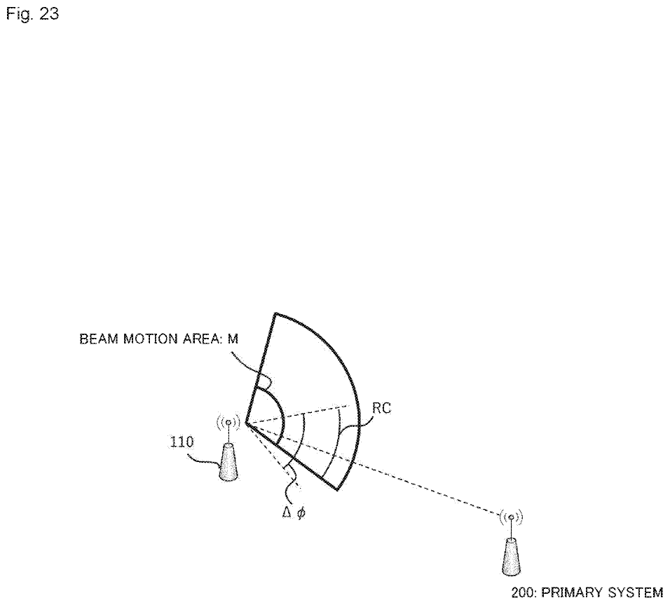

Further, the sampling interval of the beam may be changed depending on a relationship between the beam direction and a direction in which there is the primary system. For example, the sampling interval may be narrowed for a range RC within a certain range of angles (Δφ) from a direction in which there is a primary protection area in a beam motion area M of the communication apparatus 110, as illustrated in FIG. 23, and the sampling interval may be widened in the other range. For the relationship with the direction in which there is the primary system, not only the azimuth angle but also the elevation angle direction may be considered. Further, when there are a plurality of primary systems for the communication apparatus 110 of one secondary system, the sampling interval may be similarly narrowed for all the primary systems and the calculation may be performed. In this case, the same sampling result may be used in all the primary systems, or different sampling results may be used in each primary system. In a case in which the different sampling results are used, it is necessary to notify the communication apparatus of the transmission power at the narrowest sampling interval in each direction when the communication apparatus is notified of the transmission power.

Further, when the sampling interval is changed on the basis of some criteria, a minimum sampling interval may be provided and all sampling intervals may be limited to a multiple of the minimum sampling interval.

Further, a plurality of beam motion areas may be included in the capability information of the beam. In this case, sampling may be performed individually on all motion areas, and all sampling points may be set as beam directions.

Only in the case of [6] of <3.1>, the beam motion area may be divided into one or more parts by the beam width or the like, and a center thereof may be used as the beam direction. A division interval in this case may be variable depending on, for example, at least one of the azimuth angle and the elevation angle, like the sampling interval.

Further, the beam motion area may be expressed in the form of a combination of one or more ranges in which the beam is movable and one or more ranges in which the beam is not movable. For the ranges in which the beam is not movable, the sampling or division may not be performed.

Further, as in [2] and [5] of <3.1>, when the antenna element information is given, this antenna element information and beam direction may be used to calculate the beam gain in the protection point direction and the beam width. When the antenna element information and the beam directions are used, the beam pattern may be calculated using, for example, an equation disclosed in Chapter 5 of Annex 1 of Recommendation ITU-R M.2101. From this beam pattern, the beam width may be calculated.

When the beam gain is calculated from the antenna element information, there may be protection points in a null direction of the beam pattern. In this case, a slight error in the angle is likely to cause a large fluctuation in the interference power to give a large amount of interference to the primary system. As a countermeasure, clipping may be performed with a lower limit of the beam gain set to a predetermined value, or nulls may be decreased by filtering. Alternatively, the beam pattern obtained by calculating the envelope of the beam pattern obtained from the antenna element information may be used.

Next, as in [3] and [6] of <3.1>, a case in which a combination of one or more beam widths and the beam maximum gain is given will be described. In the beam pattern, the beam gain may be fixed at the maximum gain within the beam width, or a value obtained by connecting the beam direction to the beam width (for example, a range of plus or minus 15 degrees from the beam direction) using a curve or straight line may be set as the beam gain. Outside the beam width, the gain may be a constant value, or may be a value depending on the at least one of the azimuth angle and the elevation angle. Further, these values may be determined in advance by standards, legal systems, specifications of the communication apparatus 110, or may be acquired from the communication apparatus 110.

Further, when the sampled beam pattern is given as in [4] and [7] of <3.1>, the beam gain may be obtained by interpolating between sampling points of the beam pattern. As an interpolation method, linear interpolation or arbitrary nonlinear interpolation may be used, or interpolation may be performed in a stepwise manner (or at regular intervals). The beam width may be obtained from this interpolation result.

Further, the plurality of beam patterns may be grouped according to a certain criterion into one or a plurality of groups, and interference calculation may be performed for each group, thereby decreasing an amount of calculation required for the IAP.

### <3.7 Details of Method of Notify Communication Apparatus of Maximum Antenna Power>

When the communication apparatus 110 is notified of the maximum antenna power allowed for each beam, a notification method may be changed depending on the capability information of the beam.

When capability information is given in the form of one or more precoding matrices, the weight matrices, or the steering vectors as in [1] of <3.1>, the communication control apparatus 130 may notify the communication apparatus 110 of transmission power or transmission possibility for each matrix or vector. When hybrid beamforming is performed and a beam pattern is calculated using a plurality of combinations of matrices and vectors, information on the combinations used for the calculation may also be notified of.

When one or more beam directions represented by, for example, the at least one of the azimuth angle and the elevation angle are given as in [2] to [4] of <3.1>, the communication control apparatus 130 may notify the communication apparatus 110 of the transmission power or transmission possibility for each given beam direction. Further, when a plurality of beam widths, beam gains, beam patterns, and the like are defined for one beam direction, such information is also notified separately.

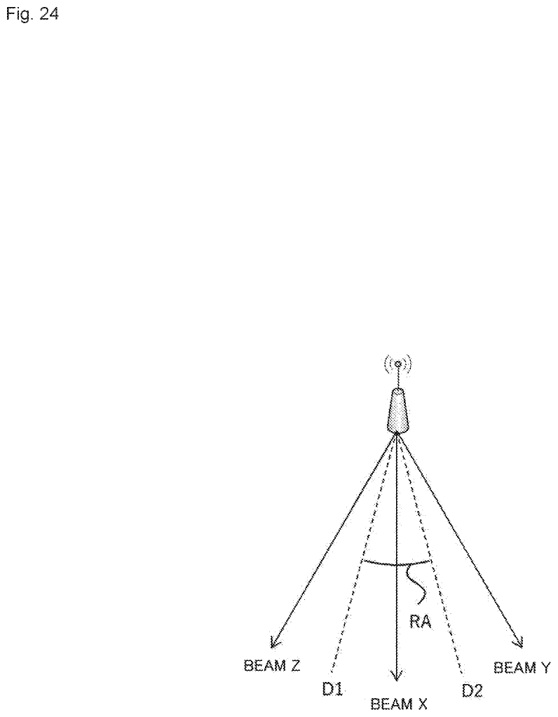

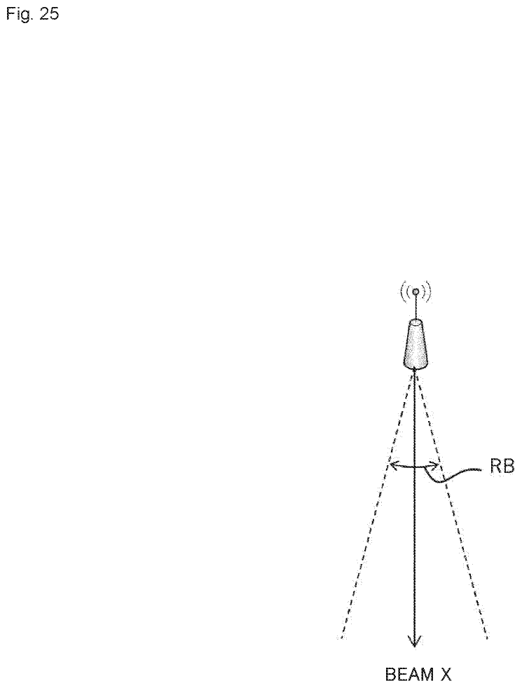

The communication apparatus 110 notified of the maximum antenna power for each beam direction in this way determines transmission power of the beam formed by the apparatus or availability, on the basis of the notified information. In this case, the communication apparatus 110 is not necessarily capable of applying a result (the transmission power or availability) only to a beam in a beam direction that completely matches the notified beam direction. The communication apparatus 110 may obtain a range of beam directions to which corresponding maximum antenna power should be applied, for each of the notified beam directions, and apply the maximum antenna power to a beam directed to the inside of the range. For example, as illustrated in FIG. 24, a maximum antenna power of a certain beam X may be applied to a beam directed to a range RA between an intermediate direction D1 between the beam X and an adjacent beam Y and an intermediate direction D2 between the beam X and an adjacent beam Z. Similarly, as in FIG. 25, the same maximum antenna power may be applied to a beam directed to within a beam width range RB from a beam direction of a certain beam X. When a certain beam is directed to within a beam width common to two or more beams, a maximum, minimum, or average value of a maximum antenna power of the two or more beams, for example, may be obtained and applied to the beam.

As in [5] to [7] of <3.1>, when one or more beam motion areas represented by, for example, at least one of the azimuth angle and the elevation angle are given, the communication control apparatus 130 may notify the communication apparatus 110 of the maximum antenna power together with direction information such as the azimuth angle and elevation angle, for each beam direction obtained by sampling.

In this case, the communication apparatus 110 may obtain a range of beam directions to which corresponding maximum antenna power should be applied, for each of the sampled beam directions, and apply the maximum antenna power to a beam directed to the inside of the range. For example, as illustrated in FIG. 24, a maximum antenna power of a certain beam X may be applied to a beam directed to a range RA between an intermediate direction D1 between the beam X and an adjacent beam Y and an intermediate direction D2 between the beam X and an adjacent beam Z. Similarly, as in FIG. 25, the same maximum antenna power may be applied to a beam directed to within a beam width range RB from a beam direction of a certain beam X. When a certain beam is directed to within a beam width common to two or more beams, a maximum, minimum, or average value of a maximum antenna power of the two or more beams, for example, may be obtained and applied to the beam.

Further, the communication control apparatus 130 may obtain the range of beam directions to which respective calculation results (transmission power, availability, or the like) are to be applied from the beam direction, and notify the communication apparatus 110 of the maximum antenna power together with the information on the obtained range of beam directions, as illustrated in FIGS. 23 and 23. In this case, the communication apparatus 110 applies the corresponding maximum antenna power to a beam directed to the inside of each range.

When a plurality of beam widths, beam gains, and beam patterns are defined in one beam motion area, the plurality of defined pieces of information may also be notified of separately.

The communication control apparatus 130 may notify of an absolute amount (absolute value) of the maximum antenna power of each beam, or may notify of, for example, the maximum antenna power as a relative amount (relative value) such as a difference from a beam with a highest maximum antenna power.

Further, the communication control apparatus 130 may periodically recalculate the maximum allowable transmission power for each beam in order to cope with addition or reduction of primary systems, addition or reduction of secondary systems, parameter changes, and the like. When there has been change in a result of calculating the maximum allowable power as a result of the calculation, the communication control apparatus 130 may notify the communication apparatus 110 of information on the changed maximum allowable power using a response of the spectrum grant procedure and the spectrum use notification.

In this case, in order to decrease an amount of communication data required for the procedure, the communication control apparatus 130 may notify of, for example, only information on the beam whose maximum allowable power has decreased. Alternatively, the communication control apparatus 130 may notify of only the information of the beam whose use has been notified in the spectrum grant procedure or the spectrum use notification.

### <3.8 Modification Example of the IAP According to Present Embodiment>

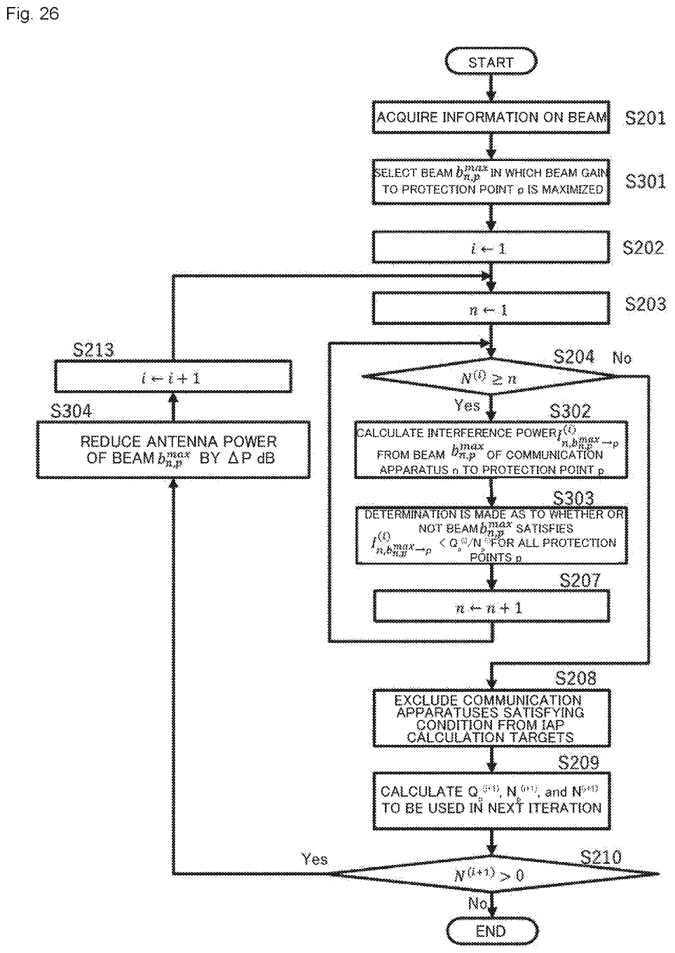

Here, a modification example that can be applied only to a case in which there is one protection point will be described. A modification example of Example 1 described above is shown. FIG. 26 is a flowchart of the present modification example when there is only one protection point p. An operation of the present flowchart is executed by the communication control apparatus 130. The same steps as in FIG. 15 are denoted by the same reference numerals, and the same description is omitted. Steps S303 and S304 are steps different from those in the flowchart of FIG. 15, and other steps are the same as those of FIG. 15.

Further, the modification example can be used when there are a plurality of protection points, by calculating allowable maximum antenna power of each protection point and then, using a calculation result (for example, selecting a minimum value of the allowable maximum antenna power of each beam). However, in this case, this is equivalent to protecting a plurality of primary systems with only one protection point, and has a purpose different from the original IAP.

First, after information on the beam is obtained, a beam b^{max}_{n,p} in which the beam gain to the protection point p is maximized is selected for all the communication apparatuses 110 (S301). b^{max}_{n,p} can be expressed by Equation (17) below.

$$\begin{matrix}[ Math . 18 ] & \\ {b}_{n , p}^{max} = {arg max}_{1 \leq b \leq {B}_{n}} {G}_{n , b} ( {ϕ}_{n \to p} , {θ}_{n \to p} ) & ( 17 )\end{matrix}$$

Equation (17) is equivalent to selecting a beam with the maximum interference power to the protection point p, as expressed by Equation (18).

$$\begin{matrix}[ Math . 19 ] & \\ {b}_{n , p}^{max} = {arg max}_{1 \leq b \leq {B}_{n}} {I}_{n , b \to p} & ( 18 )\end{matrix}$$

In subsequent calculation, it is assumed that the beam pattern of this beam b^{max}_{n,p} is an antenna pattern of the communication apparatus n and, for the protection point p, until all the communication apparatuses 110 satisfy the condition

$${I}_{n , {b}_{n , p}^{max} \to p}^{( i )} < {Q}_{p}^{( i 〉} / {N}_{p}^{( i )} ,$$

the antenna power is decreased by ΔP dB (S302, S303, S304).

In this modification example, after all the communication apparatuses 110 satisfy the above conditions, the allowable maximum antenna power for each beam is determined. The interference power when the beam b^{max}ₙ is formed with the antenna power obtained using the beam pattern of beam b^{max}_{n,p} is.

$${P}_{n , {b}_{n , p}^{max}}^{′}$$

$${I}_{n , {b}_{n}^{max} \to p}^{′}$$

The communication control apparatus 130 determines the allowable maximum antenna power of each beam so that the interference power of all the beams is equal. Therefore, the antenna power of each beam is represented by Equation (19) below.

$$\begin{matrix}[ Math . 20 ] & \\ {P}_{n , b}^{′} = {P}_{n , b} - ( {I}_{n , b \to p} - {I}_{n , {b}_{n}^{max} \to p}^{′} ) & ( 19 )\end{matrix}$$

Further, selecting the beam with the maximum beam gain is equivalent to using the antenna pattern obtained by synthesizing all the beams in the same communication apparatus for the IAP. In this case, the maximum allowable antenna power of the communication apparatus 110 is obtained using the synthesized beam pattern. In order to make the interference power to the protection point when this allowable maximum antenna power and the combined antenna pattern are used equal to the interference power obtained for each beam, the maximum allowable antenna power of each beam is determined, as in Equation (19).

As described above, according to the present embodiment, when the transmission power of each communication apparatus in the IAP is decreased, a beam is selected on the basis of the criterion, and only the transmission power of the selected beam is decreased. This makes it possible to transmit abeam with smaller interference to the primary system with greater transmission power while flexibly allocating the interference margin of the primary system to each communication apparatus like the IAP.

### 4 Modification Examples

The transmission power calculation scheme described above can be applied to not only a case in which the transmission power is decreased but also when a case in which the transmission power is increased. For example, it is possible to allocate a surplus interference margin to the other communication apparatus 110 due to a decrease in the number of communication apparatuses 110 in the secondary system. In other words, the phrase “the transmission power is decreased” can be replaced with “the transmission power is increased”. Further, in this case, the phrase exceeding the allowable interference power can be replaced with not exceeding the allowable interference power. The phrase “until the interference power becomes equal to or smaller than the allowable interference power” can be replaced with “in a range in which the allowable interference power is not exceeded”. Further, at least one of the plurality of communication apparatuses capable of transmitting at least one beam may be capable of transmitting a plurality of beams.

Further, the transmission power calculation scheme described above can be diverted to purposes other than a protection purpose of an existing system (Incumbent System). As an example, the above-described method can also be applied to interference control between secondary systems.

The above-described embodiment is an example for embodying the present disclosure, and the present disclosure can be implemented in various other forms. For example, various modifications, substitutions, omissions, or combinations thereof are possible without departing from the gist of the present disclosure. Forms with such a modification, substitution, omission, or the like are also included in the scope of the invention described in the claims and their equivalents, as well as being included in the scope of the present disclosure.

Further, the effects of the present disclosure described herein are merely examples, and there may be other effects.

Further, the present disclosure can also have the following configurations.

### [Item 1]

A communication control apparatus including:
a processing unit configured to perform processing for calculating interference power for each beam, a plurality of communication apparatuses capable of transmitting at least one beam giving the interference power to a protection target through transmission of the beam, and
decreasing or increasing transmission power for each beam to a value at which total interference power in a case in which the plurality of communication apparatuses simultaneously transmit the beam is equal to or smaller than an interference margin indicating a total allowable interference power of the protection target, on the basis of the interference margin.

### [Item 2]

The communication control apparatus according to item 1, wherein the processing unit calculates allowable interference power of the plurality of communication apparatuses on the basis of the interference margin of the protection target, and decreases transmission power of the beam of a first communication apparatus in which the interference power of the beam exceeds the allowable interference power among the plurality of communication apparatuses.

### [Item 3]

The communication control apparatus according to item 2, wherein the communication control apparatus calculates a residual interference margin obtained by removing the allowable interference power of a second communication apparatus having an interference power of the beam equal to or lower than the allowable interference power among the plurality of communication apparatuses from the interference margin of the protection target,
calculates an allowable interference power allocable to the first communication apparatus on the basis of the residual interference margin, and
further decreases the transmission power of the beam of the first communication apparatus when the interference power by the beam of the first communication apparatus after decreasing the transmission power exceeds the calculated allowable interference power.

### [Item 4]

The communication control apparatus according to item 3, wherein the processing unit calculates allowable interference power allocable to the first communication apparatus by dividing the residual interference margin by the number of the first communication apparatuses.

### [Item 5]

The communication control apparatus according to item 2 or 3, wherein the processing unit decreases transmission power of a beam having the highest interference power among the plurality of beams of the first communication apparatus.

### [Item 6]

The communication control apparatus according to item 5, wherein the processing unit decreases the transmission power by first power.

### [Item 7]

The communication control apparatus according to item 5, wherein the processing unit selects, from among the plurality of beams of the first communication apparatus, a beam in which a difference from the interference power of the beam having the highest interference power is smaller than second power, and decreases transmission power of the selected beam.

### [Item 8]

The communication control apparatus according to item 7, wherein the processing unit decreases transmission power of the selected beam by third power.

### [Item 9]

The communication control apparatus according to item 8, wherein interference power after the transmission power of the selected beam is decreased by the third power is the same as interference power of a beam with a highest interference power after transmission power of the beam with a highest interference power is decreased.

### [Item 10]

The communication control apparatus according to item 2 or 3, wherein the processing unit decreases transmission power of all beams whose interference power exceeds the allowable interference power among the plurality of beams of the first communication apparatus.

### [Item 11]

The communication control apparatus according to item 10, wherein the processing unit decreases transmission power of all beams whose interference power exceeds the allowable interference power by fourth power.

### [Item 12]

The communication control apparatus according to any one of items 1 to 11, wherein there are a plurality of the protection targets, and
the processing unit decreases or increases the transmission power for each beam to a value at which total interference power is equal to or smaller than the interference margin for each protection target with respect to all of the plurality of protection targets.

### [Item 13]

The communication control apparatus according to item 3, wherein the processing unit iterates calculation of the residual interference margin and decreasing transmission power of the beam of the first communication apparatus until all interference powers of the plurality of beams of the first communication apparatus become equal to or smaller than the allowable interference power.

### [Item 14]

The communication control apparatus according to any one of items 1 to 13, including:
a transmission unit configured to transmit information indicating the transmission power for each beam determined for the communication apparatus to the communication apparatus.

### [Item 15]

The communication control apparatus according to any one of items 1 to 14,
wherein the processing unit specifies the at least one beam that the communication apparatus is able to transmit on the basis of information on the communication apparatus.

### [Item 16]

The communication control apparatus according to item 15, wherein the processing unit specifies the beam that can be transmitted by the communication apparatus by sampling the inside of a beam motion area of the communication apparatus.

### [Item 17]

The communication control apparatus according to any one of items 1 to 16, wherein the processing unit calculates interference power given to the protection target through simultaneous transmission of two or more beams when the communication apparatus is able to transmit the two or more beams simultaneously.

### [Item 18]

The communication control apparatus according to item 2 or 3, wherein the first communication apparatus is a communication apparatus in which an average value of the interference power caused by the plurality of beams of the communication apparatus exceeds the allowable interference power.

### [Item 19]

A communication control method including:
calculating interference power for each beam, a plurality of communication apparatuses capable of transmitting at least one beam giving the interference power to a protection target through transmission of the beam, and performing processing for decreasing or increasing transmission power for each beam to a value at which total interference power in a case in which the plurality of communication apparatuses simultaneously transmit the beam is equal to or smaller than an interference margin indicating a total allowable interference power of the protection target, on the basis of the interference margin.

### [Item 20]

A communication apparatus including:
a transmission unit configured to selectively transmit a plurality of beams;
a reception unit configured to receive information indicating transmission power for each beam; and
a processing unit configured to control transmission power of the beam transmitted by the transmission unit on the basis of the information.

### [Item 21]

A communication control apparatus including:
a processing unit configured to calculate interference power for each beam, a plurality of communication apparatuses capable of transmitting at least one beam giving the interference power to a protection target through transmission of the beam, and
a processing unit configured to determine transmission power for each beam allowed for the communication apparatus on the basis of an interference margin indicating a total allowable interference power of the protection target, and the interference power;

### REFERENCE SIGNS LIST

51 Antenna
100 Communication network
110, 110A, 110B, 110C Communication apparatus
111 Reception unit
113 Processing unit
114 Transmission unit
115 Control unit
116 Storage unit
120, 120A Terminal
130, 130A, 130B Communication control apparatus
131 Reception unit
132 Processing unit
133 Processing unit
134 Transmission unit
135 Control unit
136 Storage unit
200 Primary system

1. A communication control apparatus comprising:
a processing unit configured to perform processing for calculating interference power for each beam, a plurality of communication apparatuses capable of transmitting at least one beam giving the interference power to a protection target through transmission of the beam, and
decreasing or increasing transmission power for each beam to a value at which total interference power in a case in which the plurality of communication apparatuses simultaneously transmit the beam is equal to or smaller than an interference margin indicating total allowable interference power of the protection target, on the basis of the interference margin.

2. The communication control apparatus according to claim 1, wherein the processing unit calculates allowable interference power of the plurality of communication apparatuses on the basis of the interference margin of the protection target, and decreases transmission power of the beam of a first communication apparatus in which the interference power of the beam exceeds the allowable interference power among the plurality of communication apparatuses.

3. The communication control apparatus according to claim 2, wherein the communication control apparatus
calculates a residual interference margin obtained by removing the allowable interference power of a second communication apparatus having an interference power of the beam equal to or lower than the allowable interference power among the plurality of communication apparatuses from the interference margin of the protection target,
calculates an allowable interference power allocable to the first communication apparatus on the basis of the residual interference margin, and
further decreases the transmission power of the beam of the first communication apparatus when the interference power by the beam of the first communication apparatus after decreasing the transmission power exceeds the calculated allowable interference power.

4. The communication control apparatus according to claim 3, wherein the processing unit calculates allowable interference power allocable to the first communication apparatus by dividing the residual interference margin by the number of the first communication apparatuses.

5. The communication control apparatus according to claim 2, wherein the processing unit decreases transmission power of a beam having the highest interference power among the plurality of beams of the first communication apparatus.

6. The communication control apparatus according to claim 5, wherein the processing unit decreases the transmission power by first power.

7. The communication control apparatus according to claim 5, wherein the processing unit selects, from among the plurality of beams of the first communication apparatus, a beam in which a difference from the interference power of the beam having the highest interference power is smaller than second power, and decreases transmission power of the selected beam.

8. The communication control apparatus according to claim 7, wherein the processing unit decreases transmission power of the selected beam by third power.

9. The communication control apparatus according to claim 8, wherein interference power after the transmission power of the selected beam is decreased by the third power is the same as interference power of a beam with a highest interference power after transmission power of the beam with a highest interference power is decreased.

10. The communication control apparatus according to claim 2, wherein the processing unit decreases transmission power of all beams whose interference power exceeds the allowable interference power among the plurality of beams of the first communication apparatus.

11. The communication control apparatus according to claim 10, wherein the processing unit decreases transmission power of all beams whose interference power exceeds the allowable interference power by fourth power.

12. The communication control apparatus according to claim 1,
wherein there are a plurality of the protection targets, and
the processing unit decreases or increases the transmission power for each beam to a value at which total interference power is equal to or smaller than the interference margin for each protection target with respect to all of the plurality of protection targets.

13. The communication control apparatus according to claim 3, wherein the processing unit iterates calculation of the residual interference margin and decreasing transmission power of the beam of the first communication apparatus until all interference powers of the plurality of beams of the first communication apparatus become equal to or smaller than the allowable interference power.

14. The communication control apparatus according to claim 1, comprising:
a transmission unit configured to transmit information indicating the transmission power for each beam determined for the communication apparatus to the communication apparatus.

15. The communication control apparatus according to claim 1, wherein the processing unit specifies the beam that the communication apparatus is able to transmit on the basis of information on the communication apparatus.

16. The communication control apparatus according to claim 15, wherein the processing unit specifies the beam that can be transmitted by the communication apparatus by sampling the inside of a beam motion area of the communication apparatus.

17. The communication control apparatus according to claim 1, wherein the processing unit calculates interference power given to the protection target through simultaneous transmission of two or more beams when the communication apparatus is able to transmit the two or more beams simultaneously.

18. The communication control apparatus according to claim 2, wherein the first communication apparatus is a communication apparatus in which an average value of the interference power caused by the plurality of beams of the communication apparatus exceeds the allowable interference power.

19. A communication control method comprising:
calculating interference power for each beam, a plurality of communication apparatuses capable of transmitting at least one beam giving the interference power to a protection target through transmission of the beam, and
performing processing for decreasing or increasing transmission power for each beam to a value at which total interference power in a case in which the plurality of communication apparatuses simultaneously transmit the beam is equal to or smaller than an interference margin indicating total allowable interference power of the protection target, on the basis of the interference margin.

20. A communication apparatus comprising:
a transmission unit configured to selectively transmit a plurality of beams;
a reception unit configured to receive information indicating transmission power for each beam; and
a processing unit configured to control transmission power of the beam transmitted by the transmission unit on the basis of the information.

21. A communication control apparatus comprising:
a processing unit configured to calculate interference power for each beam, a plurality of communication apparatuses capable of transmitting at least one beam giving the interference power to a protection target through transmission of the beam;
a processing unit configured to determine transmission power for each beam allowed for the communication apparatus on the basis of an interference margin indicating total allowable interference power of the protection target, and the interference power; and
a transmission unit configured to transmit information indicating the transmission power of each beam to the communication apparatus.
